(19) United States
(12) Patent Application Publication
(10) Pub. No.: US 2009/0043681 A1
(43) Pub. Date: Feb. 12, 2009

(54) AUTHENTICATION SYSTEM

(76) Inventors: Mamoru Shoji, Osaka (JP); Masaru Yamaoka, Osaka (JP); Takahiro Sato, Osaka (JP); Shinichi Tanaka, Kyoto (JP); Susumu Koike, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/063,499

(22) PCT Filed: Jul. 28, 2006
(86) PCT No.: PCT/JP2006/315040

§ 371 Date: Feb. 11, 2008

(30) Foreign Application Priority Data
Aug. 12, 2005 (JP) 2005-235020

(51) Int. Cl. G06Q 40/00; G06F 21/20

(52) U.S. Cl. 705/35; 726/17

(57) ABSTRACT

It is an object of the present invention to achieve both security and convenience in authentication of authentication targets, which is required in various situations. An authentication system of the present invention includes: a receiving unit operable to receive first ID information from a first device, and receive second ID information from a second device; and an authority information generating unit operable to generate authority information having an authority range varying according to the number of pieces of the ID information received by the receiving unit. Accordingly, the range of authority that can be executed can be limited according to the number of pieces of authenticated ID information, and thus both security and convenience can be achieved in authentication of authentication targets, which is required in various situations.

### TECHNICAL FIELD

The present invention relates to an authentication system, particularly, to an authentication system for authenticating an object to be authenticated.

### BACKGROUND ART

Conventionally, in a transaction between a customer and a trader, authentication based on a card and a code number has been used for user identification of the customer. However, recently, when a card is stolen, the code number is misused, resulting in damages such as theft of money and goods. Thus, further enhancement of authentication is desired.

FIG. 56 shows a structure of an authentication system according to a conventional example (see, for example, Japanese Patent Document 1). FIG. 56 illustrates a method for withdrawing money at an automated teller machine (ATM). In FIG. 56, reference numeral 701 denotes a magnetic card, reference numeral 704 denotes an ATM, reference numeral 706 denotes a host computer, and reference numeral 709 denotes a secure chip attached to a watch or the like.

Now, the authentication system according to the conventional example is described. A customer inserts a card to the ATM 704 (702), and inputs a code number (703). If the code number is correct, the ATM 704 inquires the host computer 706 whether authentication by the secure chip 709 is required or not (705). The host computer 706 answers the ATM 704.

If the authentication by the secure chip 709 is required, inherent information of the customer is sent to the ATM 704 (707). As the ATM 704 receives this signal, it requests the secure chip 709 to provide the inherent information of the customer (708). The secure chip 709 responds to the demand and send the inherent information to the ATM 704 (710).

If two sets of inherent information, i.e., the inherent information sent from the host 706 and the inherent information sent from the secure chip 709 match, the ATM 704 authenticates identification of the customer who is operating as an authorized user, and permits withdrawals.

However, in the authentication system of the conventional example, the secure chip 709 alone provides the inherent information, so there is a problem that, when the secure chip 709 is lost, it may be misused. Further, there is also a problem that when the customer has forgotten to carry the secure chip 709, a predetermined withdrawal is not permitted.

Moreover, in these days, credit cards and debit cards utilizing IC card media are widely used. Also, electronic money utilizing the same type of IC cards has been becoming widely used. However, credit cards and debit cards require authentication of the user by an input of a password in order to protect them from misuse by a malicious third party. Thus, operations become complicated and a factor of concern in security aspect such as leakage of the password or the like is also pointed out. Therefore, a safe electronic settlement method in which only key information for user authentication is stored on the IC card media, and an electronic wallet server connected via a network is used to secure anonymity of the user and uniqueness of electronic money, which performs a batch processing from authentication to charging, has been disclosed (see Patent Document 2).

For using a credit card in an electronic transaction via the Internet, a user inputs and sends a card number. Even when it is encrypted and sent securely, user's anxiety cannot be eased completely. Also, complexity of such an input operation hinders expansion of users. Further, regarding Web money, there is complexity that a password has to be input every time it is used. Thus, a settlement method in which authentication information of a user and right to purchase of the user (i.e., electronic money information) are previously stored on the IC card, and a settlement server via the network updates the electronic money information so that password input or the like is not necessary, which means that complexity of conventional credit cards or Web money is avoided, has been disclosed (see Patent Document 3).

However, any of the methods which are currently disclosed cannot provide complete safety in the case when the user lost the card or has the card stolen.

For example, in the case where the electronic money information or electronic ticket information is securely stored on the current type of IC cards in order to use for settlement, it may be used by a malicious third party if the user did not notice he/she has lost it.

Even when authentication by a password is performed as for credit cards, password information can be readily read by using an external device, and thus, security is not ensured. Also, password input results in complexity of user operation. When it is used for electronic transaction, since the user has to notify the card number information, the user's anxiety cannot be eased.

The settlement system in which the IC card stores only the key information for identifying the user and settlement servers are used is not very practical since there is no reliability in the case of loss or theft of the IC card, and the settlement server has a burden to perform a process for every use of the user.

A charging method (a method in which a user previously register electronic money information) is now becoming mainstream. In the method, suppressing damage due to a loss or theft to a certain extent or crediting is not required. Thus, the method is effective to a certain extent in avoiding risks such as loan-loss and the like. However, there is complexity that the user has to often register the electronic money information. Further, it is merely usual paper money transformed into an electronic form, so the convenience that the electronic money naturally has is not pursued.

### Patent Document 1: Japanese Laid-Open Publication No. 2002-318903

### Patent Document 2: Japanese Laid-Open Publication No. 2003-50959

### Patent Document 3: Japanese Laid-Open Publication No. 2002-279322

### DISCLOSURE OF THE INVENTION

### Problems to be Solved by the Invention

An object of the present invention is to simultaneously pursue the safety and convenience in authentication of an object to be authenticated which is required in various situations.

### Means for Solving the Problems

A first aspect of the present invention is directed to an authentication system, comprising: a receiving unit operable to receive first ID information from a first device, and receive second ID information from a second device; and an authority information generating unit operable to generate authority information having an authority range varying according to the number of pieces of the ID information received by the receiving unit.

A second or third aspect of the present invention is the first aspect of the present invention, wherein the first or second ID information is encrypted user ID information, and the second or first ID information is a decryption key of the user ID information.

A fourth or fifth aspect of the present invention is the first aspect of the present invention, wherein the first or second ID information is user ID information, and the second or first ID information is a digital signature of the user ID information.

A sixth aspect of the present invention is the first aspect of the present invention, comprising a user management unit and a user confirmation unit. The user management unit holds information relating to a user. The user confirmation unit makes an inquiry as to the first ID information or the second ID information to the user management unit, and acquires information regarding whether or not a user corresponding to the first ID information or the second ID information has been registered. Moreover, if information indicating that the user has been registered is not acquired by the user confirmation unit, the authority information generating unit does not generate the authority information.

A seventh aspect of the present invention is the first aspect of the present invention, comprising: a user management unit operable to manage the first ID information and the second ID information such that they correspond to each other; and an ID correspondence confirmation unit operable to acquire information regarding whether or not the first ID information and the second ID information correspond to each other.

An eighth aspect of the present invention is the first aspect of the present invention, wherein the authority information generating unit generates, as the authority information, full authority information or limited authority information. The full authority information is generated if the receiving unit receives both the first ID information and the second ID information. The limited authority information is generated if the receiving unit receives only either one of the first ID information and the second ID information.

A ninth aspect of the present invention is the eighth aspect of the present invention, comprising a storage unit operable to store the full authority information and the limited authority information, wherein the authority information generating unit selects either one of the full authority information and the limited authority information in the storage unit.

A tenth aspect of the present invention is the first aspect of the present invention, comprising a device selecting unit operable to select either one of the first device and the second device, wherein the authority information generating unit generates the authority information according to a result of the selection performed by the device selecting unit.

An eleventh aspect of the present invention is the tenth aspect of the present invention, wherein if the first device is selected by the device selecting unit, the authority information generating unit generates the authority information, by encrypting the authority information with the first ID information, and if the second device is selected, the authority information generating unit generates the authority information, by encrypting the authority information with the second ID information.

A twelfth aspect of the present invention is the tenth aspect of the present invention, wherein if the first device is selected by the device selecting unit, the authority information generating unit generates the authority information, by providing a digital signature to the authority information and the first ID information, and if the second device is selected, the authority information generating unit generates the authority information, by providing a digital signature to the authority information and the second ID information.

A thirteenth aspect of the present invention is the tenth aspect of the present invention, comprising a sending unit operable to send the authority information to a device that has been selected by the device selecting unit.

A fourteenth aspect of the present invention is the first aspect of the present invention, comprising a sending unit operable to send the authority information that has been generated by the authority information generating unit, to the first device or the second device.

A fifteenth aspect of the present invention is the first aspect of the present invention, comprising an authority exercising unit configured to operate according to the authority information that has been generated by the authority information generating unit.

A sixteenth aspect of the present invention is the first aspect of the present invention, wherein the limited information is the amount of money that can be used, the number of times of operation that can be performed, time, period, expiration date, or area.

### ADVANTAGEOUS EFFECTS

According to the present invention, the range of authority to be executed can be limited dynamically and in real time, and thus both security and convenience can be achieved in authentication of authentication targets, which is required in various situations.

### BEST MODE FOR CARRYING OUT THE INVENTION

### Overview of Embodiment

Hereinafter, overview of embodiments of the present invention will be described.

<1>

In the first through fifth embodiments, an object is to provide an authentication system which realizes enhancement of authentication, and reducing risks in the case where a device including inherent information is lost or forgotten to be carried.

According to the first through fifth embodiments, enhancement of authentication in various events which require authentication, reducing of risks in the case where a device including inherent information is lost, and prevention of impairing convenience when the device including inherent information is forgotten to be carried can be realized.

For example, in the present invention shown in the first embodiment (see FIG. 1), a customer inserts a magnetic card to an ATM 106 (103), and inputs a code number (104). If the code number is correct, the ATM 106 reads a signal 105 input from an IC tag 101. The signal 105 includes a personal ID of the IC tag 101 which is encrypted, and also ID information of a mobile phone 110. The ATM 106 checks whether it has received the ID information of the mobile phone 110, and if it confirms receipt (111), the personal ID of the IC tag 101 is decrypted using the ID information as a key. The ATM 106 sends the decrypted personal ID of the IC tag 101 to a host computer 108 (107). The host computer 108 searches whether the personal ID of the IC tag 101 exists in a predetermined database of personal IDs. If it is confirmed to exist, the host computer 108 sends a signal to permit withdrawal to the ATM 106 (109).

<2>

The sixth through eighth embodiments are to solve a problem that, in a conventional electronic money system, use of card by a third party due to a theft, loss or the like of cards cannot be eliminated as a result of focusing anonymity in electronic money use. An object of the sixth through eighth embodiments is to provide an authentication system and authentication device which can prevent misuse by a third party even in the case where a card is lost or stolen without complicated input of a password or the like by the user.

According to the sixth through eighth embodiments, safety which has been conventionally achieved by a combination of a passbook and a registered seal can be applied to electronic personal authentication. Thus, it becomes possible to be used for safe electronic money, deposit and withdrawal control, and digital information recording or the like.

For example, in the present invention shown in the sixth embodiment (see FIG. 13), an authentication system is formed of an IC card 1100 on which card information is recorded, a mobile terminal 1101 which stores mobile ID, and a reader/writer having secure communication means with the IC card, communication means with the mobile terminal, extraction means for extracting electronic money information from the card information read from the IC card and the mobile ID information read from the mobile terminal, and update means for updating the electronic money information. With such a structure, an electronic money system which can eliminate misuse by a third party even when the IC card is stolen or lost is provided.

<3>

In the ninth embodiment, an information recording apparatus using an authentication process will be described. This allows prevention of misuse of contents and the like.

<4>

In the tenth embodiment, further application of the authentication process will be described.

<5>

In the eleventh embodiment, another application of the authentication process will be described.

<6>

In the twelfth embodiment, an authentication process will be described in which use is permitted within a limited authority range even with only one of two devices having inherent information.

<7>

In the thirteenth embodiment, another application of the authentication process using two devices having inherent information will be described.

### First Embodiment

Hereinafter, a preferred embodiment of the present invention is described with reference to the drawings. FIG. 1 shows a structure of an authentication system according to the first embodiment of the present invention. FIG. 1 illustrates a method for withdrawing money at an ATM. In FIG. 1, reference numeral 101 denotes an IC tag, reference numeral 102 denotes a magnetic card, reference numeral 106 denotes an ATM, reference numeral 108 denotes a host computer, and reference numeral 110 denotes a mobile phone. The IC tag 101 is embedded in the magnetic card 102.

Now, the authentication system in the first embodiment is described. A customer inserts a magnetic card to the ATM 106 (103), and inputs a code number (104). If the code number is correct, the ATM 106 reads a signal 105 input from the IC tag 101. The signal 105 includes a personal ID of the IC tag 101 which is encrypted, and also ID information of the mobile phone 110. The ATM 106 checks whether it has received the ID information of the mobile phone 110.

In general, mobile phones have a function to switch base stations as they move so that call is not interrupted while they are moving, and intermittently transmit a signal to notify their current positions to the base stations.

In the present embodiment, such a signal is utilized. The signal transmitted by the mobile phone includes at least ID information specific to the mobile phone 110. The receiving sensitivity of the ATM 106 for the ID information of the mobile phone 110 is suppressed to be lower than the receiving sensitivity of the base stations, and the ATM 106 can receive the ID information only from the mobile phones within the range of about a few meters.

If the ATM 106 confirms reception of the ID information which matches the ID information received from the IC tag 101 (111), the personal ID of the IC tag 101 is decrypted using the ID information as a key. Then, the ATM 106 sends the decrypted personal ID of the IC tag 101 to the host computer 108 (107). The host computer 108 searches whether the personal ID of the IC tag 101 exists in a predetermined database of personal IDs. If it is confirmed to exist, the host computer 108 sends a signal to permit withdrawal to the ATM 106 (109).

As described above, by the authentication system of the present embodiment, the personal ID is decrypted using two devices, i.e., the IC tag 101 and the mobile phone 110. Thus, security level can be improved compared to the case where only one device is used.

Furthermore, since the mobile phone 110 is used, original functions of mobile phones, such as a function for transmitting a signal or the power supply can be utilized, and thus, authentication of an individual can be performed with a simple structure. Further, since the ID information intermittently transmitted from the mobile phone 110 is utilized, there is no need to request the mobile phone 110 to transmit the ID information from the ATM 106, and thus, a time period necessary for authentication is reduced.

Usually, if the number of so-called keys is increased in order to improve the level of security, the operations become complicated, and may impair convenience of the customer. However, in the present embodiment, the ID information which is intermittently transmitted from the mobile phone 110 is used so that the authentication can be performed without impairing convenience of the customer.

In the present embodiment, the IC tag 101 is embedded in the magnetic card 102. However, the IC tag 101 can be provided separately from the magnetic card 102. It may be in any form such as a key ring, a bracelet, a watch with the IC tag being embedded, or the like. If the IC tag 101 is separated from the magnetic card 102, it becomes necessary to take a measure such as bringing the IC tag 101 closer to the ATM 106 or the like to send the signal 105. However, since at least three devices, the magnetic card 102, the IC tag 101, and the mobile phone 110 are necessary, the security level can be improved compared to that when two devices are used.

Since the IC tag cannot complete the authentication by itself, a plurality of IC tags may be provided in view of the case of losing or forgetting the IC tag. By carrying a plurality of IC tags, even when the IC tag is forgotten to be carried, the convenience can be prevented from being impaired without increasing the risk of misuse.

In the present embodiment, a signal of the mobile phone for notifying base stations of its position is used. However, any signal other than the signal for notifying base stations of the position can be used as long as it is intermittently transmitted at a frequency of once in about a few seconds or more. By employing another signal, a weak signal which reaches to only a range of about a few meters can be used so that the power consumption of the mobile phone can be reduced by that amount.

In the present embodiment, the ATM 106 decrypts the personal ID of the IC tag 101 using the ID information received from the mobile phone 110 as a key. However, as long as the host computer 108 already knows or can recognize, a signal obtained by arbitrarily calculating the signal 111 received from the mobile phone 110 and the signal 105 received from the IC tag 101 may be sent to the host computer 108. Sending and receiving between the host computer 108 and the ATM 106 may be in any form such as wired, wireless, one-way communication, bidirectional communication, or the like.

In the present embodiment, the decrypted personal ID of the IC tag 101 is sent to the host computer 108. However, the signal may be sent as it remains encrypted, and may be decrypted at the host computer 108.

In the present embodiment, if the customer does not carry the mobile phone 110, for example, money cannot be withdrawn. However, it may allow for a withdrawal within a predetermined range upon transmission of the code number to the magnetic card 102 as in conventional art, and it may further allow for an increase in the amount of money which can be withdrawn upon transmission of the signal 105 from the IC tag 101.

The signal input from the IC tag 101 to the ATM 106 may include address information of the host computer 108. Since the address information is included, the signal 107 can be sent to the host computer 108 even when the ATM 106 does not have address information of the host computer 108.

Even when the address information is not included, if the personal ID is a personal ID which is authenticated by an authentication organization which is designated by the ATM 106 and whose address information is known, it can be used. However, by including the address information, the personal ID authenticated by another authentication organization can be used. In this way, the number of the personal IDs can be prevented from increasing, and the customers do not have to increase the personal IDs. Thus, management of the personal IDs becomes easy.

The signal input from the mobile phone 110 to the ATM 106 may also include the address information of the host computer 108. Since the address information is included, the signal 107 can be sent to the host computer 108 even when the ATM 106 does not have address information of the host computer 108.

Even when the address information is not included, if the personal ID is a personal ID which is authenticated by an authentication organization which is designated by the ATM 106 and whose address information is known, it can be used. However, by including the address information, the personal ID authenticated by another authentication organization can be shared. In this way, the number of the personal IDs can be prevented from increasing, and the customers do not have to increase the personal IDs. Thus, management of the personal IDs becomes easy.

The signal input from the ATM 106 to the host computer 108 may include the address information of the ATM 106. By including the address information, a sending process to the host computer 108 and a receiving process from the host computer 108 can be separated. This allows selecting communication means other than bidirectional communication, and the range of choices for the communication means can be expanded.

In the present embodiment, the customer inserts the magnetic card to the ATM 106 and inputs the code number. If the code number is correct, the ATM 106 reads the signal 105 from the IC tag 101. However, the signal 105 may be sent to the ATM 106 by an operation of the customer. If the signal 105 is sent upon the customer's operation, it is no longer necessary to send the personal ID when the signal 105 does not have to be sent. Thus, the security level of the personal information can be further enhanced than that in the case where the personal IDs are always transmitted.

In the present embodiment, the customer inserts the magnetic card to the ATM 106 and inputs the code number. If the code number is correct, the ATM 106 reads the signal 105 from the IC tag 101. However, transmission of the personal ID from the IC tag 101 may be performed at a timing different from that of transmitting the ID information of the mobile phone 110 from the IC tag 101. By sending the personal ID of the IC tag 101 only under a predetermined condition, the security level of the personal information can be further enhanced than that in the case where the personal IDs are always transmitted.

An example of transmitting the personal ID of the IC tag 101 at the different timing is as follows. First, the IC tag 101 transmits only the ID information of the mobile phone 110, and the ATM 106 confirms the ID information transmitted from the mobile phone 110. Then, upon a request from the ATM 106, the IC tag 101 may transmit the personal ID of the IC tag 101. In this way, the personal ID of the IC tag is not transmitted any longer when a mobile phone which does not transmit correct ID information due to misuse is being used. Thus, the security level of the personal information can be further enhanced.

As another example, the IC tag 101 receives the ID information of the mobile phone 110 first, and is triggered by it to transmit the personal ID of the IC tag 101. Transmission of the ID information of the mobile phone 110 from the IC tag 101 to the ATM 106 may be before or after reception of the ID information of the mobile phone 110, or at the same timing. This allows omitting receiving means of the ATM 106 from the mobile phone 110.

The transmission of the personal ID from the IC tag 101 may be performed intermittently for a predetermined period of time once transmission is performed. In this way, it is ensured that the personal ID is sent to the ATM 106.

In the present embodiment, the mobile phone 110 intermittently transmits the ID information. However, the transmission may be performed upon an operation of the customer in the case of emergency, in the case where timing has to be adjusted with respect to the receiving side, or the like. Similarly, when the communication between the IC tag 101, the ATM 106, and the mobile phone 110 has to be performed at a predetermined timing, the transmission of the ID information from the mobile phone 110 may be triggered by the IC tag 101 or the ATM 106.

Further, transmission of predetermined information stored in the IC tag 101 such as the personal ID, the ID information of the mobile phone 110 and the like may be stopped by sending a predetermined signal to the IC tag 101. This reduces a risk of misuse in the case of loss.

Moreover, predetermined information stored in the IC tag 101 such as the personal ID, the ID information of the mobile phone 110 and the like may be erased by sending a predetermined signal to the IC tag 101. This reduces a risk of misuse in the case of loss.

Furthermore, predetermined information stored in the IC tag 101 such as the personal ID, the ID information of the mobile phone 110 and the like may be transferred to a predetermined device by sending a predetermined signal to the IC tag 101. This reduces a risk of misuse in the case of loss, and also allows reuse of the information which has been stored in the IC tag 101.

Further, transmission of predetermined information stored in the mobile phone 110 such as the ID information and the like may be stopped by sending a predetermined signal to the IC tag 101. This reduces a risk of misuse in the case of loss.

Moreover, predetermined information stored in the mobile phone 110 such as the ID information and the like may be erased by sending a predetermined signal to the IC tag 101. This reduces a risk of misuse in the case of loss.

Furthermore, predetermined information stored in the mobile phone 110 such as the ID information and the like may be transferred to a predetermined device by sending a predetermined signal to the IC tag 101. This reduces a risk of misuse in the case of loss, and also allows reuse of the information which has been stored in the mobile phone 110.

Alternatively, by sending a predetermined signal to the host computer 108, authentication of the ATM 106 may be stopped, or may notify the ATM 106 of a misuse.

Further, in the case of loss or the like, a predetermined code number may be input for transmitting a predetermined signal to the IC tag 101, the ATM 106, or the mobile phone 110, and the signal may be sent only when the code number is correct. This can prevent erroneous suspension of a predetermined function.

Further, the host computer 108 may be set to perform authentication only at a predetermined place. For example, the name of the store which is designated by the customer is previously registered to the host computer 108. Authentication is not performed at a store which is not designated even when a predetermined signal is sent. In this way, misuse can be prevented.

Moreover, the host computer 108 may be set to perform authentication only within a predetermined time zone. For example, a time zone designated by the customer is previously registered to the host computer 108. Authentication is not performed in time zones which are not designated even when a predetermined signal is sent. In this way, misuse can be prevented.

In the present embodiment, the signal sent from the IC tag 101 to the ATM 106 includes the ID information of the mobile phone 110 with the encrypted personal ID of the IC tag 101. The ATM 106 reads the signal input from the IC tag 101, and checks whether it has received the ID information of the mobile phone 110 which is intermittently transmitted. When the ATM 106 confirms reception of the ID information which matches the ID information received from the IC tag 101, the ATM 106 decrypts the personal ID of the IC tag 101 using the ID information as a key. Then, the ATM 106 sends the decrypted personal ID of the IC tag 101 to the host computer 108. However, the signal sent to the ATM 105 from the IC tag 101 may be sent to the mobile phone 110, and the decrypted personal ID may be sent from the mobile phone 110 to the host computer 108.

Thus, the personal ID of the IC tag 101 is no longer necessary to be sent to the ATM 105. The personal ID of the IC tag 101 is just sent to the same host computer 108. Thus, compared to the case where the personal ID is transmitted to the ATM which is used every time money is withdrawn, the security level of the personal information can be further enhanced.

The owner of the host computer 108 and the owner of the ATM 106 may be the same. However, if the owner of the host computer 108 and the owner of the ATM 106 are different, the burden of the owner of the ATM 106 can be reduced since the owner of the host computer 108 can carry out the authentication process for it.

In the present embodiment, withdrawal is permitted when there are both the mobile phone 110 and the IC tag 101 (see FIG. 2A). However, withdrawal with either device may be permitted within a limited extent upon previous registration with both the mobile phone 110 and the IC tag 101. Such an example will be described with reference to FIGS. 2B through 2D. Herein, the limited extent refers to the amount of money which can be withdrawn, the number of times allowed to withdraw, the time zone in which withdrawal is permitted (for example, from 9 AM to 10 AM), the time period permitted to withdraw (for example, one day), the time limit for withdrawal (for example, until August 5), the area in which withdrawal is permitted, and the like.

With such a feature, even when, for example, the customer notices that he/she has forgotten the mobile phone 110 at the time he/she tries to withdraw the money, or the power supply of the mobile phone 110 is insufficient or the mobile phone 110 has a failure, or money is to be withdrawn in a place where the mobile phone 110 has to be turned off, the money can be withdrawn with only the IC tag 101 if the information is registered such that the withdrawal is permitted for just once with the upper limit of the amount of money being determined.

The registration may be performed by, for example, sending the ID information of the mobile phone 110, or information obtained by arbitrarily calculating the ID information and the limitation information for limiting the range of use from the mobile phone 110 to the IC tag 101 (see FIGS. 2B and 2C). The ATM 106 receives the information, and then sends the decrypted personal ID of the IC tag 101 to the host computer without receiving the ID information from the mobile phone 110 (see FIG. 2D).

Updating of the limitation information shown in FIG. 2D means that, for example, in the case where the number of times to permit withdrawal is “once”, if money is withdrawn using only the IC tag 101, the limitation information is updated, and the number of times of withdrawal is updated to “zero”.

In the present embodiment, the signal sent from the IC tag 101 to the ATM 106 includes the ID information of the mobile phone 110 with the encrypted personal ID of the IC tag 101. The ATM 106 reads the signal input from the IC tag 101, and checks whether it has received the ID information of the mobile phone 110 which is intermittently transmitted. When the ATM 106 confirms reception of the ID information which matches the ID information received from the IC tag 101, the ATM 106 decrypts the personal ID of the IC tag 101 using the ID information as a key. Then, the ATM 106 sends the decrypted personal ID of the IC tag 101 to the host computer 108. The host computer 108 searches whether the personal ID of the IC tag 101 is in a predetermined database of personal IDs. If the host computer 108 can confirm that the personal ID exists, it sends the signal to permit withdrawal to the ATM 106. However, the host computer 108 may input the limitation information to the ATM later, and the ATM 106 may send the ID information of the mobile phone 110, or information obtained by arbitrarily calculating the ID information and the limitation information for limiting the range of use to the IC tag 101 (see FIG. 2C). Alternatively, the limitation information may be stored in the ATM or the host computer.

The method of registering can be any method other than the method of the present embodiment as long as it is performed after the user is authenticated.

In the case where the power supply of the mobile phone 110 is insufficient, the IC tag 101 may be notified by a sound or vibration.

Similarly, if previously registered, the limited withdrawal using only the mobile phone 110 may be permitted in the case of a failure of the IC tag 101.

This allows, for example, asking other person to withdraw money with passing only the IC tag as the owner keeps the mobile phone 110.

Functions of the mobile phone 110 may be transferred to an IC tag different from the IC tag 101 or a mobile phone within a limited extent if it is previously registered with both the mobile phone 110 and the IC tag 101. Herein, the limited extent refers to the amount of money which can be withdrawn, the number of times allowed to withdraw, the time zone in which withdrawal is permitted (for example, from 9 AM to 10 AM), the time period permitted to withdraw (for example, one day or until August 5), the area in which withdrawal is permitted, and the like. In this way, even in the case where the mobile phone 110 cannot be used, another IC tag or mobile phone can carry out the functions for it within the limited extent so that money can be withdrawn within the limited extent without lowering the security level.

The extent of limitation may be varied depending upon the cases, for example, the case where there are both the mobile phone 110 and the IC tag, the case where there are a substituting device for the mobile phone 110 and the IC tag, the case where there is only the registered IC tag, and the case where there is an IC tag which is not registered.

In the present embodiment, the signal sent from the IC tag 101 to the ATM 106 includes the ID information of the mobile phone 110 with the encrypted personal ID of the IC tag 101. The ATM 106 reads the signal input from the IC tag 101, and checks whether it has received the ID information of the mobile phone 110 which is intermittently transmitted. When the ATM 106 confirms reception of the ID information which matches the ID information received from the IC tag 101, the ATM 106 decrypts the personal ID of the IC tag 101 using the ID information as a key. Then, the ATM 106 sends the decrypted personal ID of the IC tag 101 to the host computer 108. However, the signal sent from the IC tag 101 to the ATM 106 may not include the ID information of the mobile phone 110. The ATM 106 may receive the ID information of any mobile phone and decrypts it to send to the host computer. If there are a number of mobile phones around the ATM 106, it may take some time for the ATM 106 to obtain the ID information of the mobile phone 110. However, in this way, the ID information of the mobile phone 110 is no longer necessary to be stored in the IC tag 101, so the security level can be enhanced in terms of protecting the ID information of the mobile phone.

In the present embodiment, the personal ID of the IC tag 101 is decrypted using the ID information of the mobile phone as a key, and the decrypted personal ID of the IC tag 101 is sent to the host computer. However, the present invention is not limited to such an example, and the withdrawal may be permitted by simply having both the ID of the mobile phone and the signal sent from the IC tag. In this way, decrypting means is no longer necessary, and the system can be simplified.

In the present embodiment, the signal sent from the IC tag 101 to the ATM 106 includes the ID information of the mobile phone 110 with the encrypted personal ID of the IC tag 101. The ATM 106 reads the signal input from the IC tag 101, and checks whether it has received the ID information of the mobile phone 110 which is intermittently transmitted. When the ATM 106 confirms reception of the ID information which matches the ID information received from the IC tag 101, the ATM 106 decrypts the personal ID of the IC tag 101 using the ID information as a key. Then, the ATM 106 sends the decrypted personal ID of the IC tag 101 to the host computer 108. However, the signal sent from the IC tag 101 to the ATM 108 may include mail address information or a telephone number of the mobile phone 110. When the ATM 108 receives the signal output from the IC tag, it may send mail to or call the mobile phone 110, and upon a predetermined receiving operation (clicking a predetermined button or the like) on the mobile phone 110, withdrawal may be permitted. In this way, decrypting means is no longer necessary, and the system can be simplified.

### Second Embodiment

Hereinafter, another embodiment of the present invention is described with reference to the drawings. FIG. 3 shows a structure of an authentication system according to another embodiment of the present invention. FIG. 3 illustrates a method for settling for shopping at a store or the like. In FIG. 3, reference numeral 201 denotes an IC tag, reference numeral 203 denotes a terminal, reference numeral 204 denotes a mobile phone, and reference numeral 207 denotes a host computer.

Now, the authentication system in the second embodiment is described. For purchasing a product, a customer passes the IC tag 201 to the store. A form of the IC tag 201 may be a card or the like with an IC tag being embedded. The store reads a signal 202 by the terminal 203 having a reader function for the IC tag 201.

The signal 202 includes a personal ID of the IC tag 201 which is encrypted, and also ID information of the mobile phone 204. The terminal 203 checks whether it has received the ID information of the mobile phone 204.

In general, mobile phones have a function to switch base stations as they move so that call is not interrupted while they are moving, and intermittently transmit a signal to notify their current positions to the base stations.

In the present embodiment, such a signal is utilized. The signal transmitted by the mobile phone includes at least ID information specific to the mobile phone 204. The receiving sensitivity of the terminal 203 for the ID information of the mobile phone is suppressed to be lower than the receiving sensitivity of the base stations, and the terminal 203 can receive the ID information only from the mobile phones within the range of about a few meters.

If the terminal 203 confirms reception of the ID information which matches the ID information received from the IC tag 201 (205), the personal ID of the IC tag 201 is decrypted using the ID information as a key. Then, the terminal 203 sends the decrypted personal ID of the IC tag 201 to the host computer 207 (206). The host computer 207 searches whether the personal ID of the IC tag 201 exists in a predetermined database of personal IDs. If it is confirmed to exist, the host computer 207 sends a signal to confirm authentication to the terminal 203 (208).

As described above, by the authentication system of the present embodiment, the personal ID is decrypted using two devices, i.e., the IC tag 201 and the mobile phone 204. Thus, security level can be improved.

Furthermore, since the mobile phone 204 is used, original functions of mobile phones, such as a function for transmitting signal or the power supply can be utilized, and thus, authentication of an individual can be performed with a simple structure. Further, since the ID information intermittently transmitted from the mobile phone 204 is utilized, there is no need to request the mobile phone 204 to transmit the ID information from the terminal 203, and thus, a time period necessary for authentication is reduced.

Usually, if the number of so-called keys is increased in order to improve the level of security, the operations become complicated, and may impair convenience of the customer. However, in the present embodiment, the ID information which is intermittently transmitted from the mobile phone 204 is used so the authentication can be performed without impairing convenience of the customer.

In the present embodiment, the IC tag 201 is formed into a card. However, it may be in any form such as a key ring, a bracelet, a watch with the IC tag being embedded, or the like.

Since the IC tag cannot complete the authentication by itself, a plurality of IC tags may be provided in view of the case of losing or failing to bring the IC tag.

In the present embodiment, a signal of the mobile phone for notifying base stations of its position is used. However, any signal other than the signal for notifying base stations of the position can be used as long as it is intermittently transmitted at a frequency of once in about a few seconds or more. By employing another signal, a weak signal which reaches to a range of about a few meters can be used so the power consumption of the mobile phone can be reduced by that amount.

In the present embodiment, the terminal 203 decrypts the personal ID of the IC tag 201 using the ID information received from the mobile phone 204 as a key. However, as long as the host computer 207 already knows or can recognize, a signal obtained by arbitrarily calculating the signal 205 received from the mobile phone 204 and the signal 202 received from the IC tag 201 may be sent to the host computer 207. Sending and receiving between the host computer 207 and the terminal 203 may be in any form such as wired, wireless, one-way communication, bidirectional communication, or the like.

In the present embodiment, if the customer does not carry the mobile phone 204, for example, withdrawal is not permitted. However, if some money is deposited to the card having the IC tag in the form of electronic money or the like, the settlement may be performed within that range.

In the present embodiment, the decrypted personal ID of the IC tag 201 is sent to the host computer 207. However, the signal may be sent as it remains encrypted, and may be decrypted at the host computer 207.

The signal input from the IC tag 201 to the terminal 203 may include address information of the host computer 207. Since the address information is included, the signal 206 can be sent to the host computer 207 even when the terminal 203 does not have address information of the host computer 207.

Even if the address information is not included, if the personal ID is a personal ID which is authenticated by an authentication organization which is designated by the terminal 203 and has known address information, it can be used. However, by including the address information, the personal ID authenticated by another authentication organization can be used. In this way, the number of the personal IDs can be prevented from increasing, and the customers do not have to increase the personal IDs. Thus, management of the personal IDs becomes easy.

The signal input from the mobile phone 204 to the terminal 203 may also include the address information of the host computer 207. Since the address information is included, the signal 206 can be sent to the host computer 207 even when the terminal 203 does not have address information of the host computer 207.

Even if the address information is not included, if the personal ID is a personal ID which is authenticated by an authentication organization which is designated by the terminal 203 and has known address information, it can be used. However, by including the address information, the personal ID authenticated by another authentication organization can be used. In this way, the number of the personal IDs can be prevented from increasing, and the customers do not have to increase the personal IDs. Thus, management of the personal IDs becomes easy.

The signal input from the terminal 203 to the host computer 207 may include the address information of the terminal 203. Since the address information is included, a sending process to the host computer 207 and a receiving process from the host computer 207 can be separated. This allows selecting communication means other than bidirectional communication, and the range of choices for the communication means can be expanded.

Further, the signal input from the host computer 207 to the terminal 203 may include address information of an object to be billed. By including the address information, the terminal 203 can quickly bill.

In the present embodiment, the terminal 203 having a reader function reads the signal 202. However, the signal 202 may be sent to the terminal 203 by an operation of the customer. If the signal 202 is sent upon the customer's operation, it is no longer necessary to send the personal ID when the signal 202 does not have to be sent. Thus, the security level of the personal information can be further enhanced than that in the case where the personal IDs are always transmitted.

The terminal 203 may receive only a signal from the IC tag 201 within a range of about a few meters. In this way, crossed line with signals sent from other IC tags can be prevented.

In the present embodiment, the terminal 203 having a reader function reads the signal 202. However, transmission of the personal ID from the IC tag 201 may be performed at a timing different from that of transmitting the ID information of the mobile phone 204 from the IC tag 201. By sending the personal ID of the IC tag 201 only under a predetermined condition, the security level of the personal information can be further enhanced than that in the case where the personal IDs are always transmitted.

An example of transmitting the personal ID of the IC tag 201 at the different timing is as follows. First, the IC tag 201 transmits only the ID information of the mobile phone 204, and the terminal 203 confirms the ID information transmitted from the mobile phone 204. Then, upon a request from the terminal 203, the IC tag 201 may transmit the personal ID of the IC tag 201. In this way, the personal ID of the IC tag is not transmitted any longer when a mobile phone which does not transmit correct ID information due to misuse is being used. Thus, the security level of the personal information can be further enhanced.

As another example, the IC tag 201 receives the ID information of the mobile phone 204 first, and is triggered by it to transmit the personal ID of the IC tag 201. Transmission of the ID information of the mobile phone 204 from the IC tag 201 may be before or after reception of the ID information of the mobile phone 204, or at the same timing. This allows omitting receiving means of the terminal 203 which is for receiving from the mobile phone 204.

The transmission of the personal ID from the IC tag 201 may be performed intermittently for a predetermined period of time once transmission is performed. In this way, it is ensured that the personal ID can be sent to the terminal 203.

In the present embodiment, the mobile phone 204 intermittently transmits the ID information. However, transmission may be performed upon an operation of the customer in the case of emergency, in the case where timing has to be adjusted with respect to the receiving side, or the like. Similarly, when the communication between the IC tag 201, the terminal 203, and the mobile phone 204 has to be performed at a predetermined timing, transmission of the ID information from the mobile phone 204 may be triggered by the IC tag 201 or the terminal 203.

Further, transmission of predetermined information stored in the IC tag 201 such as the personal ID, the ID information of the mobile phone 204 and the like may be stopped by sending a predetermined signal to the IC tag 201. This reduces a risk of misuse in the case of loss.

Moreover, predetermined information stored in the IC tag 201 such as the personal ID, the ID information of the mobile phone 204 and the like may be erased by sending a predetermined signal to the IC tag 201. This reduces a risk of misuse in the case of loss.

Furthermore, predetermined information stored in the IC tag 201 such as the personal ID, the ID information of the mobile phone 204 and the like may be transferred to a predetermined device by sending a predetermined signal to the IC tag 201. This reduces a risk of misuse in the case of loss, and also allows reuse of the information which has been stored in the IC tag 201.

Further, transmission of the ID information and the like of the mobile phone 204 may be stopped by sending a predetermined signal to the IC tag 201. This reduces a risk of misuse in the case of loss.

Moreover, predetermined information stored in the mobile phone 204 such as the ID information and the like may be erased by sending a predetermined signal to the IC tag 201. This reduces a risk of misuse in the case of loss.

Furthermore, predetermined information stored in the mobile phone 204 such as the ID information and the like may be transferred to a predetermined device by sending a predetermined signal to the IC tag 201. This reduces a risk of misuse in the case of loss, and also allows reuse of the information which has been stored in the mobile phone 204.

Alternatively, by sending a predetermined signal to the host computer 207, authentication of the terminal 203 may be stopped, or may notify the terminal 203 of a misuse.

Further, in the case of loss or the like, a predetermined code number may be input for transmitting a predetermined signal to the IC tag 201, the terminal 203, or the mobile phone 204, and the signal may be sent only when the code number is correct. This can prevent erroneous suspension of a predetermined function.

Further, the host computer 207 may be set to perform authentication only at a predetermined place. For example, the name of the store which is designated by the customer is previously registered to the host computer 207. Authentication is not performed at a store which is not designated even when a predetermined signal is sent. In this way, misuse can be prevented.

Moreover, the host computer 207 may be set to perform authentication only within a predetermined time zone. For example, a time zone designated by the customer is previously registered to the host computer 207. Authentication is not performed in time zones which are not designated even when a predetermined signal is sent. In this way, misuse can be prevented.

In the present embodiment, the signal sent from the IC tag 201 to the terminal 203 includes the ID information of the mobile phone 204 with the encrypted personal ID of the IC tag 201. The terminal 203 reads the signal input from the IC tag 201, and checks whether it has received the ID information of the mobile phone 204 which is intermittently transmitted. When the terminal 203 confirms reception of the ID information which matches the ID information received from the IC tag 201, the terminal 203 decrypts the personal ID of the IC tag 201 using the ID information as a key. Then, the terminal 203 sends the decrypted personal ID of the IC tag 201 to the host computer 207. However, the signal sent to the terminal 203 from the IC tag 201 may be sent to the mobile phone 204, and the decrypted personal ID may be sent from the mobile phone 204 to the host computer 207.

Thus, the personal ID of the IC tag 201 is no longer necessary to be sent to the terminal 203. The personal information of the IC tag 201 is just sent to the host computer 207. Thus, compared to the case where the personal ID is transmitted to each terminal every time for shopping, the security level of the personal information can be further enhanced.

In the present embodiment, settlement is permitted when there are both the mobile phone 204 and the IC tag 201 (see FIG. 4A). However, settlement with either device may be permitted within a limited extent upon previous registration with both the mobile phone 204 and the IC tag 201. Such an example will be described with reference to FIGS. 4B through 4D. Herein, the limited extent refers to the amount of money which can be settled, the number of times allowed to settle, the time zone in which settlement is permitted (for example, between 9 AM to 10 AM), the time period permitted to settle (for example, one day), the time limit for settlement (for example, until August 5), the area in which settlement is permitted, and the like.

With such a feature, even when, for example, the customer notices that he/she has forgotten the mobile phone 204 at the time he/she tries to settle, or the power of the mobile phone 204 is insufficient or the mobile phone 204 has a failure, or settlement is to be performed in a place where the mobile phone 204 has to be turned off, the settlement can be performed with only the IC tag 201 if the information is registered such that the settlement is permitted for just once with the upper limit of the amount of money being determined.

The registration may be performed by, for example, sending the ID information of the mobile phone 204, or information obtained by arbitrarily calculating the ID information and the limitation information for limiting the range of use from the mobile phone 204 to the IC tag 201 (see FIG. 4B or 4C). The terminal 203 receives the information, and then sends the decrypted personal ID of the IC tag 201 to the host computer without receiving the ID information from the mobile phone 204 (see FIG. 4D).

Updating of the limitation information shown in FIG. 4D means that, for example, in the case where the number of times to permit settlement is “once”, if withdrawal is performed using only the IC tag 201, the limitation information is updated, and the number of times of settlement is updated to “zero”.

In the present embodiment, the signal sent from the IC tag 201 to the terminal 203 includes the ID information of the mobile phone 204 with the encrypted personal ID of the IC tag 201. The terminal 203 reads the signal input from the IC tag 201, and checks whether it has received the ID information of the mobile phone 204 which is intermittently transmitted. When the terminal 203 confirms reception of the ID information which matches the ID information received from the IC tag 201, the terminal 203 decrypts the personal ID of the IC tag 201 using the ID information as a key. Then, the terminal 203 sends the decrypted personal ID of the IC tag 201 to the host computer 207. The host computer 207 searches whether the personal ID of the IC tag 201 is in a predetermined database of personal IDs. If the host computer 207 can confirm that the personal ID exists, it sends the signal to permit settlement to the terminal 203. However, the host computer 207 may input the limitation information to the terminal later, and the terminal 203 may send the ID information of the mobile phone 204, or information obtained by arbitrarily calculating the ID information and the limitation information for limiting the range of use to the IC tag 201 (see FIG. 4C). Alternatively, the limitation information may be stored in the terminal or the host computer.

The method of registering can be any method other than the method of the present embodiment as long as it is performed after the user is authenticated.

In the case where the power supply of the mobile phone 204 is insufficient, the IC tag 201 may be notified by a sound or vibration.

Similarly, if previously registered, the limited settlement using only the mobile phone 204 may be permitted in the case of a failure of the IC tag 201.

This allows, for example, asking other person to settle with passing only the IC tag as the owner keeps the mobile phone 204.

Functions of the mobile phone 204 may be transferred to an IC tag different from the IC tag 201 or a mobile phone within a limited extent if it is previously registered with both the mobile phone 204 and the IC tag 201. Herein, the limited extent refers to the amount of money which can be settled, the number of times allowed to settle, the time zone in which settlement is permitted (for example, between 9 AM to 10 AM), the time period permitted to settle (for example, for one day or until August 5), the area in which settlement is permitted, and the like. In this way, even in the case where the mobile phone 204 cannot be used, another IC tag or mobile phone can carry out the functions for it within the limited extent so that settlement can be performed within the limited extent without lowering the security level.

The extent of limitation may be varied depending upon the cases, for example, the case where there are both the mobile phone 204 and the IC tag, the case where there are a substituting device for the mobile phone 204 and the IC tag, the case where there is only the registered tag, and the case where there is an IC tag which is not registered.

In the present embodiment, the signal sent from the IC tag 201 to the terminal 203 includes the ID information of the mobile phone 204 with the encrypted personal ID of the IC tag 201. The terminal 203 reads the signal input from the IC tag 201, and checks whether it has received the ID information of the mobile phone 204 which is intermittently transmitted. When the terminal 203 confirms reception of the ID information which matches the ID information received from the IC tag 201, the terminal 203 decrypts the personal ID of the IC tag 201 using the ID information as a key. Then, the terminal 203 sends the decrypted personal ID of the IC tag 201 to the host computer 207. However, the signal sent from the IC tag 201 to the terminal 203 may not include the ID information of the mobile phone 204. The terminal 203 may receive the ID information of any mobile phone and decrypts it to send to the host computer. If there are a number of mobile phones around the terminal 203, it may take some time for the terminal 203 to obtain the ID information of the mobile phone 204. However, in this way, the ID information of the mobile phone is no longer necessary to be stored in the IC tag 201, so the security level can be enhanced in terms of protecting the ID information of the mobile phone.

In the present embodiment, the personal ID of the IC tag 201 is decrypted using the ID information of the mobile phone as a key, and the decrypted personal ID of the IC tag 201 is sent to the host computer. However, the present invention is not limited to such an example, and the settlement may be permitted by simply having both the ID of the mobile phone and the signal sent from the IC tag. In this way, decrypting means is no longer necessary, and the system can be simplified.

In the present embodiment, the signal sent from the IC tag 201 to the terminal 203 includes the ID information of the mobile phone 204 with the encrypted personal ID of the IC tag 201. The terminal 203 reads the signal input from the IC tag 201, and checks whether it has received the ID information of the mobile phone 204 which is intermittently transmitted. When the terminal 203 confirms reception of the ID information which matches the ID information received from the IC tag 201, the terminal 203 decrypts the personal ID of the IC tag 201 using the ID information as a key. Then, the terminal 203 sends the decrypted personal ID of the IC tag 201 to the host computer 207. However, the signal sent from the IC tag 201 to the terminal 203 may include mail address information or a telephone number of the mobile phone 204. When the terminal 203 receives the signal output from the IC tag, it may send mail to or call the mobile phone 204, and upon a predetermined receiving operation (clicking a predetermined button or the like) on the mobile phone 204, settlement may be permitted. In this way, decrypting means is no longer necessary, and the system can be simplified.

### Third Embodiment

Hereinafter, another embodiment of the present invention is described with reference to the drawings. FIG. 5 shows a structure of an authentication system according to another embodiment of the present invention. FIG. 5 illustrates a method of authentication for entering a building or a car. In FIG. 5, reference numeral 301 denotes an IC tag, reference numeral 303 denotes a terminal, reference numeral 304 denotes a mobile phone, and reference numeral 307 denotes a host computer.

Now, the authentication system in the third embodiment is described. A person who wants to enter holds the IC tag 301 over the terminal 303 of the door. A form of the IC tag 301 may be a card or the like with an IC tag being embedded. The door reads a signal 302 by the terminal 303 having a reader function for the IC tag 301.

The signal 302 includes a personal ID of the IC tag 301 which is encrypted, and also ID information of the mobile phone 304. The terminal 303 checks whether it has received the ID information of the mobile phone 304.

In general, mobile phones have a function to switch base stations as they move so that call is not interrupted while they are moving, and intermittently transmit a signal to notify their current positions to the base stations.

In the present embodiment, such a signal is utilized. The signal transmitted by the mobile phone includes at least ID information specific to the mobile phone 304. The receiving sensitivity of the terminal 303 for the ID information of the mobile phone is suppressed to be lower than the receiving sensitivity of the base stations, and the terminal 303 can receive the ID information only from the mobile phones within the range of about a few meters.

If the terminal 303 confirms reception of the ID information which matches the ID information received from the IC tag 301 (305), the personal ID of the IC tag 301 is decrypted using the ID information as a key. Then, the terminal 303 sends the decrypted personal ID of the IC tag 301 to the host computer 307 (306). The host computer 307 searches whether the personal ID of the IC tag 301 exists in a predetermined database of personal IDs. If it is confirmed to exist, the host computer 307 sends a signal to confirm authentication to the terminal 303 (308), and the door is unlocked.

As described above, by the authentication system of the present embodiment, the personal ID is decrypted using two devices, i.e., the IC tag 301 and the mobile phone 304. Thus, security level can be improved.

Furthermore, since the mobile phone 304 is used, original functions of mobile phones, such as a function for transmitting signal or the power supply can be utilized, and thus, authentication of an individual can be performed with a simple structure. Further, since the ID information intermittently transmitted from the mobile phone 304 is utilized, there is no need to request the mobile phone 304 to transmit the ID information from the terminal 303, and thus, a time period necessary for authentication is reduced.

Usually, if the number of so-called keys is increased in order to improve the level of security, the operations become complicated, and may impair convenience of the person who wants to enter. However, in the present embodiment, the ID information which is intermittently transmitted from the mobile phone 304 is used so the authentication can be performed without impairing convenience of the person who wants to enter.

In the present embodiment, the IC tag 301 is formed into a card. However, it may be in any form such as a key ring, a bracelet, a watch with the IC tag being embedded, or the like.

Since the IC tag cannot complete the authentication by itself, a plurality of IC tags may be provided in view of the case of losing or failing to bring the IC tag.

In the present embodiment, a signal of the mobile phone for notifying base stations of its position is used. However, any signal other than the signal for notifying base stations of the position can be used as long as it is intermittently transmitted at a frequency of once in about a few seconds or more. By employing another signal, a weak signal which reaches only in a range of about a few meters can be used so the power consumption of the mobile phone can be reduced by that amount.

In the present embodiment, the terminal 303 decrypts the personal ID of the IC tag 301 using the ID information received from the mobile phone 304 as a key. However, as long as the host computer 307 already knows or can recognize, a signal obtained by arbitrarily calculating the signal 305 received from the mobile phone 304 and the signal 302 received from the IC tag 301 may be sent to the host computer 307. Sending and receiving between the host computer 307 and the terminal 303 may be in any form such as wired, wireless, one-way communication, bidirectional communication, or the like.

In the present embodiment, the decrypted personal ID of the IC tag 301 is sent to the host computer 307. However, the signal may be sent as it remains encrypted, and may be decrypted at the host computer 307.

In the present embodiment, the terminal 303 having a reader function reads the signal 302. However, the signal 302 may be sent to the terminal 303 by an operation of the person who wants to enter. If the signal 302 is sent upon the operation by the person who wants to enter, it is no longer necessary to send the personal ID when the signal 302 does not have to be sent. Thus, the security level of the personal information can be further enhanced than that in the case where the personal IDs are always transmitted.

The terminal 303 may receive only a signal from the IC tag 301 within a range of about a few meters. In this way, crossed line with signals sent from other IC tags can be prevented.

In the present embodiment, the terminal 303 having a reader function reads the signal 302. However, transmission of the personal ID from the IC tag 301 may be performed at timing different from that of transmitting the ID information of the mobile phone 304 from the IC tag 301. By sending the personal ID of the IC tag 301 only under a predetermined condition, the security level of the personal information can be further enhanced than that in the case where the personal IDs are always transmitted.

An example of transmitting the personal ID of the IC tag 301 at the different timing is as follows. First, the IC tag 301 transmits only the ID information of the mobile phone 304, and the terminal 303 confirms the ID information transmitted from the mobile phone 304. Then, upon a request from the terminal 203, the IC tag 301 may transmit the personal ID of the IC tag 301. In this way, the personal ID of the IC tag is not transmitted any longer when a mobile phone which does not transmit correct ID information due to misuse is being used. Thus, the security level of the personal information can be further enhanced.

As another example, the IC tag 301 receives the ID information of the mobile phone 304 first, and is triggered by it to transmit the personal ID of the IC tag 301. Transmission of the ID information of the mobile phone 304 from the IC tag 301 may be before or after reception of the ID information of the mobile phone 304, or at the same timing. This allows omitting receiving means of the terminal 303 which is for receiving from the mobile phone 304.

The transmission of the personal ID from the IC tag 301 may be performed intermittently for a predetermined period of time once transmission is performed. In this way, it is ensured that the personal ID can be sent to the terminal 303.

In the present embodiment, the mobile phone 304 intermittently transmits the ID information. However, transmission may be performed upon an operation of the person who wants to enter in the case of emergency, in the case where timing has to be adjusted with respect to the receiving side, or the like. Similarly, when the communication between the IC tag 301, the terminal 303, and the mobile phone 304 has to be performed at a predetermined timing, transmission of the ID information from the mobile phone 304 may be triggered by the IC tag 301 or the terminal 303.

Further, transmission of predetermined information stored in the IC tag 301 such as the personal ID, the ID information of the mobile phone 304 and the like may be stopped by sending a predetermined signal to the IC tag 301. This reduces a risk of misuse in the case of loss.

Moreover, predetermined information stored in the IC tag 301 such as the personal ID, the ID information of the mobile phone 304 and the like may be erased by sending a predetermined signal to the IC tag 301. This reduces a risk of misuse in the case of loss.

Furthermore, predetermined information stored in the IC tag 301 such as the personal ID, the ID information of the mobile phone 304 and the like may be transferred to a predetermined device by sending a predetermined signal to the IC tag 301. This reduces a risk of misuse in the case of loss, and also allows reuse of the information which has been stored in the IC tag 301.

Further, transmission of the ID information and the like of the mobile phone 304 may be stopped by sending a predetermined signal to the IC tag 301. This reduces a risk of misuse in the case of loss.

Moreover, predetermined information stored in the mobile phone 304 such as the ID information and the like may be erased by sending a predetermined signal to the IC tag 301. This reduces a risk of misuse in the case of loss.

Furthermore, predetermined information stored in the mobile phone 304 such as the ID information and the like may be transferred to a predetermined device by sending a predetermined signal to the IC tag 301. This reduces a risk of misuse in the case of loss, and also allows reuse of the information which has been stored in the mobile phone 304.

Alternatively, by sending a predetermined signal to the host computer 207, authentication of the terminal 303 may be stopped, or may notify the terminal 303 of a misuse.

Further, in the case of loss or the like, a predetermined code number may be input for transmitting a predetermined signal to the IC tag 301, the terminal 303, or the mobile phone 304, and the signal may be sent only when the code number is correct. This can prevent erroneous suspension of a predetermined function.

Moreover, the host computer 307 may be set to perform authentication only within a predetermined time zone. For example, a time zone designated by the customer is previously registered to the host computer 307. Authentication is not performed in time zones which are not designated even when a predetermined signal is sent. In this way, misuse can be prevented.

In the present embodiment, the signal sent from the IC tag 301 to the terminal 303 includes the ID information of the mobile phone 304 with the encrypted personal ID of the IC tag 301. The terminal 303 reads the signal input from the IC tag 301, and checks whether it has received the ID information of the mobile phone 304 which is intermittently transmitted. When the terminal 303 confirms reception of the ID information which matches the ID information received from the IC tag 301, the terminal 303 decrypts the personal ID of the IC tag 301 using the ID information as a key. Then, the terminal 303 sends the decrypted personal ID of the IC tag 301 to the host computer 307. However, the signal sent to the terminal 303 from the IC tag 301 may be sent to the mobile phone 304, and the decrypted personal ID may be sent from the mobile phone 304 to the host computer 307.

For room entry in the case of loss of the IC tag 301 and/or the mobile phone 304, means for unlocking or locking which uses a code number may be provided.

Further, a locking system for preventing failing to bring the IC tag 301 and/or the mobile phone 304 may also be provided. FIG. 6 is a diagram illustrating a locking system used when a person leave a building or a car. In FIG. 6, reference numeral 601 denotes an IC tag, reference numeral 603 denotes a terminal, reference numeral 604 denotes a mobile phone, reference numeral 607 denotes a sensor, and reference numeral 609 denotes an alarm. The locking system is described below.

For leaving a building, first, the sensor 607 senses a person, and sends a signal 606 to the terminal 603. Then, the terminal 603 confirms whether a signal 602 is input from a predetermined IC tag 601. If the signal has not been input after a predetermined period of time elapsed, the terminal 603 sends a signal 608 to the alarm. The alarm 609 transmits warning. To the terminal 603, IC tags of members who need the locking systems are previously registered.

The sensor 607 may be of a type detecting a temperature, a type detecting a weight, or a type detecting interruption of light.

The signal 602 includes the ID information of the mobile phone 604 with the encrypted personal ID of the IC tag 601. If the signal 602 is sent from the IC tag 601, the terminal 603 checks whether it has received the ID information 605 of the mobile phone 604.

For sending the signal 602, for example, a person who wants to exit holds the IC tag 601 over the terminal 603. The terminal 603 of the door, which has a reader function for the IC tag 601, reads the signal 602.

The terminal 603 confirms whether the signal 605 is input from the mobile phone 604. If the signal has not been input after a predetermined period of time elapsed, the terminal 603 sends a signal 608 to the alarm. The alarm 609 transmits warning. If the signal 605 has been input, the terminal 603 locks the door.

The signal 605 may be sent from the mobile phone 604 intermittently, or may be sent upon an operation by the person who wants to exit.

To the terminal 603, IC tags of members who need the locking systems are previously registered. The ID information of the mobile phones may be registered together. If the ID information of the mobile phones is registered, the terminal 603 has to receive just the personal ID of the IC tag 601 from the IC tag 601. Thus, a time period necessary for locking can be reduced.

As described above, the locking system of the present embodiment ensure that the IC tag 601 and/or the mobile phone 604 is carried when the person leaves.

In the present embodiment, unlocking is permitted when there are both the mobile phone 304 and the IC tag 301 (see FIG. 7A). However, unlocking with either device may be permitted within a limited extent upon previous registration with both the mobile phone 304 and the IC tag 301. Such an example will be described with reference to FIGS. 7B through 7D. Herein, the limited extent refers to the number of times allowed to unlock, the time zone in which unlocking is permitted (for example, between 9 AM to 10 AM), the time period permitted to unlock (for example, one day), the time limit for unlocking (for example, until August 5), and the like.

With such a feature, even when, for example, the person who wants to enter notices that he/she has forgotten the mobile phone 304 at the time he/she tries to unlock, or the power of the mobile phone 304 is insufficient or the mobile phone 304 has a failure, or unlocking is to be performed in a place where the mobile phone 304 has to be turned off, the unlocking can be performed with only the IC tag 301 if the information is registered such that the unlocking is permitted for just once with the upper limit of the amount of money being determined.

The registration may be performed by, for example, sending the ID information of the mobile phone 304, or information obtained by arbitrarily calculating the ID information and the limitation information for limiting the range of use from the mobile phone 304 to the IC tag 301 (see FIG. 7B or 7C). The terminal 303 receives the information, and then sends the decrypted personal ID of the IC tag 301 to the host computer without receiving the ID information from the mobile phone 304 (see FIG. 7D).

Updating of the limitation information shown in FIG. 7D means that, for example, in the case where the number of times to permit unlocking is “once”, if unlocking is performed using only the IC tag 301, the limitation information is updated, and the number of times of unlocking is updated to “zero”.

In the present embodiment, the signal sent from the IC tag 301 to the terminal 303 includes the ID information of the mobile phone 304 with the encrypted personal ID of the IC tag 301. The terminal 303 reads the signal input from the IC tag 301, and checks whether it has received the ID information of the mobile phone 304 which is intermittently transmitted. When the terminal 303 confirms reception of the ID information which matches the ID information received from the IC tag 301, the terminal 303 decrypts the personal ID of the IC tag 301 using the ID information as a key. Then, the terminal 303 sends the decrypted personal ID of the IC tag 301 to the host computer 307. The host computer 307 searches whether the personal ID of the IC tag 301 is in a predetermined database of personal IDs. If the host computer 307 can confirm that the personal ID exists, it sends the signal to permit unlocking to the terminal 303. However, the host computer 307 may input the limitation information to the terminal later, and the terminal 303 may send the ID information of the mobile phone 304, or information obtained by calculating the ID information and the limitation information for limiting the range of use to the IC tag 301 (see FIG. 7C). Alternatively, the limitation information may be stored in the terminal or the host computer.

The method of registering can be any method other than the method of the present embodiment as long as it is performed after the user is authenticated.

In the case where the power supply of the mobile phone 304 is insufficient, the IC tag 301 may be notified by a sound or vibration.

Similarly, if previously registered, the limited unlocking using only the mobile phone 304 may be permitted in the case of a failure of the IC tag 301.

This allows, for example, asking other person to unlock with passing only the IC tag as the owner keeps the mobile phone 304.

Functions of the mobile phone 304 may be transferred to an IC tag different from the IC tag 301 or a mobile phone within a limited extent if they are previously registered with both the mobile phone 304 and the IC tag 301. Herein, the limited extent refers the number of times allowed to unlock, the time zone in which unlocking is permitted (for example, between 9 AM to 10 AM), the time period permitted to unlock (for example, for one day), the time limit for unlocking (for example, until August 5), and the like. In this way, even in the case where the mobile phone 304 cannot be used, another IC tag or mobile phone can carry out the functions for it within the limited extent so that unlocking can be performed within the limited extent without lowering the security level.

The extent of limitation may be varied depending upon the cases, for example, the case where there are both the mobile phone 304 and the IC tag, the case where there are a substituting device for the mobile phone 304 and the IC tag, the case where there is only the registered tag, and the case where there is an IC tag which is not registered.

In the present embodiment, the signal sent from the IC tag 301 to the terminal 303 includes the ID information of the mobile phone 304 with the encrypted personal ID of the IC tag 301. The terminal 303 reads the signal input from the IC tag 301, and checks whether it has received the ID information of the mobile phone 304 which is intermittently transmitted. When the terminal 303 confirms reception of the ID information which matches the ID information received from the IC tag 301, the terminal 303 decrypts the personal ID of the IC tag 301 using the ID information as a key. Then, the terminal 303 sends the decrypted personal ID of the IC tag 301 to the host computer 307. However, the signal sent from the IC tag 301 to the terminal 303 may not include the ID information of the mobile phone 304. The terminal 303 may receive the ID information of any mobile phone and decrypts it to send to the host computer. If there are a number of mobile phones around the terminal 303, it may take some time for the terminal 303 to obtain the ID information of the mobile phone 304. However, in this way, the ID information of the mobile phone is no longer necessary to be stored in the IC tag 301, so the security level can be enhanced in terms of protecting the ID information of the mobile phone.

In the present embodiment, the personal ID of the IC tag 301 is decrypted using the ID information of the mobile phone as a key, and the decrypted personal ID of the IC tag 301 is sent to the host computer. However, the present invention is not limited to such an example, and the unlocking may be permitted by simply having both the ID of the mobile phone and the signal sent from the IC tag. In this way, decrypting means is no longer necessary, and the system can be simplified.

In the present embodiment, the signal sent from the IC tag 301 to the terminal 303 includes the ID information of the mobile phone 304 with the encrypted personal ID of the IC tag 301. The terminal 303 reads the signal input from the IC tag 301, and checks whether it has received the ID information of the mobile phone 304 which is intermittently transmitted. When the terminal 303 confirms reception of the ID information which matches the ID information received from the IC tag 301, the terminal 303 decrypts the personal ID of the IC tag 301 using the ID information as a key. Then, the terminal 303 sends the decrypted personal ID of the IC tag 301 to the host computer 307. However, the signal sent from the IC tag 301 to the terminal 303 includes mail address information or a telephone number of the mobile phone 304. When the terminal 303 receives the signal output from the IC tag, it may send mail to or call the mobile phone 304, and upon a predetermined receiving operation (clicking a predetermined button or the like) on the mobile phone 304, unlocking may be permitted. In this way, decrypting means is no longer necessary, and the system can be simplified.

### Fourth Embodiment

Hereinafter, another embodiment of the present invention is described with reference to the drawings. FIG. 8 shows a structure of an authentication system according to another embodiment of the present invention. FIG. 8 illustrates an authentication method when asking to disclose or issue a certificate at a government office and the like. In FIG. 8, reference numeral 401 denotes an IC tag, reference numeral 403 denotes a terminal, reference numeral 404 denotes a mobile phone, reference numeral 407 denotes a host computer, and reference numeral 410 denotes a monitor.

Now, the authentication system in the fourth embodiment is described. First, a person who wants to ask holds the IC tag 401 over the terminal 403 at the government office. A form of the IC tag 401 may be a card or the like with an IC tag being embedded. The terminal 403 has a reader function for the IC tag 401 and reads a signal 402.

The signal 402 includes a personal ID of the IC tag 401 which is encrypted, and also ID information of the mobile phone 404. The terminal 403 checks whether it has received the ID information of the mobile phone 404.

In general, mobile phones have a function to switch base stations as they move so that call is not interrupted while they are moving, and intermittently transmit a signal to notify their current positions to the base stations.

In the present embodiment, such a signal is utilized. The signal transmitted by the mobile phone includes at least ID information specific to the mobile phone 404. The receiving sensitivity of the terminal 403 for the ID information of the mobile phone is suppressed to be lower than the receiving sensitivity of the base stations, and the terminal 403 can receive the ID information only from the mobile phones within the range of about a few meters.

If the terminal 403 confirms reception of the ID information which matches the ID information received from the IC tag 401 (405), the personal ID of the IC tag 301 is decrypted using the ID information as a key. Then, the terminal 403 sends the decrypted personal ID of the IC tag 401 to the host computer 407 (406). The host computer 407 searches whether the personal ID of the IC tag 401 exists in a predetermined database of personal IDs. If it is confirmed to exist, the host computer 407 sends a signal to confirm authentication to the terminal 403 (408), and the certificate is displayed on the monitor 410 or output from a printer.

As described above, by the authentication system of the present embodiment, the personal ID is decrypted using two devices, i.e., the IC tag 401 and the mobile phone 404. Thus, security level can be improved.

Furthermore, since the mobile phone 404 is used, original functions of mobile phones, such as a function for transmitting signal or the power supply can be utilized, and thus, authentication of an individual can be performed with a simple structure. Further, since the ID information intermittently transmitted from the mobile phone 404 is utilized, there is no need to request the mobile phone 404 to transmit the ID information from the terminal 403, and thus, a time period necessary for authentication is reduced.

Usually, if the number of so-called keys is increased in order to improve the level of security, the operations become complicated, and may impair convenience of the customer. However, in the present embodiment, the ID information which is intermittently transmitted from the mobile phone 404 is used so the authentication can be performed without impairing convenience of the customer.

In the present embodiment, the IC tag 401 is formed into a card. However, it may be in any form such as a key ring, a bracelet, a watch with the IC tag being embedded, or the like.

Since the IC tag cannot complete the authentication by itself, a plurality of IC tags may be provided in view of the case of losing or failing to bring the IC tag.

In the present embodiment, a signal of the mobile phone for notifying base stations of its position is used. However, any signal other than the signal for notifying base stations of the position can be used as long as it is intermittently transmitted at a frequency of once in about a few seconds or more. By employing another signal, a weak signal which reaches to a range of about a few meters can be used so the power consumption of the mobile phone can be reduced by that amount.

In the present embodiment, the terminal 403 decrypts the personal ID of the IC tag 401 using the ID information received from the mobile phone 404 as a key. However, as long as the host computer 407 already knows or can recognize, a signal obtained by arbitrarily calculating the signal 405 received from the mobile phone 404 and the signal 402 received from the IC tag 401 may be sent to the host computer 407. Sending and receiving between the host computer 407 and the terminal 403 may be in any form such as wired, wireless, one-way communication, bidirectional communication, or the like.

In the present embodiment, the decrypted personal ID of the IC tag 401 is sent to the host computer 407. However, the signal may be sent as it remains encrypted, and may be decrypted at the host computer 407.

The signal input from the IC tag 401 to the terminal 403 may include address information of the host computer 407. Since the address information is included, the signal 406 can be sent to the host computer 407 even when the terminal 403 does not have address information of the host computer 407.

Even if the address information is not included, if the personal ID is a personal ID which is authenticated by an authentication organization which is designated by the terminal 403 and has known address information, it can be used. However, by including the address information, the personal ID authenticated by another authentication organization can be used. In this way, the number of the personal IDs can be prevented from increasing, and the customers do not have to increase the personal IDs. Thus, management of the personal IDs becomes easy.

The signal input from the mobile phone 404 to the terminal 403 may also include the address information of the host computer 407. Since the address information is included, the signal 406 can be sent to the host computer 407 even when the terminal 403 does not have address information of the host computer 407.

Even if the address information is not included, if the personal ID is a personal ID which is authenticated by an authentication organization which is designated by the terminal 403 and has known address information, it can be used. However, by including the address information, the personal ID authenticated by another authentication organization can be used. In this way, the number of the personal IDs can be prevented from increasing, and the customers do not have to increase the personal IDs. Thus, management of the personal IDs becomes easy.

The signal input from the terminal 403 to the host computer 407 may include the address information of the terminal 403. Since the address information is included, a sending process to the host computer 407 and a receiving process from the host computer 407 can be separated. This allows selecting communication means other than bidirectional communication, and the range of choices for the communication means can be expanded.

In the present embodiment, the terminal 403 having a reader function reads the signal 402. However, the signal 402 may be sent to the terminal 403 by an operation of the customer. If the signal 402 is sent upon the customer's operation, it is no longer necessary to send the personal ID when the signal 402 does not have to be sent. Thus, the security level of the personal information can be further enhanced than that in the case where the personal IDs are always transmitted.

The terminal 403 may receive only a signal from the IC tag 401 within a range of about a few meters. In this way, crossed line with signals sent from other IC tags can be prevented.

In the present embodiment, the terminal 403 having a reader function reads the signal 402. However, transmission of the personal ID from the IC tag 401 may be performed at a timing different from that of transmitting the ID information of the mobile phone 404 from the IC tag 401. By sending the personal ID of the IC tag 401 only under a predetermined condition, the security level of the personal information can be further enhanced than that in the case where the personal IDs are always transmitted.

An example of transmitting the personal ID of the IC tag 401 at the different timing is as follows. First, the IC tag 401 transmits only the ID information of the mobile phone 404, and the terminal 403 confirms the ID information transmitted from the mobile phone 404. Then, upon a request from the terminal 403, the IC tag 401 may transmit the personal ID of the IC tag 401. In this way, the personal ID of the IC tag is not transmitted any longer when a mobile phone which does not transmit correct ID information due to misuse is being used. Thus, the security level of the personal information can be further enhanced.

As another example, the IC tag 401 receives the ID information of the mobile phone 404 first, and is triggered by it to transmit the personal ID of the IC tag 401. Transmission of the ID information of the mobile phone 404 from the IC tag 401 may be before or after reception of the ID information of the mobile phone 404, or at the same timing. This allows omitting receiving means of the terminal 403 which is for receiving from the mobile phone 404.

The transmission of the personal ID from the IC tag 401 may be performed intermittently for a predetermined period of time once transmission is performed. In this way, it is ensured that the personal ID can be sent to the terminal 403.

In the present embodiment, the mobile phone 404 intermittently transmits the ID information. However, transmission may be performed upon an operation of the customer in the case of emergency, in the case where timing has to be adjusted with respect to the receiving side, or the like. Similarly, when the communication between the IC tag 401, the terminal 403, and the mobile phone 404 has to be performed at a predetermined timing, transmission of the ID information from the mobile phone 404 may be triggered by the IC tag 401 or the terminal 403.

Further, transmission of predetermined information stored in the IC tag 401 such as the personal ID, the ID information of the mobile phone 404 and the like may be stopped by sending a predetermined signal to the IC tag 401. This reduces a risk of misuse in the case of loss.

Moreover, predetermined information stored in the IC tag 401 such as the personal ID, the ID information of the mobile phone 404 and the like may be erased by sending a predetermined signal to the IC tag 401. This reduces a risk of misuse in the case of loss.

Furthermore, predetermined information stored in the IC tag 401 such as the personal ID, the ID information of the mobile phone 404 and the like may be transferred to a predetermined device by sending a predetermined signal to the IC tag 401. This reduces a risk of misuse in the case of loss, and also allows reuse of the information which has been stored in the IC tag 401.

Further, transmission of the ID information and the like of the mobile phone 404 may be stopped by sending a predetermined signal to the IC tag 401. This reduces a risk of misuse in the case of loss.

Moreover, predetermined information stored in the mobile phone 404 such as the ID information and the like may be erased by sending a predetermined signal to the IC tag 401. This reduces a risk of misuse in the case of loss.

Furthermore, predetermined information stored in the mobile phone 404 such as the ID information and the like may be transferred to a predetermined device by sending a predetermined signal to the IC tag 401. This reduces a risk of misuse in the case of loss, and also allows reuse of the information which has been stored in the mobile phone 404.

Alternatively, by sending a predetermined signal to the host computer 407, authentication of the terminal 403 may be stopped, or may notify the terminal 403 of a misuse.

Further, in the case of loss or the like, a predetermined code number may be input for transmitting a predetermined signal to the IC tag 401, the terminal 403, or the mobile phone 404, and the signal may be sent only when the code number is correct. This can prevent erroneous suspension of a predetermined function.

Further, the host computer 407 may be set to perform authentication only at a predetermined place. For example, the name of the store which is designated by the customer is previously registered to the host computer 407. Authentication is not performed at a store which is not designated even when a predetermined signal is sent. In this way, misuse can be prevented.

Moreover, the host computer 407 may be set to perform authentication only within a predetermined time zone. For example, a time zone designated by the customer is previously registered to the host computer 407. Authentication is not performed in time zones which are not designated even when a predetermined signal is sent. In this way, misuse can be prevented.

In the present embodiment, the signal sent from the IC tag 401 to the terminal 403 includes the ID information of the mobile phone 404 with the encrypted personal ID of the IC tag 401. The terminal 403 reads the signal input from the IC tag 401, and checks whether it has received the ID information of the mobile phone 404 which is intermittently transmitted. When the terminal 403 confirms reception of the ID information which matches the ID information received from the IC tag 401, the terminal 403 decrypts the personal ID of the IC tag 401 using the ID information as a key. Then, the terminal 403 sends the decrypted personal ID of the IC tag 401 to the host computer 407. However, the signal sent to the terminal 403 from the IC tag 401 may be sent to the mobile phone 404, and the decrypted personal ID may be sent from the mobile phone 404 to the host computer 407.

Thus, the personal ID of the IC tag 401 is no longer necessary to be sent to the terminal 403. The personal information of the IC tag 401 is just sent to the host computer 407. Thus, compared to the case where the personal ID is transmitted to each terminal every time a certificate is issued, the security level of the personal information can be further enhanced.

In the present embodiment, authentication is permitted when there are both the mobile phone 404 and the IC tag 401 (see FIG. 9A). However, authentication with either device may be permitted within a limited extent upon previous registration with both the mobile phone 404 and the IC tag 401. Such an example will be described with reference to FIGS. 9B through 9D. Herein, the limited extent refers to the amount of money which can be authenticated, the number of times allowed to authenticate, the time zone in which authentication is permitted (for example, between 9 AM to 10 AM), the time period permitted to authenticate (for example, for one day), the time limit for authentication (for example, until August 5), the area in which authentication is permitted, and the like.

With such a feature, even when, for example, the user notices that he/she has forgotten the mobile phone 404 at the time he/she tries to be authenticated, or the power of the mobile phone 404 is insufficient or the mobile phone 404 has a failure, or authentication is to be performed in a place where the mobile phone 404 has to be turned off, the authentication can be performed with only the IC tag 401 if the information is registered such that the authentication is permitted for just once with the upper limit of the amount of money being determined.

The registration may be performed by, for example, sending the ID information of the mobile phone 404, or information obtained by arbitrarily calculating the ID information and the limitation information for limiting the range of use from the mobile phone 404 to the IC tag 401 (see FIG. 9B or 9C). The terminal 403 receives the information, and then sends the decrypted personal ID of the IC tag 401 to the host computer without receiving the ID information from the mobile phone 404 (see FIG. 9D).

Updating of the limitation information shown in FIG. 9D means that, for example, in the case where the number of times to permit authentication is “once”, if authentication is performed using only the IC tag 401, the limitation information is updated, and the number of times of authentication is updated to “zero”.

In the present embodiment, the signal sent from the IC tag 401 to the terminal 403 includes the ID information of the mobile phone 404 with the encrypted personal ID of the IC tag 401. The terminal 403 reads the signal input from the IC tag 401, and checks whether it has received the ID information of the mobile phone 404 which is intermittently transmitted. When the terminal 403 confirms reception of the ID information which matches the ID information received from the IC tag 401, the terminal 403 decrypts the personal ID of the IC tag 401 using the ID information as a key. Then, the terminal 403 sends the decrypted personal ID of the IC tag 401 to the host computer 407. The host computer 407 searches whether the personal ID of the IC tag 401 is in a predetermined database of personal IDs. If the host computer 407 can confirm that the personal ID exists, it sends the signal to permit authentication to the terminal 403. However, the host computer 407 may input the limitation information to the terminal later, and the terminal 403 may send the ID information of the mobile phone 404, or information obtained by arbitrarily calculating the ID information and the limitation information for limiting the range of use to the IC tag 401 (see FIG. 9C). Alternatively, the limitation information may be stored in the terminal or the host computer.

The method of registering can be any method other than the method of the present embodiment as long as it is performed after the user is authenticated.

In the case where the power supply of the mobile phone 404 is insufficient, the IC tag 401 may be notified by a sound or vibration.

Similarly, if previously registered, the limited authentication using only the mobile phone 404 may be permitted in the case of a failure of the IC tag 401.

This allows, for example, asking other person to be authenticated with passing only the IC tag as the owner keeps the mobile phone 404.

Functions of the mobile phone 404 may be transferred to an IC tag different from the IC tag 401 or a mobile phone within a limited extent if it is previously registered with both the mobile phone 404 and the IC tag 401. Herein, the limited extent refers to the amount of money which can be authenticated, the number of times allowed to authenticate, the time zone in which authentication is permitted (for example, between 9 AM to 10 AM), the time period permitted to authenticate (for example, one day or until August 5), the area in which authentication is permitted, and the like. In this way, even in the case where the mobile phone 410 cannot be used, another IC tag or mobile phone can carry out the functions for it within the limited extent so that authentication can be performed within the limited extent without lowering the security level.

The extent of limitation may be varied depending upon the cases, for example, the case where there are both the mobile phone 404 and the IC tag, the case where there are a substituting device for the mobile phone 404 and the IC tag, the case where there is only the registered tag, and the case where there is an IC tag which is not registered.

In the present embodiment, the signal sent from the IC tag 401 to the terminal 403 includes the ID information of the mobile phone 404 with the encrypted personal ID of the IC tag 401. The terminal 403 reads the signal input from the IC tag 401, and checks whether it has received the ID information of the mobile phone 404 which is intermittently transmitted. When the terminal 403 confirms reception of the ID information which matches the ID information received from the IC tag 401, the terminal 403 decrypts the personal ID of the IC tag 401 using the ID information as a key. Then, the terminal 403 sends the decrypted personal ID of the IC tag 401 to the host computer 407. However, the signal sent from the IC tag 401 to the terminal 403 may not include the ID information of the mobile phone 404. The terminal 403 may receive the ID information of any mobile phone and decrypts it to send to the host computer. If there are a number of mobile phones around the terminal 403, it may take some time for the terminal 403 to obtain the ID information of the mobile phone 404. However, in this way, the ID information of the mobile phone is no longer necessary to be stored in the IC tag 401, so the security level can be enhanced in terms of protecting the ID information of the mobile phone.

In the present embodiment, the personal ID of the IC tag 401 is decrypted using the ID information of the mobile phone as a key, and the decrypted personal ID of the IC tag 401 is sent to the host computer. However, the present invention is not limited to such an example, and the authentication may be permitted by simply having both the ID of the mobile phone and the signal sent from the IC tag. In this way, decrypting means is no longer necessary, and the system can be simplified.

In the present embodiment, the signal sent from the IC tag 401 to the terminal 403 includes the ID information of the mobile phone 404 with the encrypted personal ID of the IC tag 401. The terminal 403 reads the signal input from the IC tag 401, and checks whether it has received the ID information of the mobile phone 404 which is intermittently transmitted. When the terminal 403 confirms reception of the ID information which matches the ID information received from the IC tag 401, the terminal 403 decrypts the personal ID of the IC tag 401 using the ID information as a key. Then, the terminal 403 sends the decrypted personal ID of the IC tag 401 to the host computer 407. However, the signal sent from the IC tag 401 to the terminal 403 may include mail address information or a telephone number of the mobile phone 404. When the terminal 403 receives the signal output from the IC tag, it may send mail to or call the mobile phone 404, and upon a predetermined receiving operation (clicking a predetermined button or the like) on the mobile phone 404, authentication may be permitted. In this way, decrypting means is no longer necessary, and the system can be simplified.

### Fifth Embodiment

Hereinafter, another embodiment of the present invention is described with reference to the drawings. FIGS. 10 and 11 show a structure of an authentication system according to another embodiment of the present invention. FIGS. 10 and 11 illustrate a method for settling at a ticket gate when taking a train or the like. In FIG. 10, reference numeral 501 denotes an IC tag, reference numeral 503 denotes a terminal, and reference numeral 504 denotes a mobile phone. In FIG. 11, reference numeral 807 denotes a host computer. Now, the authentication system in the fifth embodiment is described.

First, a passenger holds the IC tag 501 over the terminal 503 of a ticket gate for passing the ticket gate before riding the train. A form of the IC tag 501 may be a card or the like with an IC tag being embedded. The ticket gate reads a signal 502 with the terminal 503 having a reader function for the IC tag 501.

The signal 502 includes a personal ID of the IC tag 501 which is encrypted, and also ID information of the mobile phone 504. The terminal 503 checks whether it has received the ID information of the mobile phone 504.

In general, mobile phones have a function to switch base stations as they move so that call is not interrupted while they are moving, and intermittently transmit a signal to notify their current positions to the base stations.

In the present embodiment, such a signal is utilized. The signal transmitted by the mobile phone includes at least ID information specific to the mobile phone 504. The receiving sensitivity of the terminal 503 for the ID information of the mobile phone is suppressed to be lower than the receiving sensitivity of the base stations, and the terminal 503 can receive the ID information only from the mobile phones within the range of about a few meters.

If the terminal 503 confirms reception of the ID information which matches the ID information received from the IC tag 501 (505), it opens an entrance gate of the ticket gate after it sends and records an information signal regarding entry to and on the IC tag 501 (509).

Then, for passing a ticket gate after getting off the train, the passenger holds the IC tag 501 over a terminal 803 at the ticket gate. The ticket gate reads a signal 802 with the terminal 803 having a reader function for the IC tag 501. The signal 802 includes a personal ID of the IC tag 501 which is encrypted, ID information of the mobile phone 504, and the information when the passenger ride the train. The terminal 803 checks whether it has received the ID information of the mobile phone 504.

If the terminal 803 confirms reception of the ID information which matches the ID information received from the IC tag 501 (805), it opens an exit gate at the ticket gate after it sends and records an information signal regarding exit to and on the IC tag 501 (809).

Meanwhile, the terminal 803 decrypts the personal ID of the IC tag 501 using the ID information as a key. Then, the terminal 803 sends the decrypted personal ID of the IC tag 501 and information on entry and exit to the host computer 807 (806). The host computer 807 searches whether the personal ID of the IC tag 501 exists in a predetermined database of personal IDs. If it is confirmed to exist, the host computer 807 sends a signal to confirm authentication to the terminal 803 (808), and the fare is billed to a predetermined object to be billed from the terminal 803.

As described above, by the authentication system of the present embodiment, the personal ID is decrypted using two devices, i.e., the IC tag 501 and the mobile phone 504. Thus, security level can be improved.

If the personal ID of the IC tag 501 does not exist in the predetermined database of the personal IDs, a signal is sent to any similar terminal to prohibit entry for the next time. For example, when IC tag and/or ID information of the mobile phone sent from the IC tag 501, or ID information of the mobile phone sent from the mobile phone 504 is detected, entry is not permitted and the entrance gate is not open.

Furthermore, since the mobile phone 504 is used, original functions of mobile phones, such as a function for transmitting signal or the power supply can be utilized, and thus, authentication of an individual can be performed with a simple structure. Further, since the ID information intermittently transmitted from the mobile phone 504 is utilized, there is no need to request the mobile phone 504 to send the ID information from the terminal 503 or 803, and thus, a time period necessary for authentication is reduced.

Usually, if the number of so-called keys is increased in order to improve the level of security, the operations become complicated, and may impair convenience of the customer. However, in the present embodiment, the ID information which is intermittently transmitted from the mobile phone 504 is used so the authentication can be performed without impairing convenience of the passenger.

In the present embodiment, the IC tag 501 is formed into a card. However, it may be in any form such as a key ring, a bracelet, a watch with the IC tag being embedded, or the like.

Since the IC tag cannot complete the authentication by itself, a plurality of IC tags may be provided in view of the case of losing or failing to bring the IC tag.

In the present embodiment, a signal of the mobile phone for notifying base stations of its position is used. However, any signal other than the signal for notifying base stations of the position can be used as long as it is intermittently transmitted at a frequency of once in about a few seconds or more. By employing another signal, a weak signal which reaches to a range of about a few meters can be used so the power consumption of the mobile phone can be reduced by that amount.

In the present embodiment, the terminal 803 decrypts the personal ID of the IC tag 501 using the ID information received from the mobile phone 504 as a key. However, as long as the host computer 807 already knows or can recognize, a signal obtained by arbitrarily calculating the signals 505 and 805 received from the mobile phone 504 and the signal 502 and 802 received from the IC tag 501 may be sent to the host computer 807. Sending and receiving between the host computer 807 and the terminal 803 may be in any form such as wired, wireless, one-way communication, bidirectional communication, or the like.

In the present embodiment, the decrypted personal ID of the IC tag 501 is sent to the host computer 807. However, the signal may be sent as it remains encrypted, and may be decrypted at the host computer 807.

The signal input from the IC tag 501 to the terminal 503 may include address information of the host computer 807. Since the address information is included, the signal 506 can be sent to the host computer 807 even when the terminal 503 does not have address information of the host computer 807.

Even if the address information is not included, if the personal ID is a personal ID which is authenticated by an authentication organization which is designated by the terminal 503 and has known address information, it can be used. However, by including the address information, the personal ID authenticated by another authentication organization can be used.

In this way, the number of the personal IDs can be prevented from increasing, and the customers do not have to increase the personal IDs. Thus, management of the personal IDs becomes easy.

The signal input from the mobile phone 504 to the terminal 503 may also include the address information of the host computer 507. Since the address information is included, the signal 806 can be sent to the host computer 507 even when the terminal 503 does not have address information of the host computer 507.

Even if the address information is not included, if the personal ID is a personal ID which is authenticated by an authentication organization which is designated by the terminal 503 and has known address information, it can be used. However, by including the address information, the personal ID authenticated by another authentication organization can be used. In this way, the number of the personal IDs can be prevented from increasing, and the customers do not have to increase the personal IDs. Thus, management of the personal IDs becomes easy.

The signal input from the terminal 503 to the host computer 807 may include the address information of the terminal 503. Since the address information is included, a sending process to the host computer 807 and a receiving process from the host computer 807 can be separated. This allows selecting communication means other than bidirectional communication, and the range of choices for the communication means can be expanded.

In the present embodiment, the terminal 503 having a reader function reads the signal 502. However, the signal 502 may be sent to the terminal 503 by an operation of the customer. If the signal 502 is sent upon the customer's operation, it is no longer necessary to send the personal ID when the signal 502 does not have to be sent. Thus, the security level of the personal information can be further enhanced than that in the case where the personal IDs are always transmitted.

The terminal 503 may receive only a signal from the IC tag 501 within a range of about a few meters. In this way, crossed line with signals sent from other IC tags can be prevented.

In the present embodiment, the terminal 503 having a reader function reads the signal 502. However, transmission of the personal ID from the IC tag 501 may be performed at a timing different from that of transmitting the ID information of the mobile phone 504 from the IC tag 501. By sending the personal ID of the IC tag 501 only under a predetermined condition, the security level of the personal information can be further enhanced than that in the case where the personal IDs are always transmitted.

An example of transmitting the personal ID of the IC tag 501 at the different timing is as follows. First, the IC tag 501 transmits only the ID information of the mobile phone 504, and the terminal 503 confirms the ID information transmitted from the mobile phone 504. Then, upon a request from the terminal 503, the IC tag 501 may transmit the personal ID of the IC tag 501. In this way, the personal ID of the IC tag is not transmitted any longer when a mobile phone which does not transmit correct ID information due to misuse is being used. Thus, the security level of the personal information can be further enhanced.

As another example, the IC tag 501 receives the ID information of the mobile phone 504 first, and is triggered by it to transmit the personal ID of the IC tag 501. Transmission of the ID information of the mobile phone 504 from the IC tag 501 may be before or after reception of the ID information of the mobile phone 504, or at the same timing. This allows omitting receiving means of the terminal 503 which is for receiving from the mobile phone 504.

The transmission of the personal ID from the IC tag 501 may be performed intermittently for a predetermined period of time once transmission is performed. In this way, it is ensured that the personal ID can be sent to the terminal 503.

In the present embodiment, the mobile phone 504 intermittently transmits the ID information. However, transmission may be performed upon an operation of the customer in the case of emergency, in the case where timing has to be adjusted with respect to the receiving side, or the like. Similarly, when the communication between the IC tag 501, the terminal 503, and the mobile phone 504 has to be performed at a predetermined timing, transmission of the ID information from the mobile phone 504 may be triggered by the IC tag 501 or the terminal 503.

Further, transmission of predetermined information stored in the IC tag 501 such as the personal ID, the ID information of the mobile phone 504 and the like may be stopped by sending a predetermined signal to the IC tag 501. This reduces a risk of misuse in the case of loss.

Moreover, predetermined information stored in the IC tag 501 such as the personal ID, the ID information of the mobile phone 504 and the like may be erased by sending a predetermined signal to the IC tag 501. This reduces a risk of misuse in the case of loss.

Furthermore, predetermined information stored in the IC tag 501 such as the personal ID, the ID information of the mobile phone 504 and the like may be transferred to a predetermined device by sending a predetermined signal to the IC tag 501. This reduces a risk of misuse in the case of loss, and also allows reuse of the information which has been stored in the IC tag 501.

Further, transmission of the ID information and the like of the mobile phone 504 may be stopped by sending a predetermined signal to the IC tag 501. This reduces a risk of misuse in the case of loss.

Moreover, predetermined information stored in the mobile phone 504 such as the ID information and the like may be erased by sending a predetermined signal to the IC tag 501. This reduces a risk of misuse in the case of loss.

Furthermore, predetermined information stored in the mobile phone 504 such as the ID information and the like may be transferred to a predetermined device by sending a predetermined signal to the IC tag 501. This reduces a risk of misuse in the case of loss, and also allows reuse of the information which has been stored in the mobile phone 504.

Alternatively, by sending a predetermined signal to the host computer 807, authentication of the terminal 503 may be stopped, or may notify the terminal 503 of a misuse.

Further, in the case of loss or the like, a predetermined code number may be input for transmitting a predetermined signal to the IC tag 501, the terminal 503, or the mobile phone 504, and the signal may be sent only when the code number is correct. This can prevent erroneous suspension of a predetermined function.

In the present embodiment, the signal sent from the IC tag 501 to the terminal 503 includes the ID information of the mobile phone 504 with the encrypted personal ID of the IC tag 501. The terminal 503 reads the signal input from the IC tag 501, and checks whether it has received the ID information of the mobile phone 504 which is intermittently transmitted. When the terminal 503 confirms reception of the ID information which matches the ID information received from the IC tag 501, the terminal 503 decrypts the personal ID of the IC tag 501 using the ID information as a key. Then, the terminal 503 sends the decrypted personal ID of the IC tag 501 to the host computer 807. However, the signal sent to the terminal 503 from the IC tag 501 may be sent to the mobile phone 504, and the decrypted personal ID may be sent from the mobile phone 504 to the host computer 807.

Thus, the personal information of the IC tag 501 is no longer necessary to be sent to the terminal 503. The personal information of the IC tag 501 is just sent to the host computer 807. Thus, compared to the case where the personal ID is transmitted to each terminal every time a certificate is issued, the security level of the personal information can be further enhanced.

In the present embodiment, authentication is permitted when there are both the mobile phone 504 and the IC tag 501 (see FIG. 12A). However, authentication with either device may be permitted within a limited extent upon previous registration with both the mobile phone 504 and the IC tag 501. Such an example will be described with reference to FIGS. 12B through 12D. Herein, the limited extent refers to the amount of money which can be authenticated, the number of times allowed to authenticate, the time zone in which authentication is permitted (for example, between 9 AM to 10 AM), the time period permitted to authenticate (for example, one day), the time limit for authentication (for example, until August 5), the area in which authentication is permitted, and the like.

With such a feature, even when, for example, the user notices that he/she has forgotten the mobile phone 504 at the time he/she tries to be authenticated, or the power of the mobile phone 504 is insufficient or the mobile phone 504 has a failure, or authentication is to be performed in a place where the mobile phone 504 has to be turned off, the authentication can be performed with only the IC tag 501 if the information is registered such that the authentication is permitted for just once with the upper limit of the amount of money being determined.

The registration may be performed by, for example, sending the ID information of the mobile phone 504, or information obtained by arbitrarily calculating the ID information and the limitation information for limiting the range of use from the mobile phone 504 to the IC tag 501 directly or indirectly via the terminal 503 (see FIG. 12B or 12C). The terminal 503 receives the information, and performs authentication without receiving the ID information from the mobile phone 504 (see FIG. 12D).

Updating of the limitation information shown in FIG. 12D means that, for example, in the case where the number of times to permit withdrawal is “once”, if withdrawal is performed using only the IC tag 101, the limitation information is updated, and the number of times of withdrawal is updated to “zero”.

In the case where the power supply of the mobile phone 504 is insufficient, the IC tag 501 may be notified by a sound or vibration.

Similarly, if previously registered, the limited authentication using only the mobile phone 504 may be permitted in the case of a failure of the IC tag 501.

Functions of the mobile phone 504 may be transferred to an IC tag different from the IC tag 501 or a mobile phone within a limited extent if it is previously registered with both the mobile phone 504 and the IC tag 501. Herein, the limited extent refers to the amount of money which can be authenticated, the number of times allowed to authenticate, the time zone in which authentication is permitted (for example, between 9 AM to 10 AM), the time period permitted to authenticate (for example, for one day or until August 5), the area in which authentication is permitted, and the like. In this way, even in the case where the mobile phone 504 cannot be used, another IC tag or mobile phone can carry out the functions for it within the limited extent so that authentication can be performed within the limited extent without lowering the security level.

The extent of limitation may be varied depending upon the cases, for example, the case where there are both the mobile phone 504 and the IC tag, the case where there are a substituting device for the mobile phone 504 and the IC tag, the case where there is only the registered tag, and the case where there is an IC tag which is not registered.

### Variations of the First Through Fifth Embodiments

<1>

In the above embodiments and variations thereof, the mobile phone may poll the IC tag.

If there is no response from the IC tag for a certain period of time as a result of such polling, the mobile phone may send ID information stored in the mobile phone, storage information such as address list information, or positional information of the mobile phone to a predetermined device.

The state that the IC tag and the mobile phone cannot communicate each other for a certain period of time may possibly mean that the mobile phone is lost. When the mobile phone transmits information in such a state, the address list and the like stored in the mobile phone are sent and transferred to a predetermined device so that they can be reused. Alternatively, the positional information of the mobile phone is obtained so that the mobile phone can be found.

Further, if there is no response from the IC tag for a certain period of time as a result of polling, the mobile phone may erase specific information such as the address list information and the like stored in the mobile phone.

In this way, even when the mobile phone is lost, misuse of the information stored in the mobile phone can be prevented.

Moreover, if there is no response from the IC tag for a certain period of time as a result of polling, the mobile phone may be switched to a setting in which manipulations on the mobile phone are invalidated.

In this way, even when the mobile phone is lost, misuse of the mobile phone itself can be prevented.

These operations may be performed in accordance with not the response from the IC tag, but power supply level of the mobile phone.

For example, if the power supply level of the mobile phone is lower than a predetermined value, the mobile phone may send ID information stored in the mobile phone, storage information such as address list information, or positional information of the mobile phone to a predetermined device.

When the mobile phone transmits information in a state that the power supply level of the mobile phone is lower than a predetermined value, the address list and the like stored in the mobile phone are sent and transferred to a predetermined device so that they can be reused. Alternatively, in the case where the mobile phone cannot be charged because it is lost, the positional information of the mobile phone is obtained so that the mobile phone can be found.

When the power supply level of the mobile phone is lower than a predetermined value, the mobile phone may erase specific information such as the address list information stored in the mobile phone.

In this way, even when the power supply level of the mobile phone is reduced because it is lost, misuse of the information stored in the mobile phone can be prevented.

Moreover, when the power supply level of the mobile phone is lower than a predetermined value, the mobile phone may be switched to a setting in which manipulations on the mobile phone are invalidated.

In this way, even when the power supply level of the mobile phone is reduced because it is lost, misuse of the mobile phone itself can be prevented.

<2>

In the above embodiments and variations thereof, encryption and decryption of the personal ID of the IC tag may be performed using the ID information of the mobile phone as an encryption key and a decryption key.

<3>

The IC tag and the mobile phone used in the above embodiments and variations thereof may transmit their ID information only within a predetermined area. Herein, the predetermined area refers to, for example, premises of a building or a station, a predetermined site and the like.

In the predetermined area, a transmitter included in or connected to the terminal is provided. The transmitter polls the IC tag and the mobile phone. The terminal receives a response to polling from the IC tag and the mobile phone. Further, the terminal performs a process as described in the above embodiments and variations thereof to perform authentication.

In such a state, the IC tag and the mobile phone transmit their ID information only when they receive a radio wave from the transmitter provided in the predetermined area. Thus, the ID information is transmitted from the IC tag and/or the mobile phone only in the predetermined area. Therefore, the security level can be further improved.

<4>

In the above embodiments and variations thereof, the ID information of either the IC tag or the mobile phone may be registered to a predetermined registration device when entering a predetermined area. In the predetermined area, the registered ID information and the other ID information may be used for authentication.

For example, in the area where the mobile phone has to be turned off such as a hospital, authentication using the mobile phone as described in the above embodiments may be inappropriate sometime.

Therefore, when entering the predetermined area, the ID information of the mobile phone is registered to the terminal at the entrance. In the predetermined area, the authentication is performed using the personal ID of the IC tag and the ID information registered to the terminal.

Registration of ID information to the terminal by the mobile phone is performed at, for example, a remote terminal which is provided outside the predetermined area or both outside and inside of the area near the border and which is connected to the terminal via a wired or wireless network. The remote terminal receives a signal of the mobile phone notifying the base stations of its position, and obtains the ID information included in the signal. Further, the remote terminal sends the obtained ID information to the terminal via the network. The terminal registers (stores) the received ID information. In the predetermined area, the terminal obtains the personal ID from the IC tag. The terminal performs authentication using the obtained personal ID and the registered ID information.

As described, in the predetermined area, the terminal merely obtains the personal ID from the IC tag. Thus, even in the area in which the mobile phone has to be turned off (for example, a hospital, a theater, a station and the like), the authentication with improved security level can be performed.

In the above description, the remote terminal registers the ID information obtained from the mobile phone to the terminal. However, the ID information may be registered to a server connected to the terminal. When the terminal obtains the personal ID from the IC tag, it further obtains the corresponding ID information from the server to perform authentication.

In the above description, the mobile phone is used for entering the predetermined area and the IC tag is used in the predetermined area. However, the present invention is not limited to such an example. The IC tag may be used for entering the predetermined area, and the mobile phone may be used in the predetermined area, for example.

<5>

In the above embodiments and variations thereof, the ID information of the IC tag and the mobile phone are used for authentication for entering the predetermined area, and once the user entered the predetermined area, either one of the ID information of the IC tag and the mobile phone may be used for authentication in the predetermined area.

For entering the predetermined area, as described in the above embodiments, the terminal performs authentication by using the ID information of the IC tag and the mobile phone. Further, the terminal stores in a database or the like that the authentication is performed at the entrance and the object to be authenticated is in an authenticated status. In the predetermined area, when the terminal obtains ID information of either the IC tag or the mobile phone, the authenticated status of the object to be authenticated for that ID information is searched for in the database. If it is determined that the object to be authenticated is in the authenticated status as a result of searching the database, the authentication within the predetermined area is completed.

In this way, the convenience can be improved with the safety of the authentication in the predetermined area being maintained. In other words, once authentication is performed when the user enters the area (for example, a hospital, a theater, a station and the like), the sufficient security level is maintained even when the security level in the following authentication processes is reduced. Furthermore, since authentication is performed by a simple method in the area, convenience can be improved.

### Sixth Embodiment

### Separated ID Electronic Money

Hereinafter, the sixth embodiment of the present invention will be described in details with reference to the drawings.

The present embodiment is a card type electronic money system is characterized by an IC card on which electronic money information is recorded, a mobile terminal device for validating use of the electronic money information, and a settlement or charging process performed with IC card information and communication with a mobile terminal. FIG. 13 shows the detailed structure thereof.

The card type electronic money system is formed of an IC card 1100, a mobile terminal 1101, and a reader/writer 1102.

The IC card 1100 includes: an IC card antenna for obtaining a signal by a radio wave from the reader/writer 1102; an IC card communication section which controls information communication with the reader/writer; a memory formed of ROM to which an operation program is previously stored and an EEPROM to which rewritable information such as electronic money information or the like is stored; a card ID information storage section which is inherent to each card (unique to a card user); and a CPU which controls main components of the card.

The mobile terminal 1101 is formed of: an antenna used for sending and receiving information to and from the reader/writer; a mobile terminal communication section which controls information communication with the reader/writer; a mobile ID storage section to which mobile ID inherent to the mobile terminal is previously stored; a display device formed of a liquid crystal display or the like; a telephone communication section which controls usual telephone call or communication such as universal-use internet or the like; keys for inputting numerical or text information; and a CPU which controls main components of the mobile terminal.

The reader/writer 1102 is formed of: an IC card antenna used for communication with the IC card 1100; an IC card communication section for controlling information communication with the IC card; an antenna used for communicating with the mobile terminal; a mobile terminal communication section for controlling information communication with the mobile terminal; a card information encrypting and decrypting section for decrypting the electronic money information received from the IC card and encrypting electronic money information to be recorded on the IC card by using the mobile ID information obtained from the mobile terminal as a key; a card information updating section for updating the electronic money information by a settlement process and/or a charging process; and an input section for inputting information for a settlement process and/or a charging process.

For communication using the IC card antenna, for example, a communication form which operates with power and a clock supplied from the reader/writer 1102 by communication using electromagnetic induction, has a carrier wave of 13.56 MHz, and utilizes Manchester as an encoding method is used.

Next, operations of the card type electronic money system will be described.

First, a communication form between the IC card 1100 and the reader/writer 1102 is described.

The communication form of the IC card 1100 and the reader/writer 1102 can be roughly separated into: (1) a card capture and key exchange process by the reader/writer; (2) a mutual authentication process between the reader/writer and the IC card; and (3) data communication.

FIG. 14 is a flow diagram illustrating a flow of a capture and key exchange process between the reader/writer and the IC card.

The reader/writer calls (polls) unspecified IC cards to check whether an IC card with which it can communicate is in a communicable range. In such a state, if the user intentionally holds his/her IC card near the IC card antenna of the reader/writer, and the IC card is polled, it sends a polling response to the reader/writer by sending its production ID (card ID) IDc to the reader/writer.

When the reader/writer receives the polling response, it sends an electronic money information access application to the IC card, having the production ID received from the IC card as an identifier.

When the IC card receives the electronic money information access application, it generates a key Kc by performing data conversion of the electronic money information access application by using, for example, a one-way function. The reader/writer also generates a key Kc by using the same one-way function as the IC card for the electronic money information access application which it sent to the IC card. In this way, a common key Kc can be generated by the reader/writer and the IC card without outputting the key information as it is to the communication path.

FIG. 15 is a flow diagram showing a mutual authentication process for the reader/writer and the IC card to authenticate each other whether they are valid devices.

First, a random number generator, which is not shown, of the IC card communication section of the reader/writer 1102 generates a random number. The random number generated by the random number generator is stored in a temporal storage section as a sequence ID, and is also encrypted with the key Kc generated by the above key exchange process at the IC card communication section to be sent to the IC card.

When the IC card receives the encrypted random number, it decrypts the random number with the key Kc generated by the above key exchange process. The decrypted result is temporally stored as a sequence ID, and is also encrypted again by using the key Kc and sent to the reader/writer.

When the reader/writer receives the encrypted random number, it decrypts the random number using the key Kc, and checks whether it matches random number Rn1 generated by itself (1305). If they do not match, the process is suspended as a mutual authentication error.

If it is confirmed to match the random number Rn1, the random number Rn2 is generated at the IC card communication section of the IC card 1100, and is temporally stored as a communication key Kt 1304. The random number Rn2 is also encrypted with the key Kc, and is sent to the reader/writer.

When the reader/writer receives the encrypted random number Rn2, it decrypts the random number with the key Kc, and temporally stores as a communication key. Also, the reader/writer encrypts the random number again with the key Kc and sends it to the IC card.

When the IC card receives the encrypted random number Rn2, it decrypts the random number with the key Kc and compares the decrypted result with the random number Rn2 generated by itself. If they do not match, the process is suspended as a mutual authentication error.

In such a way, if both devices are valid devices, common (same) sequence IDs 1301 and 1302, and communication keys 1303 and 1304 can be obtained.

When mutual authentication is completed, that is, when the reader/writer and the IC card complete authentication to check whether the other device is a valid device or not, data communication safe against frauds such as manipulation, eavesdropping and the like can be performed by performing communication using sequence IDs and communication keys they generated in common (and commands encrypted by them).

As shown in FIG. 16, in the card type electronic money system of the present embodiment, the reader/writer outputs a request for reading out the encrypted electronic money information stored in the EEPROM of the IC card after the reader/writer and the IC card are authenticated (1401).

When the IC card receives the reading out request, it reads out the electronic money information stored in its EEPROM and sends it to the reader/writer (1402).

When the reader/writer receives the encrypted electronic money information from the IC card, it searches for accessible mobile terminals with its antenna and mobile terminal communication section to obtain the key information for decrypting the encrypted electronic money information. The reader/writer sends a request for sending the mobile ID to the accessible mobile terminal (1404).

When the mobile terminal receives the mobile ID sending request from the mobile terminal communication section of the reader/writer, it sends the mobile terminal ID stored therein to the reader/writer.

When the reader/writer receives the mobile terminal ID, it tries to decipher the encrypted electronic money information received from the IC card using the mobile terminal ID as a key.

If decipherment succeeds, it is determined that use of electronic money stored on the IC card is permitted. The electronic money information is updated based on the charging process or the settlement process (1408), and is sent to the IC card. The electronic money information in the IC card is updated.

In this way, the settlement process and the charging process of the card type electronic money system of the present embodiment is completed.

The reader/writer of the present embodiment sends the mobile ID request (1404) to all the accessible mobile terminals and obtains the mobile terminal IDs of all the accessible mobile terminals.

However, only one of the mobile terminal IDs can be used for deciphering the encrypted electronic money information recorded on the IC card. By trying the decrypting process with all the received mobile terminal IDs, the encrypted electronic money information can be decrypted.

If the encrypted electronic money information cannot be decrypted with any of the received mobile terminal IDs, however, the process is suspended as not having an access right to the IC card. Thus, if no corresponding mobile terminal is in the limited area in which the IC card is used, access to the IC card cannot be established.

This is just like account access means utilizing a passbook and a registered seal, which can be used only when there are two types of information only the user has. Thus, the card type electronic money system according to the present embodiment has a sufficient reliability and safety in terms of dealing money information.

However, from the user's point of view, the action of actually setting a seal is replaced with an automatic process of reading out the portable mobile terminal ID. So, even when the reliability and the safety are sufficient the sense of safety of the user may be improved by adding, for example, means for notifying the user that decryption of the encrypted electronic money (1407) succeeds, which means that access to the electronic money is permitted and the settlement process or the charging process is performed, by sending the mail address information at the time same as sending the mobile ID (1406).

Further, by adding means for confirming update with the user by using the keys of the reader/writer or the mobile terminal (e.g., pressing one button) at some point after the mobile ID is received and the encrypted electronic money is decrypted (1407) and before the electronic money information is updated (1408) in order to suspend the process until the confirmation is detected, the sense of safety of the user is further improved, and the higher reliability can be ensured.

### Seventh Embodiment

### Crediting Utilizing a Settlement Server

Hereinafter, the seventh embodiment of the present invention will be described in details with reference to the drawings.

The seventh embodiment of the present invention is a credit settlement system formed of: an IC card on which crediting information is recorded; a mobile terminal which stores mobile ID for permitting use of the crediting information; a reader/writer for reading out the crediting information and also reading out the mobile ID to validate use of the crediting information; and a credit settlement server for receiving the crediting information from the reader/writer and specifying the card information of the user to perform credit settlement. FIG. 17 is a schematic diagram of the credit settlement system.

The credit settlement system is formed of an IC card 1500 which stores the crediting information, a mobile terminal 1501 which stores the mobile ID for validating use of the crediting information, a reader/writer 1502 for reading out the crediting information from the IC card 1500 and also reading out the mobile ID from the mobile terminal 1501 to send the extracted crediting information to the credit settlement sever, and a credit settlement server 1503 for settling based on a database which stores the crediting information from the reader/writer 1502 and a card information list.

The IC card 1500 of the present embodiment is different from the IC card 1100 of the sixth embodiment on the point that the stored information is not electronic money information but the crediting information. The crediting information is the same as crediting information for specifying a person recorded on a credit card in a system using a current magnetic or IC card. The IC card of the present embodiment has a similar structure and functions as the IC card of the sixth embodiment besides the above mentioned difference. Thus, detailed description thereof is omitted.

The mobile terminal 1501 of the present embodiment is a device for sending a mobile ID, which it has, to the reader/writer upon a request from the reader/writer 1502. The mobile terminal 1501 has a similar structure and functions as the mobile terminal 1101 of the sixth embodiment, and thus, detailed description thereof is omitted.

The reader/writer of the present embodiment is formed of: an IC card antenna for receiving encrypted crediting information stored in the memory of the IC card 1500; an IC card communication section for controlling communication with the IC card; an antenna for receiving the mobile ID stored in the mobile terminal 1501; a mobile terminal communication section for controlling communication with the mobile terminal 1501; a card information decrypting section for decrypting the encrypted crediting information from the IC card 1500 with the mobile ID read out from the mobile terminal 1501; a reader/writer ID storage section for storing the reader/writer ID; an input section formed of keys, a barcode reader, an infrared data communication device, or an RFID reader which is for inputting billed amount information; and a credit settlement server communication section for communicating with the crediting server by having a dedicated line or universal-use internet as a communication media.

The IC card communication section of the reader/writer is a block having similar functions as the IC card communication section in the sixth embodiment. By performing (1) IC card capture and key exchange process, (2) mutual authentication process with the IC card, and (3) secure data communication with the IC card, the encrypted crediting information stored in the IC card 1500 is obtained and output to the card information decrypting section.

The mobile terminal communication section of the reader/writer is a block for outputting the mobile ID sending request to all the communicable mobile terminals after mutual authentication by the IC card communication section is finished normally, receiving the mobile ID, and outputting the received mobile ID to the card information decrypting section. The mobile terminal communication section is a block having similar functions as the mobile terminal communication section in the reader/writer of the sixth embodiment.

The card information decrypting section of the reader/writer is a section for deciphering the encrypted crediting information received from the IC card 1500 with the mobile ID received from the mobile terminal 1501 and extracting the crediting information of the user. The card information decrypting section is formed using a DEC decrypter, or an AES decrypter having the mobile ID as a secret key.

The input section of the reader/writer is means for inputting the billed amount information for the user, which is formed of numeric keys, a barcode reader, infrared input device or RFID reading device and outputs the input billed amount information to the credit settlement server communication means.

The reader/writer ID storage section of the reader/writer is a section for previously storing inherent identification information which is unique to each reader/writer. The reader/writer ID storage section is used for the key exchange process and the mutual authentication process with the credit settlement server 1503 by the credit settlement server communication device, and the read out reader/writer ID is output to the credit settlement server communication section.

The credit settlement server 1503 in the credit settlement system according to the present embodiment is connected to the reader/writer 1502 via a dedicated line or a universe-use network 1504.

The credit settlement server communication section of the credit settlement server establishes secure data communication through the key exchange process and mutual authentication process and by encrypting a key which changes over time in response to the communication application to the credit settlement server from the reader/writer having its reader/writer ID as an identifier. The credit settlement server communication section obtains the billed amount information and crediting information of the user from the reader/writer 1502 and outputs them to the crediting information confirmation section.

The crediting information confirmation section of the credit settlement server uses the database having the crediting information of the user as a list to determine whether the crediting information is permitted to be used, and also obtains the bank account number of the user to output it to the settlement section.

The database is a database for managing a list of user identification information such as the name or address of the user, account numbers used for settlement, and the like for the user who previously applies to obtain the IC card.

The settlement section of the credit settlement server applies the financial institution of the user for withdrawal of the charged amount from the account number based on the account number of the user from the crediting information confirmation section and the billed amount information from the credit settlement server communication means to complete the settlement. The settlement section notifies the reader/writer that the settlement process is completed by using the credit settlement server communication means.

The credit settlement system of the present embodiment is characterized in that the crediting information encrypted using the mobile ID of the mobile terminal device of the user is previously stored in the IC card.

This means that the crediting information recorded on the IC card cannot be decrypted and used unless there is the mobile ID. On the other hand, complexity of signing or inputting of a password by the user, which has been required conventionally for using the crediting information, can be eliminated.

Further, since two types of information which only the user has, i.e., the mobile ID of the mobile terminal and the crediting information of the IC card, are used for confirming the settlement, security having the level same as or higher than that of a combination of a conventional credit card and signing or input of a password can be secured.

Although it is not described in details in the present embodiment, the secure communication by encrypting a key which changes over time by key exchange, mutual authentication and the like is also desirable when the reader/writer reads out the mobile ID from the mobile terminal.

Further, as described in the sixth embodiment, the sense of safety of the user can be further obtained by adding means for confirming completion of settlement which allows the user to confirm by pressing one button of the mobile terminal before the credit settlement is completed.

### Eighth Embodiment

### Air Charging

Hereinafter, the eighth embodiment of the present invention will be described in details with reference to the drawings.

The present embodiment provides an IC card type electronic money system which can perform electronic money charging of the IC card type electronic money at any time, in any place. FIG. 18 shows a detailed structure thereof.

The IC card type electronic money system of the present embodiment is formed of: an IC card which stores electronic money information and user account specifying information; a mobile terminal 1601 which reads out the electronic money information and user account specifying information from the IC card 1600 and also has keys and the like for receiving instructions from the user; and a bank server 1603 which is connected to the mobile terminal 1601 via a dedicated line or a universal-use network 1603.

The IC card 1600 of the present embodiment has a similar structure and functions as the IC cards described in the sixth and seventh embodiments. However, the IC card of the present embodiment is different from the IC cards described in the sixth and seventh embodiments on the point that it stores the encrypted electronic money information and encrypted user account information.

The mobile terminal 1601 of the present embodiment is formed of: an IC card antenna for receiving information from the IC card; an IC card communication section for controlling secure communication with the IC card, a display section formed of a liquid crystal display or the like; a telephone communication section for establishing a line with other mobile terminals to send and receive audio information and the like; keys formed of numeric keys and the like; a CPU for controlling operations of main blocks; a mobile ID storage section for storing the mobile ID unique to each mobile terminal; a card information encrypting and decrypting section for decrypting or encrypting the encrypted electronic money information and the user account information read out from the IC card by using the mobile ID received from the mobile terminal as a key; a card information update section for updating the electronic money information in accordance with the billed amount information and the electronic money information inputted from the keys; and a bank server communication section for communicating the user account information to the bank server.

The IC card antenna of the mobile terminal 1601 is a block for supplying power and clock to the IC card when the IC card enters the communicable range, and receiving the encrypted electronic money information and the encrypted user account information from the IC card in which they are stored. The IC card antenna has a similar structure and functions as the IC card antennas in the reader/writers in the sixth and seventh embodiments.

The IC card communication section of the mobile terminal is a block which performs capture of the IC card, key exchange, and mutual authentication for establishing secure communication with the IC card. The IC card communication section has similar functions as the IC card communication section in the reader/writers described in the sixth and seventh embodiments.

The display section of the mobile terminal 1601 is a so-called display device. Usually, it is formed of a liquid crystal display or the like.

The key of the mobile terminal 1601 represents so-called numeric keypad. They are input means for inputting numeric information, text information, and the like.

The telephone communication section of the mobile terminal 1601 is a so-called mobile phone device which establishes a line based on a telephone number or the like input from the keys to exchange audio information and the like.

The CPU of the mobile terminal 1601 receives a mobile ID request from the card information encrypting and decrypting section, reads out the mobile ID unique to each mobile terminal stored therein to output to the card information encrypting and decrypting section.

The card information encrypting and decrypting section of the mobile terminal 1601 is a block which decrypts the encrypted electronic money information and the encrypted user account information received from the IC card by using the mobile ID stored therein. In this way, the card information encrypting and decrypting section extracts the electronic money information and user account information and outputs them to the card information update section, and/or encrypts the electronic money information updated by the card information update section by using the mobile ID information stored therein as a key. The card information encrypting and decrypting section is formed of a DES encrypting and decrypting or AES encrypting and decrypting block having the mobile ID information as a key. Further, the decrypted user account information is output to the bank server communication section.

The bank server of the mobile terminal 1601 is a communication section which performs communication with a bank server using a dedicated line or a universal-use network. It performs key exchange, mutual authentication or encrypted data communication with the bank server to have secure communication with the bank server, and sends the account information decrypted by the card information decrypting section and the additional amount information input from the keys to the bank server.

The bank server 1602 of the present embodiment is formed of: a bank server communication section for communicating with the mobile terminal 1601; a user information update section for specifying the account of the user based on the user account information from the mobile terminal 1601 and the account information previously registered for each user in a form of a list, subtracting the amount information indicated by the received additional money information from the remaining balance, and outputting permission for additional money to the bank server communication section; and a database for previously managing and recording account information for each user as a list for each user.

The bank server communication section of the bank server 1602 establishes a secure communication path with the mobile terminal 1601 to receive the user account information and additional money information and output to the user information update section.

The user information update section of the bank server 1602 specifies the account information of the user based on the user account information from the bank server communication section, and the database which previously manages the account information (name, account number, the information on the amount of money permitted to use, loan information and the like) for each user, and subtracts the amount of money indicated by the additional money information from the information on the amount of money permitted to use of the user to generate addable money information. The addable money information is output to the mobile terminal 1601 via the bank server communication section.

When the mobile terminal 1601 receives the addable money information, it updates the electronic money information by adding the addable money information from the bank server 1602, and sends it to the card information encrypting and decrypting section.

The card information encrypting and decrypting section encrypts the electronic money information updated by adding at the card information update section, by having the mobile ID information stored in the mobile terminal 1601 as a key. The encrypted information is sent securely to the IC card 1600 via the IC card communication section.

When the IC card 1600 receives the updated and encrypted electronic money information, it records the received encrypted electronic money information in the memory therein to complete the charging process.

In this way, the amount of money indicated by the additional money information which is input by the user using the mobile terminal is transferred from the bank account to the IC card.

Such an operation is enabled since the mobile phone according to the present embodiment includes the communication means with the IC card, electronic money updating means, and bank server communication means as its components.

According to the present embodiment, use of the charge type IC card electronic money allows charging to the IC card, which has conventionally been able at only an IC card reader/writer for charging, to be performed in any place with the mobile terminal device.

Further, since the electronic money information and user account information which are recorded on the IC card cannot be used unless the mobile ID of the mobile terminal which the user uses is confirmed, a security of the level same as or higher than that of the combination of a passbook and a registered seal can be achieved.

### Ninth Embodiment

### Information Recording Apparatus

In the above sixth through eighth embodiments, the present invention is applied to the electronic money system using the authentication system or the crediting system. However, the present invention is not limited to such applications.

By utilizing the authentication system in an information recording apparatus, information recording which allows only the user to browse can be realized. This is achieved by, for example, recording information which can be used by only the user on information recording media such as DVD recorders and the like. An encryption key for previously recording information on the IC card is further encrypted with an identifier of the mobile device and is recorded.

The information recording apparatus reads out the content encryption key which has been encrypted by holding the IC card information of the user before recording the information.

At the same time as or after reading out the encrypted content encryption key, the identifier is read out from the mobile device.

The information recording apparatus decrypts the encrypted content encryption key by using the identifier of the mobile device to extract the content encryption key. The information recording apparatus encrypts the contents with the content encryption key and records on the information recording medium.

For reproducing the content, the content encryption key is extracted similarly. The content recorded on the information recording medium is decrypted with the content encryption key and reproduced.

According to the above-described structure, two types of information which only the user is permitted to have, i.e., the information recorded on the IC card, and the information in the mobile terminal, are used for extracting the content encryption key. The key information is used for encryption/recording, and decryption/reproduction of the content. Thus, the information recording apparatus and the information reproducing apparatus, which do not allow browsing by a third party who does not have the IC card and the corresponding mobile terminal, can be provided.

(Structure)

A form of such an information recording apparatus will be described specifically with reference to FIG. 19.

FIG. 19 is a block diagram showing a structure of an information recording apparatus 123 such as DVD player/recorders, or the like. The information recording apparatus 123 shown in FIG. 19 is an apparatus which generates authentication information for authenticating a user based on two types of information which a user of the apparatus has, and uses the generated authentication information to reproduce information recorded on a recording medium 136 or records information on the recording medium 136. The recording medium 136 may be, for example, a hard disc, CD, DVD, or other type of media. Reproduction of information refers to not only reproducing video and audio recorded on the recording medium 136 on a monitor or a speaker, but also a wide range of use such as transferring or copying the recorded information, and the like.

The information recording apparatus 123 is formed of a recording and reproducing section 133, an encrypting and decrypting section 134, a storage section 135, an authentication information generating section 132, an input/output section 137, and a communication section 131.

The recording and reproducing section 133 records the content encrypted at the encrypting and decrypting section 134 on the recording medium 136, or reproduces the content recorded on the recording medium 136 and outputs to the encrypting and decrypting section 134. The recording and reproducing section 133 may be formed of, for example, an optical pickup, an optical pickup driving device, or the like.

The communication section 131 obtains first ID information and second ID information respectively from the mobile phone 122 and the IC card 121, which are provided outside the information recording apparatus 123. Since the detailed structures of the mobile phone 122 and the IC card 121 are the same as those shown in FIG. 13, descriptions thereof are omitted.

The authentication information generating section 132 generates the authentication information based on the first ID information and the second ID information obtained via the communication section 131.

The storage section 135 stores content ID used for encrypting the content.

The encrypting and decrypting section 134 encrypts the content obtained via the input/output section 137 with the content ID, or decrypts the encrypted content obtained from the recording and reproducing section 133 with the content ID. Further, the encrypting and decrypting section 134 encrypts the content ID with the authentication information, or decrypts the encrypted content ID with the authentication information.

The input/output section 137 is connected to an external device, and inputs/outputs the content. Specifically, the input/output section 137 obtains the content from a content receiving device 142 connected outside (or included in) the information recording apparatus 123. Herein, the content receiving device 142 may be, for example, a tuner device which receives broadcasting and outputs a content signal (for example, video/audio data), or may be a device which obtains a content signal by communication means via a network such as internet and outputs the signal. Further, the input/output section 137 outputs the content signal to a content display device 141 connected outside such as a monitor or the like to have the content signal being displayed.

Now, the relationship between the first ID information, the second information, the authentication information, the content ID, and the content is described.

The first ID information is the ID information of the mobile phone 122 and is information inherent to the mobile phone 122. The second ID information is the information obtained by encrypting the authentication information with the first ID information. The content ID is information inherent to the content. In other words, the authentication information generating section 132 generates authentication information by decrypting the second ID information with the first ID information.

(Authentication Process)

The authentication process in the information recording apparatus 123 is described. In the authentication process in the information recording apparatus 123, two types of information which only the user of the information recording apparatus 123 is permitted to have, i.e., the information recorded on the IC card 121 and the information in the mobile phone 122, are used for extracting the authentication information. If the authentication information is extracted, the user having the IC card 121 and the mobile phone 122 is authenticated as a user of the information recording apparatus 123. In the information recording apparatus 123, this authentication information is used for performing encryption/recording and decryption/reproduction of the content.

Hereinafter, the authentication process is described in more details with reference to flow diagrams.

FIG. 20 is a flow diagram showing an authentication process for recording content.

First, the information recording apparatus 123 receives a content recording request (S171). The content recording request is given manually by the user, or automatically by an included timer or the like. When the information recording apparatus 123 receives the content recording request, the communication section 131 sends an ID information request to the mobile phone 122, which is a first device (S172). When the mobile phone 122 receives the ID information request, the mobile phone 122 sends the ID information request to the IC card 121, which is a second device (S173).

When the IC card 121 receives the ID information request, it sends the second ID information stored in the memory (see FIG. 13) to the mobile phone 122 (S174). When the mobile phone 122 receives the second ID information from the IC card 121, it sends the second ID information, and the first ID information which is stored in the mobile ID storage section (see FIG. 13) to the information recording apparatus 123 (S175).

In the information recording apparatus 123, the communication section 131 receives the first and the second ID information, and the authentication information generating section 132 generates the authentication information (S176). The encrypting and decrypting section 134 uses the content ID stored in the storage section 135 to encrypt the content obtained from the content receiving device 142. Further, the recording and reproducing section 133 records the encrypted content to the recording medium 136 (S177). The encrypting and decrypting section 134 uses the authentication information to encrypt the content ID. Further, the recording and reproducing section 133 records the encrypted content ID to the recording medium 136 (S178).

FIG. 21 is a flow diagram showing an authentication process for reproducing content.

First, the information recording apparatus 123 receives a content reproducing request (S181). The content reproducing request is given manually by the user, or automatically by an included timer or the like. When the information recording apparatus 123 receives the content reproducing request, the communication section 131 sends an ID information request to the mobile phone 122, which is a first device (S182).

When the mobile phone 122 receives the ID information request, the mobile phone 122 sends the ID information request to the IC card 121, which is a second device (S183).

When the IC card 121 receives the ID information request, it sends the second ID information stored in the memory (see FIG. 13) to the mobile phone 122 (S184).

When the mobile phone 122 receives the second ID information from the IC card 121, it sends the second ID information and the first ID information stored in the mobile ID storage section (see FIG. 13) to the information recording apparatus 123 (S185).

In the information recording apparatus 123, the communication section 131 receives the first and the second ID information, and the authentication information generating section 132 generates the authentication information (S186). The encrypting and decrypting section 134 obtains the encrypted content ID which is recorded on the recording medium 136 via the recording and reproducing section 133, and uses the authentication information to decrypt the content ID (S187). If the content ID cannot be decrypted at this step (S188), the process is finished as the authentication is not being allowed. In other words, the reproduction of the content is refused. On the other hand, if the content ID can be decrypted (S188), the authentication is permitted. Further, the encrypting and decrypting section 134 determines whether a reproduction stopping request is received or not (S189). The reproduction stopping request may be given manually by the user, or automatically by an included timer or the like, or by automatic determination on the end of reproduction of the content being reproduced. If the reproduction stopping request is received, the process is finished. On the other hand, if the reproduction stopping request is not received, the encrypting and decrypting section 134 obtains the encrypted content recorded on the recording medium 136 via the recording and reproducing section 133 and uses the content ID to decrypt the content (S190). At this step, if the content cannot be decrypted (S191), the process is finished as the authentication is not being allowed. In other words, the reproduction of the content is refused. On the other hand, if the content ID can be decrypted (S191), the authentication is permitted, and the content is reproduced. Then, the process of steps S189 through S191 is repeated until the reproduction stopping request is received.

(Effects)

With above described features, the information recording apparatus 123 has the following effects.

In the information recording apparatus 123, two types of information which only the user is permitted to have, i.e., the information recorded on the IC card 121 and the information in the mobile phone 122, are used for generating the authentication information. The authentication information is used for encryption/recording, and decryption/reproduction of the content. Thus, a third party who does not have the IC card 121 and the corresponding mobile phone 122 can be prohibited from browsing.

Moreover, the second ID information stored in the IC card 121, and received by the information recording apparatus 123 via the mobile phone 122 is the information obtained by encrypting the authentication information with the first ID information. Thus, the security level can be improved compared to that in the case where the authentication information is sent and received without being encrypted.

(Variations)

<1>

In the above embodiment, the IC card 121 sends and receives information to and from the information recording apparatus 123 via the mobile phone 122. However, the IC card 121 may send and receive information directly to and from the information recording apparatus 123. Further, the IC card 121 may be a card which can be incorporated into the information recording apparatus 123.

In such a case, a process for the information recording apparatus 123 to obtain the first ID information and the second ID information from the IC card 121 and the mobile phone 122, and to generate the authentication information (steps S172 through S176 of FIG. 20 or steps S182 through S186 of FIG. 21) may be a process shown in FIG. 22.

When the information recording apparatus 123 receives the content recording request or the content reproducing request, the communication section 131 sends the requests for the ID information to the mobile phone 122, which is the first device, and to the IC card 121, which is the second device (S192).

When the mobile phone 122 receives the ID information request, the mobile phone 122 sends the first ID information stored in the mobile ID storage section (see FIG. 13) to the information recording apparatus 123 (S193).

When the IC card 121 receives the ID information request, the IC card 121 sends the second ID information stored in the memory (see FIG. 13) to the information recording apparatus 123 (S194).

In the information recording apparatus 123, the communication section 131 receives the first ID information and the second ID information, and the authentication information generating section 132 generates the authentication information (S195).

In the process shown in the flow diagram of FIG. 22, the order for performing the process of the step S193 and the process of the step S194 may be changed.

<2>

The encrypted content ID stored in the recording medium 136 may be encrypted with multiple authentication information.

In such a case, the recording medium 136 stores a plurality of content IDs encrypted with respective authentication information. For reproducing the content, the encrypting and decrypting section 134 uses the authentication information obtained from the authentication information generating section 132 to decrypt the encrypted content ID. At this time, a plurality of the encrypted content IDs are sequentially decrypted using the authentication information obtained from the authentication information generating section 132. Decrypting is continued as long as there is an encrypted content ID which can be decrypted. If any of the plurality of the encrypted content IDs cannot be decrypted, the process is finished as the authentication is not permitted. On the other hand, if any of the plurality of encrypted content IDs can be decrypted, it is regarded that authentication is permitted and the content is further decrypted using the decrypted content ID.

In such a structure, content recorded on the recording medium 136 can be shared by a plurality of users. In other words, users of the number same as the number of authentication information used for encrypting the content ID can use the content recorded on the recording medium 136.

The encryption method for encrypting the content IDs may be a method in which multiple authentication information are used for encrypting and decrypting can be performed with any of the multiple authentication information.

In such a case, a storage capacity of the content ID can be reduced.

<3>

The authentication information may be formed of personal ID inherent to an object to be authenticated, and group ID shared by a group of a plurality of people including the object to be authenticated (e.g., family, school, company and the like).

An information recording apparatus, which is a variation of the information recording apparatus 123, obtains such authentication information and authenticates a person or a group.

Specifically, the authentication information has a structure shown in FIG. 23. Authentication information 225 is formed of personal ID 226 and group ID 227. The group ID 227 may be formed of a plurality of subgroup IDs.

An authentication process using such authentication information 225 is described.

FIG. 24 is a flow diagram showing an authentication process for reproducing content.

As shown in FIG. 24, a process of steps S271 through S276 is a process similar to the process of steps S181 through S186 described with reference to FIG. 21, and thus, description thereof is omitted. The authentication information generated at step S276 is the authentication information 225.

Next, the encrypting and decrypting section 134 obtains encrypted content ID which is recorded by the recording medium 136 via the recording and reproducing section 133, and uses the personal ID 226 of the authentication information 225 to decrypt the content ID (S277). At this step, if the content ID cannot be decrypted (S278), the encrypting and decrypting section 134 uses the group ID 227 of the authentication information 225 to decrypt the content ID (S279). At this step, if the content ID cannot be decrypted (S280), the process is finished as the authentication is not permitted with this authentication information. In other words, the reproduction of the content is refused.

On the other hand, if the content ID can be decrypted at either step S278 or S280, the authentication is permitted. Thus, the encrypting and decrypting section 134 obtains the encrypted content which is recorded by the recording medium 136 via the recording and reproducing section 133, and decrypts content using the decrypted content ID (S281).

In such a case, the authentication information is formed of the personal ID 226 and the group ID 227. The encrypted content ID can be decrypted with either one of them. With such a structure, it becomes easy to use the content for only a specific user, or to share it by a group of users.

For recording the content using such authentication information, it is desirable that the encrypting and decrypting section 134 knows with which of the personal ID 226 and the group ID 227 the content ID should be encrypted. Thus, the mobile phone 122 may send mode information indicating which of the personal ID 226 and the group ID 227 is to be used for encrypting the content ID when sending the first ID information and the second ID information.

In the encrypting and decrypting section 134, the content ID is encrypted by authentication information specified by the mode information.

An authentication process using such mode information is described.

FIG. 25 is a flow diagram showing an authentication process for recording content.

As shown in FIG. 25, a process of steps S285 through S288 is similar to the process of step S171 through S174 described with reference to FIG. 20, and thus, description thereof is omitted. The second ID information sent from the IC card 121 to the mobile phone 122 is information obtained by encrypting the authentication information 225 (see FIG. 23) with the first ID information.

When the mobile phone 122 receives the second ID information, it checks designation of the mode information of the mobile phone 122 (S289). At this step, if the mode is a normal mode (no designation for the mode information), the mobile phone 122 sends the second ID information and the first ID information which is stored in the mobile ID storage section (see FIG. 13) to the information recording apparatus 123 (S290). On the other hand, if the mode is a group mode (mode information designated), the mobile phone 122 sends the second ID information, the first ID information, and the mode information indicating that it is in the group mode to the information recording apparatus 123 (S291).

In the information recording apparatus 123, the mode for encryption is checked based on the information obtained by the communication section 131 (S292).

When the mode information is not included, it is determined that encryption in the normal mode is to be performed, and the authentication information generating section 132 generates the personal ID 226 from the first ID information and the second ID information (S293). The encrypting and decrypting section 134 uses the content ID stored in the storage section 135 to encrypt the content obtained from the content receiving device 142. Further, the recording and reproducing section 133 records the encrypted content on the recording medium 136 (S294). The encrypting and decrypting section 134 uses the personal ID 226 to encrypt the content ID. Further, the recording and reproducing section 133 records the encrypted content ID on the recording medium 136 (S295).

On the other hand, when the mode information is included, it is determined that encryption in the group mode is performed, and the authentication information generating section 132 generates the group ID 227 from the first ID information and the second ID information (S296). The encrypting and decrypting section 134 uses the content ID stored in the storage section 135 to encrypt the content obtained from the content receiving device 142. Further, the recording and reproducing section 133 records the encrypted content on the recording medium 136 (S297). The encrypting and decrypting section 134 uses the group ID 227 to encrypt the content ID. Further, the recording and reproducing section 133 records the encrypted content ID on the recording medium 136 (S298).

In such a way, it becomes possible to designate whether the content is used by a specific person or is shared by a group upon encrypting.

In the above description, it is described that whether to switch between the normal mode and the group mode is determined by the presence/absence of the mode information. However, each of the modes may be switched based on the content of the mode information. Further, if the group ID 227 includes a plurality of subgroup IDs, the mode information may designate which of the subgroup IDs is used for encryption.

The mode setting of the information recording apparatus 123 may be previously set from outside.

<4>

In the above embodiment, the storage section 135 may store authentication information of users who can use the information recording apparatus 123.

In such a case, the storage section 135 has authentication information of users as a database.

FIG. 26 is a flow diagram showing an authentication process for reproducing and storing (hereinafter, referred to as using) content.

As shown in FIG. 26, a process of steps S321 through S326 is similar to the process of steps S181 through S186 described with reference to FIG. 21, or a process of steps S171 through S176 described with reference to FIG. 20, and thus, description thereof is omitted.

The encrypting and decrypting section 134 searches whether the authentication information generated by the authentication information generating section 132 is stored in the database of the storage section 135 (S327).

If there is no matching authentication information as a result of searching (S328), the encrypting and decrypting section 134 finishes encryption/recording and decryption/reproduction of the content. If there is matching authentication information as a result of searching (S328), the encrypting and decrypting section 134 uses the identification information to perform encryption/recording and decryption/reproduction of the content (S329).

With such a structure, the user of the information recording apparatus 123 is authenticated, and use by a person who does not have user authority can be prevented.

The storage section 135 may store the authentication information of users who can use the information recording apparatus 123. In such a case, if a person who has improperly used the information recording apparatus 123 in the past tries to use again, it can be prevented.

The authentication information may have a structure shown in FIG. 23. In such a case, in search of the database, search is respectively performed for the personal ID 226 and group ID 227. In such a case, search may be performed for only the ID which corresponds to the mode previously set to the information recording apparatus (normal mode or group mode: see variation <3>) (which means, either for the personal ID 226 or the group ID 227).

<5>

The information recording apparatus may determine the user authority of the object to be authenticated based on the authentication information.

Such an information recording apparatus 223 will be described specifically with reference to the drawings.

<Structure>

FIG. 27 is a block diagram showing a structure of the information recording apparatus 223 such as DVD players/recorders and the like. The information recording apparatus 223 shown in FIG. 27 is an apparatus which generates authentication information for authenticating a user based on two types of information which the user of the apparatus has, and uses the generated authentication information to reproduce information recorded on an recording medium 236 or record information on the recording medium 236.

The information recording apparatus 223 is formed of a recording and reproducing section 233, an encrypting and decrypting section 234, a storage section 235, an authentication information generating section 232, an input/output section 237, and a communication section 231.

The recording and reproducing section 233, the communication section 231, and the authentication information generating section 232 function similarly to the recording and reproducing section 133, the communication section 131, and the authentication information generating section 132 shown in FIG. 19, respectively. Thus, descriptions thereof are omitted.

The storage section 235 stores a content ID used for encrypting the content. The storage section 235 further stores an ID management information of the object to be authenticated. The ID management information will be described later.

The encrypting and decrypting section 234 encrypts the content obtained via the input/output section 237 with the content ID, or decrypts the encrypted content obtained from the recording and reproducing section 233 with the content ID. Further, the encrypting and decrypting section 234 encrypts the content ID with the authentication information, or decrypts the encrypted content ID with the authentication information.

The encrypting and decrypting section 234 further performs authentication of the object to be authenticated by using the ID management information stored in the storage section 235. The authentication process will be described later.

The input/output section 237 is connected to an external device 242, and inputs/outputs the content.

<Authentication Process>

The authentication process in the information recording apparatus 223 is described. In the authentication process in the information recording apparatus 223, two types of information which only the user of the information recording apparatus 223 is allowed to have, i.e., the information recorded on the IC card 121 and the information in the mobile phone 122, are used for extracting the authentication information. Further, the information recording apparatus 223 determines whether the user is trying to use the apparatus within the scope of the user authority of the user based on the extracted authentication information. If the use is within the user authority, the information recording apparatus 223 permits the authentication. If the use is out of the user authority, the information recording apparatus 223 disapproves the use.

The use of content includes reproduction and recording of the content. The reproduction means not only reproducing the recorded video/audio on a monitor and/or speaker (hereinafter referred to as simple reproduction), but also transferring and copying the recorded information.

The authentication information generated in the present variation is the authentication information having a structure as shown in FIG. 23.

Now, before describing the authentication process in detail, the ID management information stored in the storage section 235 is described with reference to FIG. 28.

FIG. 28 is a diagram illustrating a structure of the ID management information.

As shown in FIG. 28, the ID management information includes “management level”, “contact information”, “scope of alterable management level”, and “user authority for each content” for each of the authentication information (personal IDs and group IDs).

The “management level” is an indicator showing a level of authority for each authentication information. In FIG. 28, the level is divided into five steps. In FIG. 28, a smaller value shows a higher level.

The “contact information” is access information for accessing a person or an administrator of the group corresponding to the authentication information. It includes, for example, a telephone number and/or ID information of the mobile phone.

The “scope of alterable management level” shows an extent of the management level for which the user of a high management level can alter the use authority. Specifically, FIG. 28 shows that a user of personal ID [PID0001] can alter the user authority of the users of the management levels from one to five.

The “user authority for each content” is information indicating the scope of authority for each authentication information. The scope of the authority for the contents are shown for each content of different content levels, such as “level A content”, “level B content” or the like. In this example, the “level A content” is, for example, contents created personally, such as video/audio taken personally. They are contents which can be permitted to use relatively freely without causing any problem. The “level B content” is, for example, DVDs of movies, CDs of musical pieces, and other paid contents, which cannot be permitted to use freely.

Further, for each of the contents, the user authority is set for each use form (simple reproduction, transferring, copying). In this example, the user authority is separated into three levels, such as “◯”, “Δ”, and “X”. “◯” indicates that the user is permitted to use the content (i.e., has user authority). “Δ” indicates that the user is permitted to use the content with the permission from the person of high management level (has limited user authority). “X” indicates that user is not permitted to use (has no user authority).

Next, the authentication process is described with reference to FIG. 29.

FIG. 29 is a flow diagram showing the authentication process for reproducing and storing (hereinafter, referred to as using) the content.

In FIG. 29, the process starts from where the authentication information is already obtained. This means that the process of steps S321 through S326 shown in FIG. 26 is performed before the process shown in FIG. 29.

The encrypting and decrypting section 234 searches whether the authentication information generated by the authentication information generating section 232 (either the personal ID or the group ID) is stored in the ID management information of the storage section 235 (S341).

If there is no matching authentication information as a result of searching (S342), the encrypting and decrypting section 234 finishes encryption/recording and decryption/reproduction of the content. If there is matching authentication information as a result of searching (S342), the encrypting and decrypting section 234 obtains the management level corresponding of authentication information from the ID management information (S343). Further, the encrypting and decrypting section 234 obtains the content level (S344). The content level may be previously recorded when the content is recorded on the recording medium 236, and may be obtained via the recording and reproducing section 233. Alternatively, the content level may be obtained from the communication section 237 via the network.

Further, the encrypting and decrypting section 234 authenticates the user based on the obtained management level, the content level, and the use request for the content to the information recording apparatus 223 (S345). Specifically, whether the user is permitted to use, permitted to use with limitation, or is not permitted to use the content is determined.

The process is described specifically with reference to FIG. 28. For example, the personal ID [PID0004] is obtained from the authentication information. The “content level” of the content is “level A”. The “use request for content” is “simple reproduction”. In such an example, it is determined that the user is permitted to use the content. If the same user tries to “transfer” or “copy” the same content, it is determined that content is not permitted to be used.

When the determined result is “not permitted to use”, the encrypting and decrypting section 234 finishes encryption/recording and decryption/reproduction of the content. On the other hand, when the determined result is “permitted to use”, the encrypting and decrypting section 234 performs encryption/recording and decryption/reproduction of the content (S350).

When the determined result is “permitted with limitation”, the encrypting and decrypting section 234 requests authentication to a user who has higher authority based on the “contact information” (S346 through S349).

Specifically, the encrypting and decrypting section 234 sends the authentication information to the “contact information” via the communication section 231 (S346). The user of the contact information who receives the authentication information decides whether to permit the authentication or not based on the authentication information (S347), and sends back the authentication result to the information recording apparatus 223 (S348). The authentication result is obtained by the encrypting and decrypting section 234 via the communication section 231. When the authentication result received by the encrypting and decrypting section 234 indicates that “authentication is not permitted” (S349), the encrypting and decrypting section 234 finishes encryption/recording and decryption/reproduction of the content. On the other hand, when the authentication result received by the encrypting and decrypting section 234 indicates that “authentication is permitted” (S349), the encrypting and decrypting section 234 performs encryption/recording and decryption/reproduction of the content (S350).

With the above-structure, use of content can be managed more appropriately. For example, use of content by children can be easily managed by their parents. Further, since the scope of the content, which can be used, can be readily defined in accordance with the authority, security of information is improved.

In the above description, the authentication information is sent to the “contact information” at step S346. However, a type of the use request for the content may be sent together. Such authentication confirmation may be performed in a predetermined interval.

In the above description, the ID management information is stored in the storage section 235. However, the present invention is not limited to such an example, and at least a part of the ID management information may be included in the authentication information.

FIG. 30 shows a structure of such authentication information.

The Authentication information 360 shown in FIG. 30 is formed of a personal ID 361, and a group ID 362. The group ID 362 is further formed of subgroup IDs 365, 366, and so on.

The subgroup ID 365 is further formed of subgroup ID information 370 and the management information 371. The subgroup ID information 370 is information for specifying the subgroup. The management information 371 includes the “management level”, “contact information” and the like. The “management level” and “contact information” are similar to those described with reference to FIG. 28, and the “management level” and “contact information” corresponding to the subgroup ID information 370.

With such a structure, the information recording apparatus 223 performs an authentication process similar to that described above by using the obtained management information 371.

The personal ID 361 may also contain the management information similarly to the subgroup ID 365.

<6>

In the description of the above embodiment with reference to FIGS. 19 through 21, it is described that the “encrypted content ID is stored in the recording medium 136”. In this example, the encrypted content ID may be stored in an IC tag (IC chip) provided on the recording medium 136.

In such an example, among the functions of the recording and reproducing section 133 (see FIG. 19), recording of the encrypted content (see FIG. 20, step S178) and reproduction (see FIG. 21, step S187) may be performed by an IC tag recording and reproducing section which can record and reproduce the encrypted content ID for the IC tag.

With this structure, the speed of recording and reproduction can be increased compared to that of, for example, recording and reproducing on and from the recording medium 136 such as an optical disc. Thus, a time period necessary for authentication can be reduced.

### Tenth Embodiment

In the present embodiment, a recording medium and an apparatus which prevent misuse of content stored in the recording medium is described as an example of an application of the authentication system.

The authentication system of the present embodiment is formed of a device provided on a side which gives permission to use content to a user, such as a shop which leases or hands over the recording media in which contents are stored (hereinafter, referred to as a shop device), and a device provided on a side which receives permission to use the content such as a house of user who borrows or purchase the recording media (hereinafter, referred to as user device). The authentication system of the present embodiment is a system for authenticating a user who is permitted to use content and have the user use the content stored in a recording medium.

Hereinafter, the recording medium, the shop device, and the user device used in such a system will be described respectively.

(Structure of Recording Medium)

With reference to FIGS. 31 and 32, the structure of the recording medium is described.

FIG. 31 is a diagram illustrating a physical configuration of a recording medium 420. As shown in FIG. 31, the recording medium 420 is an optical disc 421 which can be read optically, such as DVDs, CDs, BDs, and the like, with an IC tag (IC chip) 422 being attached thereon. The IC tag 422 is accessible by wireless communication. The IC tag 422 is attached to a position such that it does not prohibit the information recorded on the optical disc 421 to be read out. Specifically, the IC tag 422 is attached to the innermost area of the optical disc 421 where the information is not recorded (clamp area) 421b.

The attachment position of the IC tag 422 is not limited to such a position. For example, the IC tag 422 may be provided at a radial position corresponding to an information recording area 421a of the optical disc 421 if it is not on the side from which the information of the optical disc 421 is read out. If the IC tag 422 is provided on an outer peripheral part of the optical disc 421, it is preferable to provide a plurality of the IC tags such that their center of gravity matches the center of rotation in order to avoid eccentricity of the optical disc 42a. Further, when the optical disc 421 is used with being accommodated in a cartridge, the IC tag 422 may be provided on the cartridge.

FIG. 32 is a diagram illustrating the relationship between the physical configuration of the recording medium 420 and the structure of data stored in the recording medium 420. As shown in FIG. 32, the recording medium 420 is formed of three recording areas (first through third recording areas 431 through 433) which store different types of data.

The first recording area 431 is an area provided in the information recording area 421a of the optical disc 421. Various types of information, including multimedia contents such as video/audio, are recoded thereon with being encrypted. Hereinafter, the information recorded on the first recording area 431 is referred to as encrypted content 441.

The second recording area 432 is an area provided in a part of the recording area of the IC tag 422. An encryption key 442 for the encrypted content 441 recorded on the first recording area 431 is recorded thereon. The second recording area 432 is provided in a protected area of the IC tag 422, and can be accessed from only the authenticated devices.

The third recording area 433 is an area provided in other parts of the recording area of the IC tag 422. The area can store an encrypted encryption key 443 which is obtained by encrypting the encryption key 442. The third recording area 433 is provided in a free area of the IC tag 422. Encryption of the encryption key 442 is used by using an identification number of a user who is permitted to decrypt and use the encrypted content 441.

(Structure and Operation of Shop Device)

A structure and operations of the shop device will be described with reference to FIGS. 33 and 34.

FIG. 33 is a block diagram showing a structure of a shop device 451.

The shop device 451 is a device provided in a shop and the like which rents or sell the recording medium 420 to a user. The shop device 451 records the encryption key 442 of the encrypted content 441 such that only the valid user can decrypt so as to ensure that only the valid user can use the encrypted content 441 stored in the recording medium 420. The shop device 451 includes a first obtaining section 453, a second obtaining section 454, an authentication section 455, an encryption section 456, and a recording section 457.

The first obtaining section 453 obtains user ID 445 recorded on a member card 435 or the like which is provided by the shop and the user has. The first obtaining section 453 reads the member card 435, which is a magnetic card or an IC card, and obtains the user ID 445.

The second obtaining section 454 communicates with the second recording area 432 of the IC tag 422, and obtains the encryption key 442. The encryption key 442 obtained by the communication with the second recording area 432 is obtained after mutual authentication between the shop device 451 and the IC tag 422 is performed. This is because the second recording area 432 is provided in the protected area of the IC tag 422. The authentication process at the shop device 451 side is performed by the authentication section 455 based on the information obtained from the second obtaining section 454. The authentication process for the IC tag has been described in the above embodiment, so descriptions thereof are omitted.

The authentication section 455 performs authentication of the user based on the user ID 445 obtained by the first obtaining section 453 in addition to the mutual authentication with the IC tag 422 via the second obtaining section 454. Specifically, the authentication section 455 access a user database provided inside or outside the device, and determines whether the obtained user ID 445 is user ID of a valid user.

When the authentication result of the authentication section 455 shows that authentication is permitted, the encryption section 456 encrypts the encryption key 442 obtained from the second obtaining section 454 by using the user ID 445 obtained from the first obtaining section 453, and generates an encrypted encryption key 443.

The recording section 457 records the encrypted encryption key 443 generated by the encryption section 456 on the third recording area 433 of the recording medium 420. Since the third recording area 433 is provided on the IC tag 422, the recording section 457 records the encrypted encryption key 443 on the third recording area 433 through communication with the IC tag 422.

Operations of the shop device 451 are further described with reference to FIG. 34.

When the process of the shop device 451 is started, the first obtaining section 453 obtains the user ID 445 from the member card 435 (step S520). The authentication section 455 determines whether the user is a valid user or not based on the user ID 445 (step S521). If the result of determination is negative, the process of the shop device 451 is finished. On the other hand, if the result of determination is positive, the authentication section 455 performs the authentication process with the IC tag 422 of the recording medium 420 via the second obtaining section 454 (step S522). If the authentication is not permitted (step S523), the process of the shop device 451 is finished. On the other hand, if the authentication is permitted (step S523), the second obtaining section 454 obtains the encryption key 442 from the second recording area 432 on the IC tag 422 (step S524). The encryption section 456 uses the user ID 445 obtained by the first obtaining section 453 to encrypt the encryption key 442 obtained by the second obtaining section 454 and generates the encrypted encryption key 443 (step S525). The recording section 457 records the encrypted encryption key 443 on the third recording area 433 on the IC tag 422.

With the above-described process, the shop device 451 provides the recording medium 420 on which the encrypted encryption key 443 is recorded to a user.

(Structure and Operation of User Device)

A structure and operations of the user device are described with reference to FIGS. 35 and 36.

FIG. 35 is a block diagram showing a structure of a user device 461.

The user device 461 is a device provided in a house or the like of the user who rented or purchased the recording medium 420 from the shop. The user device 461 authenticates whether the user is a valid user for the encrypted content 441 stored in the recording medium 420 (a user permitted to use the encrypted content 441), and let the user use the encrypted content 441 when the authentication is permitted. Specifically, the user device 461 is mounted to an apparatus which can reproduce optical discs, such as a CD player, a DVD player, a BD player and the like, which is provided at the house of the user or the like. The user device 461 includes a third obtaining section 462, a fourth obtaining section 463, a fifth obtaining section 464, a user authentication section 465, an encryption key decrypting section 466, and a content decrypting section 467.

The third obtaining section 462 obtains the user ID 445 recorded on the member card 435 or the like which is provided by the shop or the like and the user has. The third obtaining section 462 reads the member card 435, which is a magnetic card or an IC card, and obtains the user ID 445.

The fourth obtaining section 463 communicates with the third recording area 433 of the IC tag 422 of the recording medium 420 placed on the user device 461, and obtains the encrypted encryption key 443 recorded on the third recording area 433 at the shop. The encrypted encryption key 443 obtained through communication with third recording area 433 is obtained without mutual authentication between the user device 461 and the IC tag 422. This is because the third recording area 433 is provided in the free area of the IC tag 422. The communication with the IC tag has been described in the above embodiment, so descriptions thereof are omitted.

The fifth obtaining section 464 reproduces the information recording area 421a of the optical disc 421 to obtain the encrypted content 441 recorded on the first recording area 431. Specifically, the fifth obtaining section 464 is realized as the recording and reproducing section 133 of the information recording apparatus 123 shown in FIG. 19.

The user authentication section 465 authenticates the user based on the user ID 445 obtained by the third obtaining section 462. Specifically, the user authentication section 465 accesses the user database provided inside or outside the device, and determines whether the obtained user ID 445 is user ID of a user permitted to use the user device 461.

When the user ID 445 is determined to be user ID of a user permitted to use the user device 461 by the user authentication section 465, the encryption key decrypting section 466 uses the user ID 445 obtained by the third obtaining section 462 to perform decryption of the encrypted encryption key 443 obtained by the fourth obtaining section 463. If the decryption having the user ID 445 as a decryption key is possible, it means that the user is authenticated as a valid user (user who is permitted to use the encrypted content 441).

The content decrypting section 467 uses the encryption key 442 decrypted by the encryption key decrypting section 466 to decrypt the encrypted content 441 obtained by the fifth obtaining section 464.

With the above-described process, the encrypted content 441 stored in the recording medium 420 is decrypted, and the decrypted content is output to an output device 471 connected to the user device 461 as, for example, a video/audio signal. The output device 471 is a device such as video/audio monitor and the like.

Operations of the user device 461 are further described with reference to FIG. 36.

When the process of the user device 461 is started, the third obtaining section 462 obtains the user ID 445 from the member card 435 (step S530). The user authentication section 465 determines whether the user is a user who is permitted to use the user device 461 or not based on the user ID 445 (step S531). If the result of determination is negative, the process of the user device 461 is finished. On the other hand, if the result of determination is positive, the fourth obtaining section 463 obtains the encrypted encryption key 443 from the third recording area 433 on the IC tag 422 (step S532). The encryption key decrypting section 466 decrypts the encrypted encryption key 443 using the user ID 445 (step S533). If the encrypted encryption key 443 cannot be decrypted (step S534), the process of the user device 461 is finished. On the other hand, if the encrypted encryption key 443 can be decrypted, and the encryption key 442 is generated (step S534), a reproduction process of the encrypted content 441 is started (steps S535 through S539).

First, end of reproduction of the encrypted content 441 is determined. If the reproduction is finished (step S535), the process of the user device 461 is finished. On the other hand, the reproduction is at the beginning or in a midcourse (step S535), the fifth obtaining section 464 obtains the encrypted content 441 from the first recording area 431 of the optical disc 421 (step S536). The content decrypting section 467 decrypts the encrypted content 441 obtained by the fifth obtaining section 464 with the encryption key 442 decrypted by the encryption key decrypting section 466 (step S537). When the encrypted content 441 cannot be decrypted (step S538), the process of the user device 461 is finished. On the other hand, when the encrypted content 441 can be decrypted (step S538), the decrypted content is reproduced (step S539). The above process is continued until the reproduction of the content is finished.

(Effects)

In the recording medium 420, the content is recorded on the optical disc 421 with being encrypted. This secures the safety in use of the content recorded on the optical disc 421.

The encryption key 442 used for encryption is stored in a protected area of the IC tag 422, to which only the authenticated object can access. Thus, inappropriate decryption of the encrypted content 441 using the encryption key 442 stored in the second recording area 432 can be prevented.

The encrypted encryption key 443 stored in the third recording area 433 is information obtained by encrypting the encryption key 442 by using the user ID 445 of the user permitted to use the content. Thus, it becomes possible to prevent that the encryption key 442 is inappropriately decrypted, and then the encrypted content 441 is inappropriately decrypted.

(Variations)

In the above embodiment, for encrypting the encryption key 442 at the shop device 451, the encryption using the user ID 445 obtained from the member card 435 is performed. Further, for decrypting the encryption key 442 at the user device 461, decryption using the user ID 445 obtained from the member card 435 is performed as described above. In such an example, when confidentiality of the user ID 445 is required, it is preferable that the shop device 451 or the user device 461 obtains the information obtained by encrypting the user ID 445.

This feature is described with reference to FIGS. 37 through 40.

FIG. 37 is a block diagram showing a structure of a shop device 451a in the case where the user ID is provided using a mobile phone 475 and an IC card 476 instead of the member card 435. FIG. 37 shows a structure different from that of the shop device 451 shown in FIG. 33. As shown in FIG. 37, the shop device 451a is different from the shop device 451 only in the structure of a first obtaining section 453a, and the remaining part of the structure (the second obtaining section 454, the authentication section 455, the encryption section 456, the recording section 457) is similar.

Before describing the structure of the first obtaining section 453a in details, the mobile phone 475 and the IC card 476 used instead of the member card 435 are described. The mobile phone 475 and the IC card 476 have similar structures as the mobile phone 122 and the IC card 121 described with reference to FIG. 19. Specifically, the mobile phone 475 includes a communication section 475a for communication with the outside, and a memory 475b. The memory 475b stores the second information 475c which is the identification information of the mobile phone 475. The IC card 476 includes a communication section 476a for communication with the outside, and a memory 476b. The memory 476b stores first information 476c. The first information 476c is the information obtained by encrypting the user ID 445, which is the identification information of the user, with the second information 475c stored in the mobile phone 475.

The communication sections 475a and 476a of the mobile phone 475 and the IC card 476 can communicate each other. Thus, the IC card 476 can send the first information 476c to the mobile phone 475 in response to a request from the mobile phone 475. Further, the communication section 475a of the mobile phone 475 can communicate with the first obtaining section 453a of the shop device 451a. Thus, the mobile phone 475 can send the second information 475c and the first information 476c which is received from the IC card 476 to the shop device 451a in response to a request from the shop device 451a.

The mobile phone 475 and the IC card 476 as described above may be provided separately. Alternatively, they may be integrally provided by, for example, attaching an IC tag (IC chip) portion of the IC card 476 to the mobile phone 475.

Next, a structure of the first obtaining section 453a is described. The first obtaining section 453a includes a communication section 453b and a user ID decrypting section 453c. The communication section 453b can communicate with the mobile phone 475 having the above-described structure. Thus, the communication section 453b sends a request for sending the second information 475c and the first information 476c to the communication sections 475a of the mobile phone 475. The communication section 453b also receives the second information 475c and the first information 476c sent from the communication sections 475a. The user ID decrypting section 453c decrypts the user ID 445 based on the second information 475c and the first information 476c received by the communication section 453b. Specifically, the first information 476c is decrypted by using the second information 475c to generate the user ID 445.

The process by each of other sections of the shop device 451a is similar to that described in the above embodiment, and thus, description thereof is omitted.

Operations of the shop device 451a, particularly, operations until the shop device 451a obtains the user ID 445 are further described with reference to FIG. 38.

When the process of the shop device 451a is started, the communication section 453b sends an ID request to the mobile phone 475 (step S620). When the mobile phone 475 receives the ID request, it sends a request for sending the first information 476c to the IC card 476 (step S621), and receives the first information 476c sent from the IC card 476 in response to the sending request. When the mobile phone 475 receives the first information 476c from the IC card 476, it sends the first information 476c to the shop device 451a with the second information 475c stored in the memory 475b. In this way, the first obtaining section 453a of the shop device 451a obtains the first information 476c and the second information 475c from the mobile phone 475 (step S622). The user ID decrypting section 453c uses the second information 475c to decrypt the first information 476c (step S623). If the first information 476c cannot be decrypted (step S624), the process of the shop device 451a is finished. On the other hand, if the first information 476c can be decrypted and the user ID 445 can be obtained (step S624), then the process of steps S521 through S526 described in the above embodiment is performed. Since the process has been described in the above embodiment, descriptions thereof are omitted.

With the shop device 451a as described above, the user ID 445 is obtained based on the information obtained from the mobile phone 475 and the IC card 476, and it becomes possible to provide the user with the recording medium 420 recording the encrypted encryption key 443 which is encrypted by using the obtained user ID 445.

FIG. 39 is a block diagram showing a structure of a user device 461a in the case where the user ID is provided using a mobile phone 475 and an IC card 476 instead of the member card 435. FIG. 39 shows a structure different from that of the user device 461 shown in FIG. 35. As shown in FIG. 39, the user device 461a is different from the user device 461 in the structure of a third obtaining section 462a, and the remaining part of the structure (the fourth obtaining section 463, the fifth obtaining section 464, the user authentication section 465, the encryption key decrypting section 466, the content decrypting section 467) is similar.

Further, the structures of the mobile phone 475 and the IC card 476 which communicate with the third obtaining section 462a instead of the member card 435 are similar to those described with reference to FIG. 37. The communication section 475a of the mobile phone 475 can communicate with the third obtaining section 462b of user device 461a. Thus, the mobile phone 475 can send the second information 475c and the first information 476c which is received from the IC card 476 to the user device 461a in response to a request from the user device 461a.

A structure of the third obtaining section 462a is described. The third obtaining section 462a includes a communication section 462b and a user ID decrypting section 462c. The communication section 462b can communicate with the mobile phone 475 having the above-described structure. Thus, the communication section 462b sends a request for sending the second information 475c and the first information 476c to the communication section 475a of the mobile phone 475. The communication section 462b also receives the second information 475c and the first information 476c sent from the communication section 475a. The user ID decrypting section 462c decrypts the user ID 445 based on the second information 475c and the first information 476c received by the communication section 462b. Specifically, the first information 476c is decrypted by using the second information 475c to generate the user ID 445.

The process by each of other sections of the user device 461a is similar to that described in the above embodiment, and thus, description thereof is omitted.

Operations of the user device 461a, particularly, operations until the user device 461a obtains the user ID 445 are further described with reference to FIG. 40.

When the process of the user device 461a is started, the communication section 462b sends an ID request to the mobile phone 475 (step S630). When the mobile phone 475 receives the ID request, it sends a request for sending the first information 476c to the IC card 476 (step S631), and receives the first information 476c sent from the IC card 476 in response to the sending request. When the mobile phone 475 receives the first information 476c from the IC card 476, it sends the first information 476c to the user device 461a with the second information 475c stored in the memory 475b. In this way, the third obtaining section 462a of the user device 461a obtains the first information 476c and the second information 475c from the mobile phone 475 (step S632). The user ID decrypting section 462c uses the second information 475c to decrypt the first information 476c (step S633). If the first information 476c cannot be decrypted (step S634), the process of the user device 461a is finished. On the other hand, if the first information 476c can be decrypted and the user ID 445 can be obtained (step S634), then the process of steps S531 through S539 described in the above embodiment is performed. Since the process has been described in the above embodiment, descriptions thereof are omitted.

With the user device 461a as described above, the user ID 445 is obtained based on the information obtained from the mobile phone 475 and the IC card 476. The encrypted encryption key 443 is decrypted with the obtained user ID 445 to generate the encryption key 442. The encrypted content 441 which has been encrypted with the encryption key 442 can be decrypted to reproduce the content.

In the shop device 451a and the user device 461a, which are variations of the above embodiment, the encrypted user ID 445 is obtained and decrypted within the device for obtaining the user ID 445. Thus, they are particularly useful when confidentiality of the user ID 445 is required.

### Eleventh Embodiment

Hereinafter, the eleventh embodiment of the present invention will be described in details with reference to the drawings.

FIG. 41 is a block diagram showing a structure of an authentication system according to the present embodiment. FIG. 41 illustrates a method for purchasing tickets for rides in a theme park or the like. In FIG. 41, reference numeral A101 denotes a mobile phone, reference numeral A108 denotes an IC card, reference numeral A112 denotes a billing information generating device, which is a ticket vendor provided at the theme park, reference numeral A120 denotes an input device for inputting the number of use to the billing information generating device A112, reference numeral A102 denotes a billing information storage area, reference numeral A103 denotes an ID information storage unit, reference numeral A104 denotes a communication unit for performing communication with the IC card A108 and/or the billing information generating device A112, reference numeral A105 denotes encrypted number-of-use controlling information stored in the billing information storage area A102, reference numeral A106 denotes number-of-use displaying information, reference numeral A107 denotes first ID information stored in the ID information storage unit, reference numeral A109 denotes an ID information storage unit, reference numeral A110 denotes a communication unit for communicating with the mobile phone A101, reference numeral A111 denotes second ID information stored in the ID information storage unit A109, and reference numeral A113 denotes a communication unit for communicating with the mobile phone A101 and/or the input device A120. As described in other embodiments, personal authentication of a user can be performed using the first ID information A107 and the second ID information A111. In the present embodiment, the ID of the user having the mobile phone A101 and the IC card A108 is encrypted with the first ID information A107 to obtain the second ID information A111.

Hereinafter, a procedure for purchasing a ticket at a theme park with the authentication system of FIG. 41 will be described with reference to FIG. 42.

At step A201, the number of use is input to the input device A120.

At step A202, an ID information request is sent from the communication unit A113 of the billing information generating device A112 to the mobile phone A101.

At step A203, the communication unit A104 of the mobile phone A101 sends a request for the second ID information to the IC card A108.

At step A204, the second ID information A111 is obtained from the IC card A108.

At step A205, the first ID information A107 and the second ID information A111 are sent to the billing information generating device A112.

At step A206, the second ID information A111 is decrypted with the first ID information A107 to obtain the user ID information.

At step A207, the user ID information obtained at step A206 and ID information of an ID information list A119 stored in the ID information storage unit A116 are verified at the authentication unit A115 to check whether the user is a valid user. If the user is a valid user, the process moves to step A208, and if the user is not a valid user, the process is finished with an error.

At step A208, the number-of-use control information in accordance with the number of use input at step A201 is obtained from a memory, which is not shown, in the billing information generating device A112. The number-of-use control information is information formed of the number of use of rides, expiry date, and the like.

At step A209, the number-of-use control information is encrypted using the first ID information A107 and an encryption key AA118. For encryption, from the first ID information A107 and the encryption key AA118, a new encryption key (referred to as use information encryption key) is generated, and the use information encryption key is used. The encryption is not limited to the above-mentioned method. The number-of-use control information may be encrypted first with the first ID information A107 and then with the encryption key AA118, or the other way around. In such cases, the order to use keys in decryption should be considered.

At step A210, the encrypted number-of-use controlling information A105, and the number-of-use displaying information 106 for displaying the number-of-use control information on the mobile phone A101 are sent to the mobile phone. The number-of-use displaying information A106, the number-of-use control information obtained at step A208 may be sent as it is, or information may be generated from a part of the number-of-use control information or the number-of-use control information itself.

At step A211, the encrypted number-of-use controlling information A105 and the number-of-use displaying information A106 are recorded on the billing information storage area A102 of the mobile phone A101.

With the above-described procedure, the first ID information A107 stored in the mobile phone A101 and the second ID information A111 stored in the IC card A108 can be used to perform the purchasing process for a ticket for a ride at a theme park by the user who is determined to be a valid user. A process for determining the user to be the valid user or not is not essential, and can be omitted.

Hereinafter, a method for using a ticket for a ride of a theme park which is purchased with a procedure of FIG. 42 is described with reference to FIGS. 43 and 44.

FIG. 43 is a diagram illustrating a method for using a ticket for a ride at a theme park. The same components as those in FIG. 41 are denoted by the same reference numerals, and descriptions thereof are omitted. Reference numeral A301 denotes a billing information use device, reference numeral A302 denotes a billing history storage unit, reference numeral A303 denotes a billing information management unit. The billing history storage unit A302 is an area for storing a user who is billed by the billing information use device A301, which means, a user who uses a ticket, as use history information for each user ID. The billing information management unit A303 interprets the number-of-use control information input to the billing information use device A301 and performs a billing process. In the present embodiment, the billing information generation device and the billing information use device are the same device, but they may be the separate devices.

Hereinafter, a procedure for using a ticket in a theme park with the authentication system of FIG. 43 is described with reference to FIG. 44.

At step A401, an input device, which is not shown, is used to input the number of use to the billing information use device A301. The number of use may be set as different values for each of the rides and facilities. However, for the sake of simplicity, the number of use is reduced by one for one use of any ride and facility.

At step A402, a number-of-use control information request is sent from the communication unit A113 of the billing information use device A301 to the mobile phone A101.

At step A403, the encrypted number-of-use controlling information A105 and the first ID information A107 are sent from the communication unit A104 of the mobile phone A101 to the billing information use device A301.

At step A404, the encrypted number-of-use controlling information A105 is decrypted by using the first ID information A107 and the encryption key AA118. Decryption is performed using the decryption key generated from the first ID information A107 and the encryption key AA118. As described above, the procedure and/or method to perform decryption varies so as to conform to the method of encrypting at step A209 described with reference to FIG. 42.

At step A405, it is determined whether the user is a valid user or not depending upon the result of decryption at step A404. If the user is a valid user, the process moves to step A406. If the user is not a valid user, the process finishes with an error.

At step A406, as a result of decryption at step A404, expiry date included in the obtained number-of-use control information is confirmed. If it is determined to be within the expiry date at step A407, the process moves to step A408, and if it is determined to expire, the process is finished with an error.

At step A408, as a result of decryption at step A404, the number of use of rides included in the obtained number-of-use control information is confirmed. If it is determined that the number of use is left at step A409, the process moves to step A410, and if it is determined that the number of use is not left, the process finishes with an error. The number of use of the rides may be set to the maximum number which can be used, and the number of times that the user used may be recorded to the mobile phone A101 or the billing information use device A301. Whether the number of use is left or not may be determined by comparing them.

At step A410, the number of use of the number-of-use control information is subtracted by “one”, and the number of use is updated.

At step A411, the number-of-use control information updated at step A410 is encrypted using the first ID information A107 and the encryption key AA118.

At step A412, the encrypted number-of-use controlling information A105 and the number-of-use displaying information A106 which is for displaying the number-of-use control information on the mobile phone A101 are sent to the mobile phone A101. The number-of-use displaying information A106 is newly generated by using the number-of-use control information updated at step A410.

At step A413, the encrypted number-of-use controlling information A105 and the number-of-use displaying information A106 are recorded on the billing information storage area A102 of the mobile phone A101.

With the above procedure, the tickets for rides of a theme park are registered to the mobile phone A101 in order to enable using rides and facilities of the theme park just by holding the mobile phone A101. Also, since the number-of-use control information stored in the mobile phone A101 is encrypted with the information of the billing information use device A301 and the information of the mobile phone A101, only a combination of a valid mobile phone and a valid use device can be used. Thus, manipulation by inappropriate user can be prevented.

### Twelfth Embodiment

Hereinafter, an authentication process in which use is permitted within a limited authority range even with only one of two devices having inherent information will be described with reference to the drawings.

FIG. 45 shows the configuration of the authentication system in this embodiment. This authentication system has a mobile terminal 4510 such as a mobile phone, a transmitter 4520 such as an IC tag, an authority granting apparatus 4530, and an authority exercising apparatus 4540 that operates according to the authority information. If a request for sending ID information is received from the authority granting apparatus 4530, the mobile terminal 4510, which is a first device, sends its own first ID information (hereinafter, referred to as ID1) to the authority granting apparatus 4530. Furthermore, if second ID information (hereinafter, referred to as ID2) is received from the transmitter 4520, which is a second device, the mobile terminal 4510 sends ID2 together with ID1 to the authority granting apparatus 4530. Moreover, as described later, if ID2 is received, the mobile terminal 4510 also sends reception determining information indicating whether or not the reception strength is at a predetermined level or higher. The authority granting apparatus 4530 that has received ID1, or both ID1 and ID2 generates authority information, or selects authority information that has been stored in advance, according to the number of authenticated IDs, and sends the authority information to the mobile terminal 4510. The mobile terminal 4510 sends the authority information to the authority exercising apparatus 4540, and the authority exercising apparatus 4540 operates according to the authority information. Herein, ID1 is user ID information, and ID2 is a digital signature of ID1.

FIG. 46 schematically shows the internal configuration of the authority granting apparatus 4530. In the authority granting apparatus 4530, an ID requesting section 4531 sends a signal for requesting ID information, to the mobile terminal 4510, for example, by polling or external input. As described later, an ID receiving section 4532 receives ID1, both ID1 and ID2, reception determining information of ID2, from the mobile terminal 4510. An ID number determining section 4533 determines the number of pieces of received ID information, that is, whether only ID1, or both ID1 and ID2 have been received. If both ID1 and ID2 have been received, the ID number determining section 4533 determines whether or not reception strength of ID2 is at a predetermined level or higher. If it is determined that only ID1 has been received, a user information confirmation section 4535 refers to a user information database 4539, and determines whether or not ID1 matches registered user information. If it is determined that both ID1 and ID2 have been received, a digital signature verifying section 4534 performs a digital signature verification process, as described later, so that it can exercise authentication and detect alteration of ID information, for example. As described later, an authority generating section 4537 generates authority information from the authority information (Full authority, Limited authority, None authority) that have been stored in advance in an authority information storage section 4536. An authority information sending section 4538 sends the generated authority information to the mobile terminal 4510.

FIG. 47 shows a flow of an ID number determination process performed by the ID number determining section 4533. First, it is determined whether or not ID2 has been received (S801). If it is determined that ID2 has not been received, only ID1 is output to the user information confirmation section 4535, and information indicating that the ID number is 1 is output (S804). If it is determined that ID2 has been received, it is further determined whether or not ID reception determination indicating that the reception strength of ID2 is at a predetermined level or higher has been negative (S802). If the reception strength of ID2 is at a predetermined level or higher, ID1 and ID2 are output to the digital signature verifying section 4534 (S803). If the strength of ID2 is not at a predetermined level or higher and thus the ID reception determination has been negative, only ID1 is output to the user information confirmation section 4535, and the ID number is set to be 1 (S804).

FIG. 48 shows a flow of a digital signature verification process performed by the digital signature verifying section 4534, which is a process performed only when both ID1 and ID2 have been received. First, a digital signature of ID1 is generated, and it is determined whether or not the digital signature matches ID2 (S811). If the digital signature matches ID2, ID1 is output to the user information confirmation section 4535 (S812). If the digital signature does not match ID2, ID1 is output to the user information confirmation section 4535, and information indicating failure in signature verification is output to the authority information generating section 4537 (S813).

FIG. 49 shows a flow of an authority information generation process performed by the authority generating section 4537. First, it is determined based on received confirmation information whether or not user registration has been confirmed by the user information confirmation section 4535 (S821). If confirmation information has not been received, None authority information is output (S822). If user registration has been confirmed, it is determined whether or not the number of pieces of ID information is 1 (S823). If the number of pieces of ID information is 1, Limited authority is output (S825). If the number of pieces of ID information is not 1, it is judged whether or not the above-mentioned information indicating failure in signature verification is present (S824). If the information indicating failure in signature verification is present, Limited authority is output (S825). If the information indicating failure in signature verification is not present, Full authority is output (S826).

Herein, Full authority and Limited authority will be described. For example, if the authority exercising apparatus 4540 is an automated teller machine (ATM), Full authority permits a transfer up to 5,000,000 yen, while Limited authority permits a transfer only up to 300,000 yen. Furthermore, if the authority exercising apparatus 4540 is a door restricting entrance/exit at a building entrance, Full authority is considered to permit unlock of all rooms in the building, while Limited authority is considered to permit unlock of only a part of rooms in the building. Moreover, if the authority exercising apparatus 4540 is used for an electronic money device or the like, Full authority permits use of all the total amount, while Limited authority permits purchase only up to 10,000 yen.

FIG. 50 shows the configuration of the mobile terminal 4510, which is a first device. In the mobile terminal 4510, an ID2 receiving section 4511 receives ID2. Furthermore, an ID request receiving section 4512 receives a request for ID information, from the authority granting apparatus 4530. If ID2 is received, a reception strength determining section 4513 determines based on the reception strength of ID2 whether or not the reception level of ID2 is at a predetermined level or higher, and generates reception determining information. It is determined based on that determining information whether or not the transmitter 4520 is within a range of a predetermined distance from the mobile terminal 4510, and thus it is possible to perform authentication at a higher security level. The reception determining information of ID2 is output to an ID sending section 4514. If ID2 has not been received, the ID sending section 4514 sends only ID1 that has been stored in advance. If ID2 has been received, the ID sending section 4514 sends both ID1 and ID2, and the reception determining information of ID2 to the authority granting apparatus 4530.

FIG. 51 shows the transmitter 4520. In the transmitter 4520, an ID2 transmission timing generating section 4521 causes ID2 that has been stored in advance to be transmitted at a predetermined timing, and an ID2 transmitting section 4522 transmits ID2. Accordingly, ID2 is transmitted from the transmitter 4520 constantly at predetermined intervals.

FIG. 52 shows a flow of the entire process of the authentication system shown in FIG. 50. First, the mobile terminal 4510 judges whether or not a request for sending ID information is present (S831). If a request for sending ID information is present, it is determined whether or not ID2, which is transmitted from the transmitter 4520 (S832), has been received (S833). If ID2 has not been received, ID1 is sent to the ID sending section 4514 (S837). If ID2 has been received, it is determined whether or not the reception strength is at a predetermined level or higher (S834). If it is determined that the reception strength of ID2 is at a predetermined level or higher, ID2 is output to the ID sending section 4514 (S835), and ID1 is also output to the ID sending section 4514 (S837). If it is determined that the reception strength of ID2 is not at a predetermined level or higher, information indicating negative as the reception determining information of ID2 is output to the ID sending section (S836), and ID1 is output to the ID sending section 4514 (S837). The ID sending section sends ID1, ID2, and the reception determining information of ID2 to the authority granting apparatus 4530 (S837). In the authority granting apparatus 4530, first, ID1, ID2, and the reception determining information of ID2 are received, and the ID number determination process (S840), the digital signature verification process (S841), and the authority information generation process (S842) are performed as described above. Then, as shown in FIG. 49, generated authority information is sent to the mobile terminal 4510 (S843), and the authority information is received in the mobile terminal 4510 (S844). The received authority information is stored in the authority information storage section 4536 (S845), and the authority information is sent to the authority exercising apparatus 4540 (S846). If the authority information is received (S847), the authority exercising apparatus 4540 operates according to the authority information (S848). If the authority exercising apparatus 4540 operates once, the authority information is updated (S849), and the updated authority information is sent to the mobile terminal 4510 (S850). The mobile terminal 4510 receives the updated authority information (S851), and stores the authority information (S852).

Note that the first device and the second device are not limited to the foregoing embodiment. For example, the mobile terminal may be the second device, and the transmitter may be the first device.

Furthermore, in the foregoing embodiment, ID1 was the user ID information, and ID2 was the digital signature of the user ID information, but the opposite is also possible. Furthermore, one of the pieces of ID information may be encrypted user ID information, and the other ID information may be a decryption key.

### Thirteenth Embodiment

FIG. 53 shows the configuration of an authentication system in entrance/exit management. The authentication system has a mobile terminal 4610 such as a mobile phone, an IC card 4620, an unlock key lending apparatus 4630 serving as an authority granting apparatus, and an entrance/exit management apparatus 4650 serving as an authority exercising apparatus. The unlock key lending apparatus 4630 sends a request for sending ID information, to the IC card 4620 by polling. If the unlock key lending apparatus 4630 that has received ID2 from the IC card 4620 further receives ID1 from the mobile terminal 4610, the unlock key lending apparatus 4630 generates a limited unlock key and sends it to the IC card 4620. On the other hand, the entrance/exit management apparatus 4650 sends a request for sending an unlock key, to the IC card 4620 by polling. If a request for sending an unlock key is received, the IC card 4620 sends the stored limited unlock key together with ID2.

FIG. 54 shows the internal configuration of the unlock key lending apparatus 4630. In the unlock key lending apparatus 4630, an ID2 requesting section 4631 sends a request for ID2, to the IC card 4620 by polling. If the IC card 4620 is within a signal reception range, an ID2 receiving section 4632 receives ID2. An ID1 receiving section receives ID1 from the mobile terminal 4610. An ID correspondence confirmation section 4634 confirms whether or not ID1 and ID2 correspond to each other. For example, in a case where ID2 serving as user ID information has been encrypted using ID1 serving as a key, if the ID correspondence confirmation section can decrypt it, it is confirmed that ID1 and ID2 correspond to each other. A user confirmation section 4635 refers to a user management database 4636, and confirms whether or not a user corresponding to the received user ID information has been registered. An authority information generating section 4637 generates authority information by reading authority information that has been input by an authority information input section 4639 and stored by an authority information storage section 4638, that is, an unlock key that can be used only within a limited range. An encrypting section 4640 encrypts the authority information with ID information corresponding to a device that has been selected by a device selecting section 4641, and provides a digital signature thereto. An authority information sending section 4642 sends the encrypted authority information to the selected device. With this process, the ID information contained in the selected device and the generated authority information are made to correspond to each other.

FIG. 55 shows in more detail a flow of the process in the authentication system in this embodiment. First, the unlock key lending apparatus 4630 sends a request for sending ID2 by polling, to the IC card 4620 (S851). Whether or not the IC card 4620 has been detected, that is, whether or not ID2 has been received is determined (S852). The IC card 4620 that has received the request for sending ID2 (S853) sends ID2 (S854). Next, the unlock key lending apparatus 4630 that has received ID2 (S855) determines whether or not ID1 has been received (S856). If ID1 that has been intermittently sent from the mobile terminal 4610 (S857) is not received, the unlock key lending apparatus 4630 ends the process. If ID1 is received (S858), the unlock key lending apparatus 4630 decrypts ID2 using ID1 as a key, and generates user ID information (S859). Then, it is determined whether or not the user ID information has been registered in the user management database 4636 (S860). If the user ID information has not been registered, an error indication is generated and output (S861). If the user ID information has been registered, authority information is generated/acquired from the authority information storage section 4638 (S862), and a device to which the authority information is to be input is selected by the device selecting section 4641 (S863). It is determined whether or not the selected device is a first device, that is, the mobile terminal 4610 (S864). If the selected device is the mobile terminal 4610, the authority information is encrypted with ID1 (S865), and sent to the mobile terminal 4610 (S866). If the selected device is not the first device, that is, the selected device is the IC card 4620, the authority information is encrypted with ID2 (S871), and sent to the IC card 4620 (S872). The authority information that has been sent to each device is stored (S867 to 868, S873 to 874), and the unlock key lending apparatus 4630 is notified that reception of the authority information has been completed (S869 to 870, S875 to 876).

Note that the foregoing embodiment can be applied to other apparatuses. For example, in an electronic money system, instead of a limited unlock key, limit information limiting the maximum amount of money that can be used may be generated and stored in a mobile terminal or an IC card.

### Other Embodiments

Hereinafter, other embodiments of the authentication system according to the present invention will be described.

The authentication system according to the present invention is characterized in that it operates using information that is stored in an IC card or the like and identification information of a mobile terminal that only the same user as the IC card is allowed to have. In other words, with the authentication system using two or more types of information for specifying the user, such as an IC card and a password, or a passbook and a registered seal, an opportunity of misuse by a third party is eliminated and also complexity of setting a seal, signing, inputting a password or the like by the user can be eliminated.

In the above sixth through eighth embodiments, the authentication system is applied for the electronic money system or the crediting system. However, the present invention is not limited to these examples.

It is also beneficial to utilize the authentication system in an entrance/exit control system.

In such a case, user identification information is recorded in the IC card, and a cyclic redundancy check code (CRC) of the user identification information is recorded in the mobile device.

First, the entrance/exit control system reads out user information from the IC card when the user holds the IC card over the system.

Also, the entrance/exit control system reads out the check code from the mobile device at the same time as reading out the user information or immediately after reading.

The entrance/exit control system checks whether the user identification information is a valid information (does not include an error) or not according to the check code.

The entrance/exit control system permits unlocking only when the user information is determined to be valid.

According to the above-described procedure, a system which allows only the user of the IC card and the mobile device can unlock can be realized.

Further, according to this system, unless the IC card and the mobile device are both in the hand of a third party at the same time, the unlocking by this third party is impossible.

Furthermore, by providing a database in the system, to which a plurality of users can be registered, the system which can be used only by the plurality of users who are registered can be provided.

Moreover, by providing means for confirming whether the user is carrying the IC card and the mobile terminal when going outside the gate, it becomes possible to prevent the user from forgetting to carry the IC card and the mobile terminal.

In all the above embodiments, ID information is obtained from two devices. However, it is also possible to combine ID information obtained from more devices to perform authentication.

### (First Additional Statement)

(Content of First Additional Statement)

### <Additional Statement 1>

An authentication system, characterized by including: a first device having a first inherent information which is inherent to each customer; a second device having a second inherent information which is inherent to each customer; a third device to which signals output from the first device and the second device are input; a fourth device to which signals processed by the third device are input; and a fifth device to which signals output from the fourth device are input, in which the fourth device performs authentication of the customer for the fifth device when the signal input from the third device matches a pre-stored signal.

### <Additional Statement 2>

The authentication system according to additional statement 1, characterized in that the first inherent information is encrypted with the second inherent information.

### <Additional Statement 3>

The authentication system according to additional statement 1, characterized in that the signal input from the first device to the third device includes a signal for identifying the second inherent information.

### <Additional Statement 4>

The authentication system according to additional statement 1, characterized in that the signal input from the first device to the third device includes address information of the fourth device.

### <Additional Statement 5>

The authentication system according to additional statement 1, characterized in that the signal input from the second device to the third device includes address information of the fourth device.

### <Additional Statement 6>

The authentication system according to additional statement 1, characterized in that the signal input from the third device to the fourth device includes address information of the fifth device.

### <Additional Statement 7>

The authentication system according to additional statement 1, characterized in that the signal input from the fourth device to the fifth device includes address information of an object to be billed.

### <Additional Statement 8>

The authentication system according to additional statement 1, characterized in that the third device checks, after it identifies the second inherent information, whether it has received the second inherent information transmitted by the second device.

### <Additional Statement 9>

The authentication system according to additional statement 1, characterized in that the third device performs authentication of the customer in a predetermined range for the fifth device by receiving the first inherent information.

### <Additional Statement 10>

The authentication system according to additional statement 1, characterized in that the first inherent information is transmitted upon an operation by the customer on the first device.

### <Additional Statement 11>

The authentication system according to additional statement 1, characterized in that the first inherent information is transmitted upon a request from the second device.

### <Additional Statement 12>

The authentication system according to additional statement 1, characterized in that the first inherent information is transmitted upon a request from the third device.

### <Additional Statement 13>

The authentication system according to additional statement 1, characterized in that the first inherent information is transmitted intermittently.

### <Additional Statement 14>

The authentication system according to additional statement 1, characterized in that the second inherent information is transmitted upon an operation by the customer on the second device.

### <Additional Statement 15>

The authentication system according to additional statement 1, characterized in that the second inherent information is transmitted upon a request from the first device.

### <Additional Statement 16>

The authentication system according to additional statement 1, characterized in that the second inherent information is transmitted upon a request from the third device.

### <Additional Statement 17>

The authentication system according to additional statement 1, characterized in that the second inherent information is transmitted intermittently.

### <Additional Statement 18>

The authentication system according to additional statement 1, characterized in that the third device can receive the first inherent information transmitted from a distance of a few meters or shorter.

### <Additional Statement 19>

The authentication system according to additional statement 1, characterized in that the third device can receive the second inherent information transmitted from a distance of a few meters or shorter.

### <Additional Statement 20>

The authentication system according to additional statement 1, characterized in that there are a plurality of devices which include the first inherent information other than the first device.

### <Additional Statement 21>

The authentication system according to additional statement 1, characterized in that transmission of the first inherent information is suspended by sending a predetermined signal to the first device.

### <Additional Statement 22>

The authentication system according to additional statement 1, characterized in that predetermined information of the first device is erased by sending a predetermined signal to the first device.

### <Additional Statement 23>

The authentication system according to additional statement 1, characterized in that predetermined information of the first device is transferred by sending a predetermined signal to the first device.

### <Additional Statement 24>

The authentication system according to additional statement 1, characterized in that transmission of the second inherent information is suspended by sending a predetermined signal to the second device.

### <Additional Statement 25>

The authentication system according to additional statement 1, characterized in that predetermined information of the second device is erased by sending a predetermined signal to the second device.

### <Additional Statement 26>

The authentication system according to additional statement 1, characterized in that predetermined information of the second device is transferred by sending a predetermined signal to the second device.

### <Additional Statement 27>

The authentication system according to additional statement 1, characterized in that authentication is not performed for the fifth device when a predetermined signal is sent to the fourth device.

### <Additional Statement 28>

The authentication system according to additional statement 1, characterized in that misuse of the second device is notified to the fifth device from the fourth device by sending a predetermined signal to the fourth device.

### <Additional Statement 29>

The authentication system according to any one of additional statements 21, 24, 27, and 28, characterized in that a predetermined code number is required for sending a predetermined signal to the first device, the second device, or the fourth device.

### <Additional Statement 30>

The authentication system according to additional statement 1, characterized in that authentication is not performed for the fifth device in a place other than a predetermined place.

### <Additional Statement 31>

The authentication system according to additional statement 1, characterized in that authentication is not performed for the fifth device in a time zone other than a predetermined time zone.

### <Additional Statement 32>

The authentication system according to additional statement 1, characterized in that the fifth device is included in the third device.

### <Additional Statement 33>

The authentication system according to additional statement 1, characterized in that the third device is included in the second device.

(Description of the First Additional Statement)

An object of the invention described in the first additional statement is to provide an authentication system which can enhance authentication, and reduce a risk in the case of losing or forgetting to carry a device having inherent information.

In order to achieve such an object, the authentication system of the present invention includes: a first device having a first inherent information which is inherent to each customer; a second device having a second inherent information which is inherent to each customer; a third device to which signals output from the first device and the second device are input; a fourth device to which signals processed by the third device are input; and a fifth device to which signals output from the fourth device are input, and in such an authentication system, the fourth device performs authentication of the customer for the fifth device when the signal input from the third device matches a pre-stored signal.

In order to achieve such an object, in the authentication system of the present invention, the first inherent information is encrypted with the second inherent information.

In order to achieve such an object, in the authentication system of the present invention, the signal input from the first device to the third device includes a signal for identifying the second inherent information.

In order to achieve such an object, in the authentication system of the present invention, the signal input from the first device to the third device includes address information of the fourth device.

In order to achieve such an object, in the authentication system of the present invention, the signal input from the second device to the third device includes address information of the fourth device.

In order to achieve such an object, in the authentication system of the present invention, the signal input from the third device to the fourth device includes address information of the fifth device.

In order to achieve such an object, in the authentication system of the present invention, the signal input from the fourth device to the fifth device includes address information of an object to be billed.

In order to achieve such an object, in the authentication system of the present invention, the third device checks, after it identifies the second inherent information, whether it has received the second inherent information transmitted by the second device.

In order to achieve such an object, in the authentication system of the present invention, the third device performs authentication of the customer in a predetermined range for the fifth device by receiving the first inherent information.

In order to achieve such an object, in the authentication system of the present invention, the first inherent information is transmitted upon an operation by the customer on the first device.

In order to achieve such an object, in the authentication system of the present invention, the first inherent information is transmitted upon a request from the second device.

In order to achieve such an object, in the authentication system of the present invention, the first inherent information is transmitted upon a request from the third device.

In order to achieve such an object, in the authentication system of the present invention, the first inherent information is transmitted intermittently.

In order to achieve such an object, in the authentication system of the present invention, the second inherent information is transmitted upon an operation by the customer on the second device.

In order to achieve such an object, in the authentication system of the present invention, the second inherent information is transmitted upon a request from the first device.

In order to achieve such an object, in the authentication system of the present invention, the second inherent information is transmitted upon a request from the third device.

In order to achieve such an object, in the authentication system of the present invention, the second inherent information is transmitted intermittently.

In order to achieve such an object, in the authentication system of the present invention, the third device can receive the first inherent information transmitted from a distance of a few meters or shorter.

In order to achieve such an object, in the authentication system of the present invention, the third device can receive the second inherent information transmitted from a distance of a few meters or shorter.

In order to achieve such an object, in the authentication system of the present invention, there are a plurality of devices which include the first inherent information other than the first device.

In order to achieve such an object, in the authentication system of the present invention, transmission of the first inherent information is suspended by sending a predetermined signal to the first device.

In order to achieve such an object, in the authentication system of the present invention, predetermined information of the first device is erased by sending a predetermined signal to the first device.

In order to achieve such an object, in the authentication system of the present invention, predetermined information of the first device is transferred by sending a predetermined signal to the first device.

In order to achieve such an object, in the authentication system of the present invention, transmission of the second inherent information is suspended by sending a predetermined signal to the second device.

In order to achieve such an object, in the authentication system of the present invention, predetermined information of the second device is erased by sending a predetermined signal to the second device.

In order to achieve such an object, in the authentication system of the present invention, predetermined information of the second device is transferred by sending a predetermined signal to the second device.

In order to achieve such an object, in the authentication system of the present invention, authentication is not performed for the fifth device when a predetermined signal is sent to the fourth device.

In order to achieve such an object, in the authentication system of the present invention, misuse of the second device is notified to the fifth device from the fourth device by sending a predetermined signal to the fourth device.

In order to achieve such an object, in the authentication system of the present invention, a predetermined code number is required for sending a predetermined signal to the first device, the second device, or the fourth device.

In order to achieve such an object, in the authentication system of the present invention, authentication is not performed for the fifth device in a place other than a predetermined place.

In order to achieve such an object, in the authentication system of the present invention, authentication is not performed for the fifth device in a time zone other than a predetermined time zone.

In order to achieve such an object, in the authentication system of the present invention, the fifth device is included in the third device.

In order to achieve such an object, in the authentication system of the present invention, the third device is included in the second device.

According to the authentication system of the present invention, enhancement of authentication in various events which require authentication, reducing of risks in the case where a device including inherent information is lost, and prevention of impairing convenience when the device including inherent information is forgotten to be carried can be realized.

### (Second Additional Statement)

(Content of Second Additional Statement)

### <Additional Statement 1>

An authentication system including:

an IC card having a communication unit with a reader/writer device, a mutual authentication unit with the reader/writer device, and a storage unit which stores first identification information which becomes accessible as a result of the mutual authentication unit;

a mobile device having a storage unit for storing second identification information and a communication unit with the reader/writer device;

a reader/writer having a first communication unit which detects an IC card which can communicate with and reads out the first identification information from the storage unit of the IC card after mutual authentication with the IC card, a second communication unit for reading out the second identification information from the mobile device, and a data conversion unit for extracting card information of the IC card by data conversion with the first identification information and the second identification information.

### <Additional Statement 2>

The authentication system according to additional statement 1, in which:

the card information is crediting information of a user; and

the reader/writer of the authentication system further includes a billing money information generating unit for generating billing money information to the user and a communication unit for sending the billing money information and the crediting information to a credit settlement server, the authentication system further includes

a credit settlement server having a database for managing card information for each user, a communication unit with the reader/writer, and a credit settlement unit based on the crediting information, the billing money information and the database.

### <Additional Statement 3>

The authentication system according to additional statement 1, in which:

the card information is electronic money information which the user can use;

the reader/writer of the authentication system further includes an input unit for inputting billing information or additional money information, an electronic money update unit for updating the electronic money information based on at least the billing information or the additional money information, a reverse data conversion unit for processing the electronic money information with reverse data conversion of the data conversion; and

the electronic money information processed with the reverse data conversion is recorded to update the storage unit of the IC card through the first communication unit.

### <Additional Statement 4>

The authentication system according to any one of additional statements 1 through 3, in which at least the first communication unit of the first communication unit and the second communication unit has a key exchange unit for sharing an encryption and decryption key between the two devices which communicate each other, and is an encryption data communication unit using the encryption and decryption key.

### <Additional Statement 5>

The authentication system according to any one of additional statements 1 through 3, in which:

the data conversion is decrypting conversion of encrypted information; and

the card information is previously encrypted with the second identification information to generate the first identification information, and is stored in the storage unit of the IC card.

### <Additional Statement 6>

The authentication system according to any one of additional statements 1 through 3, in which the reader/writer is implemented in the mobile device.

### <Additional Statement 7>

An authentication device, including

a first communication unit which detects an IC card to perform mutual authentication, and reads out a first identification information from the storage unit of the IC card;

a second communication unit for reading out a second identification information stored in a mobile device; and

a data conversion unit for extracting card information stored in the IC card by data conversion with the first identification information and the second identification information.

### <Additional Statement 8>

An IC card including a communication unit which responds to a call from a reader/writer and establishes communication with the reader/writer and a storage unit which becomes accessible after mutual authentication with the reader/writer, in which:

the storage unit includes encrypted card information recorded thereon; and

key information for the encryption is identification information stored in a device different from the IC card.

### <Additional Statement 9>

A mobile device including:

an input unit for allowing a user to input numerical and text information;

a display unit for the user;

a communication unit with a reader/writer; and

a storage unit which stores key information for decrypting or encrypting card information stored in an IC card.

### <Additional Statement 10>

An authentication device including:

a first communication unit which detects an IC card to perform mutual authentication, and reads out first identification information from a storage unit of the IC card;

a storage unit which stores second identification information; and

a data conversion unit for extracting card information stored in the IC card by data conversion with the first identification information and the second identification information.

### <Additional Statement 11>

A personal authentication method, including the steps of:

reading out first identification information stored in an IC card:

reading out second identification information stored in a mobile device;

extracting personal information of a user by a data conversion with the first identification information and the second identification information; and

completing personal authentication of the user by confirming validity of the personal information.

### <Additional Statement 12>

The personal authentication method according to additional statement 11, in which the data conversion is encryption deciphering conversion for deciphering cipher of the first identification information by using the second identification information as a key.

### (Description of Second Additional Statement)

An object of the present invention described in the second additional statement is to provide an authentication system and authentication device which does not require complicated input of a password or the like by a user, and can prevent misuse by a third party even when a card is lost or stolen.

An object of the present invention is to provide a settlement system utilizing the above-described authentication with the authentication system which can authenticate a user without input of a password or the like. Means for solving this is described.

An authentication system of the present invention includes: an IC card having a communication unit with a reader/writer device, a mutual authentication unit with the reader/writer device, and a storage unit which stores a first identification information which becomes accessible as a result of the mutual authentication unit; a mobile device having a storage unit for storing a second identification information and a communication unit with the reader/writer device; a reader/writer having a searching unit for searching a communicable IC card, a mutual authentication unit with the IC card found by the searching unit, a first communication unit for reading out the first identification information from the storage unit of the IC card after the mutual authentication, a second communication unit for reading out the second identification information from the mobile device, and a data conversion unit for extracting card information of a user of the IC card or the mobile terminal by data conversion with the first identification information and the second identification information.

Further, the authentication system of the present invention is characterized in that: the card information is crediting information of a user; the authentication system further includes a credit settlement server having a database for managing card information for each user, a communication unit with the reader/writer, and credit settlement unit which obtains the crediting information and the billing money information of the user from the reader/writer and at least based on the crediting information, the billing amount information and the database; and the reader/writer of the authentication system further includes a billing money information generating unit for generating billing money information to the user and a communication unit for sending the billing money information and the person specifying information to a credit settlement server.

The authentication system of the present invention is characterized in that: the card information is electronic money information which the user can use; the reader/writer of the authentication system further includes an input unit for inputting billing information or additional money information, an electronic money update unit for updating the electronic money information obtained from the IC card based on at least one of the billing information and additional money information, and a reverse data conversion unit for processing the updated electronic money information with reverse data conversion of the data conversion; and the updated electronic money information processed with the reverse data conversion is recorded to update the storage unit of the IC card through the first communication unit.

The authentication system of the present invention is characterized in that at least one of the first communication unit and the second communication unit has a key exchange unit for sharing an encryption and decryption key between the two devices which communicate each other, and is an encryption data communication unit using the encryption and decryption key.

The authentication system of the present invention is characterized in that: the data conversion is decrypting conversion of encrypted information; and the card information is previously encrypted with the second identification information to generate the first identification information, and is stored in the storage unit of the IC card.

The authentication system of the present invention is characterized in that the reader/writer is implemented in the mobile device.

Furthermore, the authentication device of the present invention, which is comprised of a reader and a writer, includes: a searching unit for searching an IC card which enables communication, a mutual authentication unit with the IC card found by the searching unit, a first communication unit which reads out a first identification information from the storage unit of the IC card after the mutual authentication; a second communication unit for reading out a second identification information from a mobile device; and a data conversion unit for extracting card information of a user of the IC card or the mobile terminal by data conversion with the first identification information and the second identification information.

The IC card of the present invention includes a communication unit with a reader/writer, mutual authentication unit with the reader/writer, and a storage unit which becomes accessible after the mutual authentication with the reader/writer, and is characterized in that the storage unit includes encrypted card information recorded thereon, and key information for encryption is information stored in a device different from the IC card.

The mobile device according to the present invention is characterized by including: a communication unit with the reader/writer; an input unit from a user; a display unit for the user; and a storage unit which stores key information for decrypting or encrypting card information stored in an IC card.

According to the present invention, both the first identification information in the IC card and the second identification information stored in the mobile terminal are read out by the reader/writer, and card information of a user using the IC card is extracted by data conversion of the first identification information and the second identification information. Thus, unless the IC card and the mobile terminal are both in the hand of a third party at the same time, they are not misused. This provides the safety of a level similar to that in a conventional bank depositing system, in which the account is confirmed by a passbook, and user identification is performed by a registered seal, to a transaction of electronic data.

Since the card information of the user is extracted from the first identification information and the second identification information, the user does not have to perform a complicated password input operation.

According to the present invention, by employing a database for managing card information for each user, a communication unit of the IC card with the reader/writer, a mutual authentication unit with the reader/writer, and the billing server which performs settlement in accordance with the billing money information from the reader/writer, it becomes possible to use the card information extracted from the first identification information and the second identification information as the crediting information and/or account information. Thus, the complexity of the password input or the like by the user can be avoided with the convenience of conventional credit cards and debit card being maintained. Also, misuse in the case where the IC card in the hand of a third party can be prevented.

By utilizing the card information extracted from the first identification information and the second identification information of the authentication system according to the present invention as electronic money information which the user has, a threat of misuse by a third party can be averted without impairing convenience of conventional charging-type electronic money.

If the card information extracted from the first identification information and the second identification information of the authentication system according to the present invention is used as entrance/exit control information, the present invention can be applied to an entrance/exit control system which permits only entrance and exit of users who are previously registered, and can refuse entrance and exit of a third party who is inappropriately using the IC card of the registered user.

In the entrance/exit control system, entrance and exit are controlled by the IC card storing the first identification information and the mobile terminal storing the second identification information. Thus, when the registered user exits the gate, it is confirmed whether the user is carrying the IC card and the mobile terminal. If the user does not carry them, an alarm is output in order to ensure that the valid registered user can enter and exit the gate.

By applying the present invention to a digital information recording system in which digital information is encrypted with the card information extracted from the first identification information and the second identification information of the authentication system according to the present invention for recording, confidential digital information recording which is permitted to only the user becomes possible.

By applying the present invention to a digital information reproducing system in which digital information is decrypted with the card information extracted from the first identification information and the second identification information of the authentication system according to the present invention for reproducing, confidential digital information reproduction which is permitted to only the user becomes possible.

The first identification information of the authentication system according to the present invention is characterized in that the card information is previously encrypted with the second identification information and is stored in the IC card. In this way, the card information is extracted only when both of the first identification information and the second identification information can be obtained surely.

In the authentication system according to the present invention, the first identification information is card information, and the second identification information is a checking code for the first identification information. In this way, the card information is extracted only when that both the first identification information and the second identification information can be obtained surely.

The reader/writer which communicates with the IC card of the authentication system according to the present invention in a contact/non-contact manner is characterized by being implemented in the mobile terminal. With such a structure, for example, for charging electronic money of a charging type as described above, the card information extracted from the first identification information and the second identification information is sent to the settlement server. The settlement server performs authentication of a user and a withdrawal process for the charged money from the account of the user, and updates the electronic money information in the IC card. In this way, the user can charge electronic money to own IC card in any place without restriction on a place.

As described above, the authentication system according to the present invention realizes the safety, which has been conventionally achieved by a combination of a passbook and a registered seal, in electronic personal authentication, and can be used for safe electronic money, entrance/exit control, digital information recording, or the like.

In the present embodiment, as an example of the device having the inherent information, the mobile phone has been described. However, it may be other types of devices as long as it has predetermined functions.

### INDUSTRIAL APPLICABILITY

The authentication system of the present invention is useful for performing personal authentication in electronic settlement and the like. Further, according to the authentication system, the authentication device, the IC card and the mobile device of the present invention, electronic money information or crediting information which allows use by only users can be recorded with an IC card and a mobile device which only the users are permitted to have.

### BRIEF DESCRIPTION OF THE DRAWINGS

FIG. 1 is a diagram of an authentication system of the first embodiment.

FIG. 2 is a diagram showing a structure of an authentication system as a variation of the first embodiment.

FIG. 3 is a diagram showing a structure of an authentication system of the second embodiment.

FIG. 4 is a diagram showing a structure of an authentication system as a variation of the second embodiment.

FIG. 5 is a diagram showing a structure of an authentication system of the third embodiment.

FIG. 6 is a diagram showing a structure of an authentication system of the third embodiment.

FIG. 7 a diagram showing a structure of an authentication system as a variation of the third embodiment.

FIG. 8 is a diagram showing a structure of an authentication system of the fourth embodiment.

FIG. 9 is a diagram showing a structure of an authentication system as a variation of the fourth embodiment.

FIG. 10 is a diagram showing a structure of an authentication system of the fifth embodiment.

FIG. 11 is diagram showing a structure of an authentication system of the fifth embodiment.

FIG. 12 is a diagram showing a structure of an authentication system as a variation of the fifth embodiment.

FIG. 13 is a block diagram of an authentication system of the sixth embodiment.

FIG. 14 is a diagram showing a flow of a process showing card capture and key exchange processing.

FIG. 15 is a diagram showing a mutual authentication process between a card and a reader/writer.

FIG. 16 is a diagram showing an electronic money information update procedure according to the sixth embodiment.

FIG. 17 is a block diagram of an authentication system of the seventh embodiment.

FIG. 18 is a block diagram of an authentication system of the eighth embodiment.

FIG. 19 is a block diagram of an information recording apparatus of the ninth embodiment.

FIG. 20 is a flow diagram showing an authentication process for recording content.

FIG. 21 is a flow diagram showing an authentication process for reproducing content.

FIG. 22 is a flow diagram showing an authentication process as a variation.

FIG. 23 is a diagram illustrating a structure of authentication information.

FIG. 24 is a flow diagram showing an authentication process for reproducing content.

FIG. 25 is a flow diagram showing an authentication process for recording content.

FIG. 26 is a flow diagram showing an authentication process for using content.

FIG. 27 is a block diagram of an information recording apparatus as a variation.

FIG. 28 is a diagram showing a structure of ID management information.

FIG. 29 is a flow diagram illustrating an authentication process for using content.

FIG. 30 is a diagram illustrating a structure of authentication information.

FIG. 31 is a diagram illustrating a physical configuration of a recording medium of the tenth embodiment.

FIG. 32 is a diagram illustrating the relationship between the physical configuration and data of the recording medium of the tenth embodiment.

FIG. 33 is a block diagram showing a structure of a shop device of the tenth embodiment.

FIG. 34 is a flow diagram showing an operation of the shop device of the tenth embodiment.

FIG. 35 is a block diagram showing a structure of a user device of the tenth embodiment.

FIG. 36 is a flow diagram showing an operation of the user device of the tenth embodiment.

FIG. 37 is a block diagram showing a structure of a shop device of a variation of the tenth embodiment.

FIG. 38 is a flow diagram showing an operation of the shop device of the variation of the tenth embodiment.

FIG. 39 is a block diagram showing a structure of a user device of a variation of the tenth embodiment.

FIG. 40 is a flow diagram showing an operation of the user device of the variation of the tenth embodiment.

FIG. 41 is a block diagram showing a structure of an authentication system of the eleventh embodiment.

FIG. 42 is a flow diagram showing an operation of the authentication system of the eleventh embodiment.

FIG. 43 is a block diagram showing a structure of an authentication system of the eleventh embodiment.

FIG. 44 is a flow diagram showing an operation of the authentication system of the eleventh embodiment.

FIG. 45 is a diagram of an authentication system in a twelfth embodiment.

FIG. 46 is a diagram of a right granting apparatus in the authentication system in the twelfth embodiment.

FIG. 47 is a flowchart illustrating a part of the process of the right granting apparatus.

FIG. 48 is a flowchart illustrating a part of the process of the right granting apparatus.

FIG. 49 is a flowchart illustrating a part of the process of the right granting apparatus.

FIG. 50 is a diagram of a mobile terminal in the authentication system in the twelfth embodiment.

FIG. 51 is a diagram of a transmitter in the authentication system in the twelfth embodiment.

FIG. 52 is a flowchart illustrating the operation of the authentication system in the twelfth embodiment.

FIG. 53 is a diagram of an authentication system in a thirteenth embodiment.

FIG. 54 is a diagram of an unlock key lending apparatus in the authentication system in the thirteenth embodiment.

FIG. 55 is a flowchart illustrating the operation of the authentication system in the thirteenth embodiment.

FIG. 56 is a diagram of an authentication system in a conventional example.

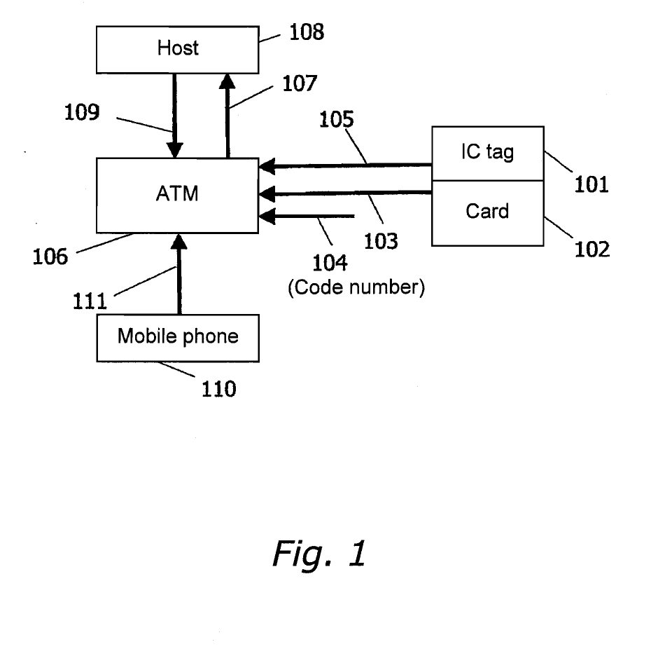

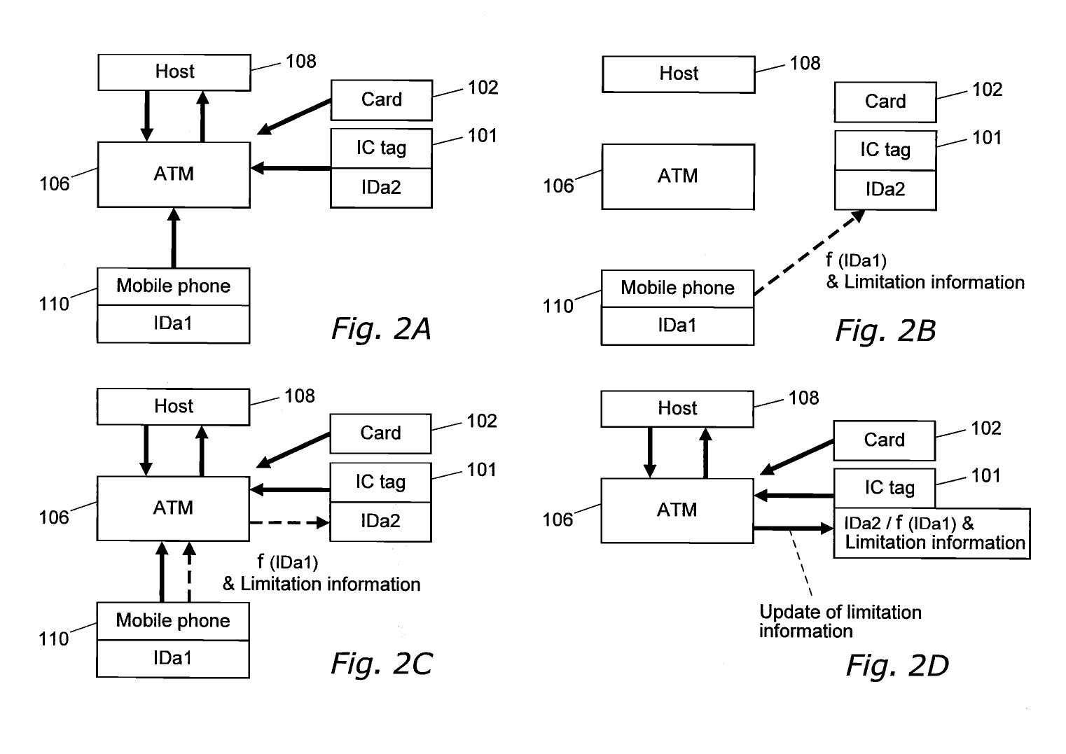

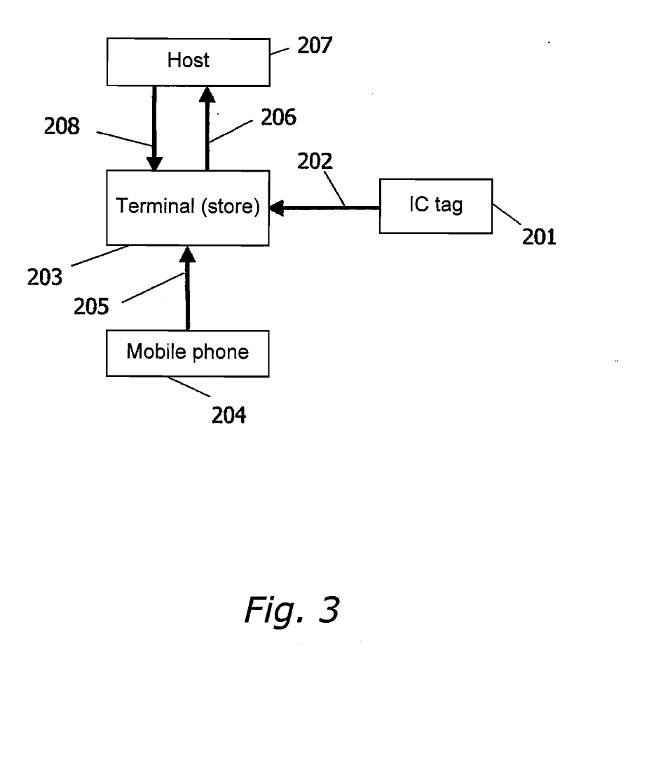

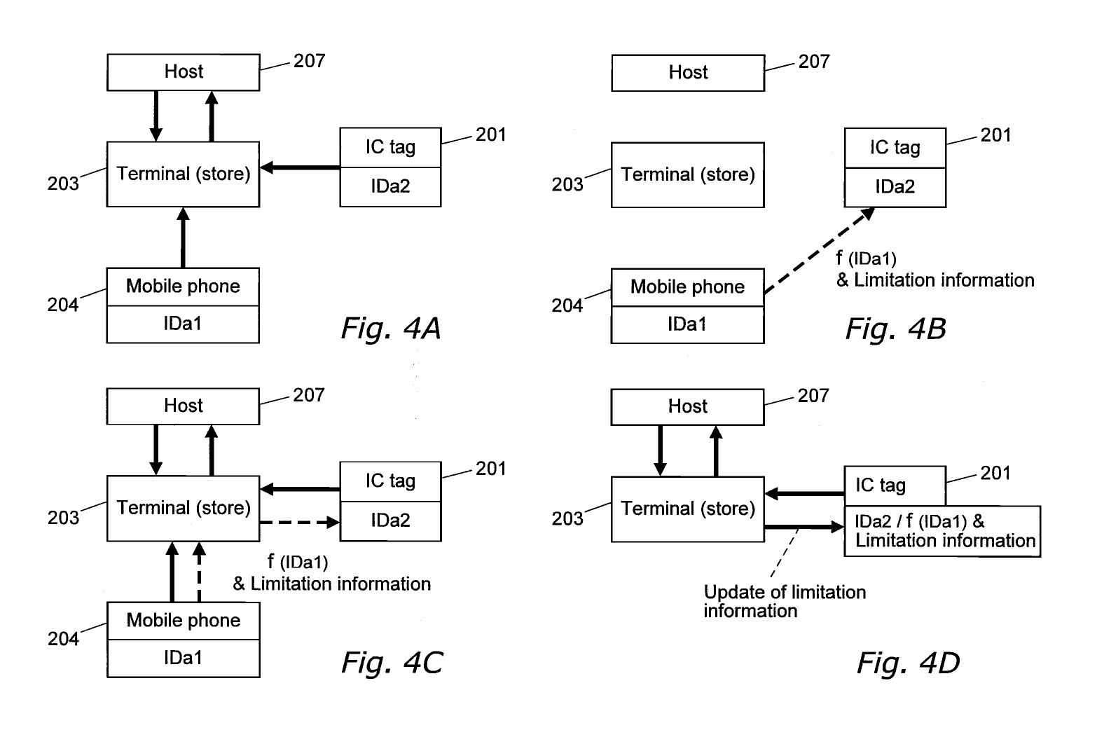

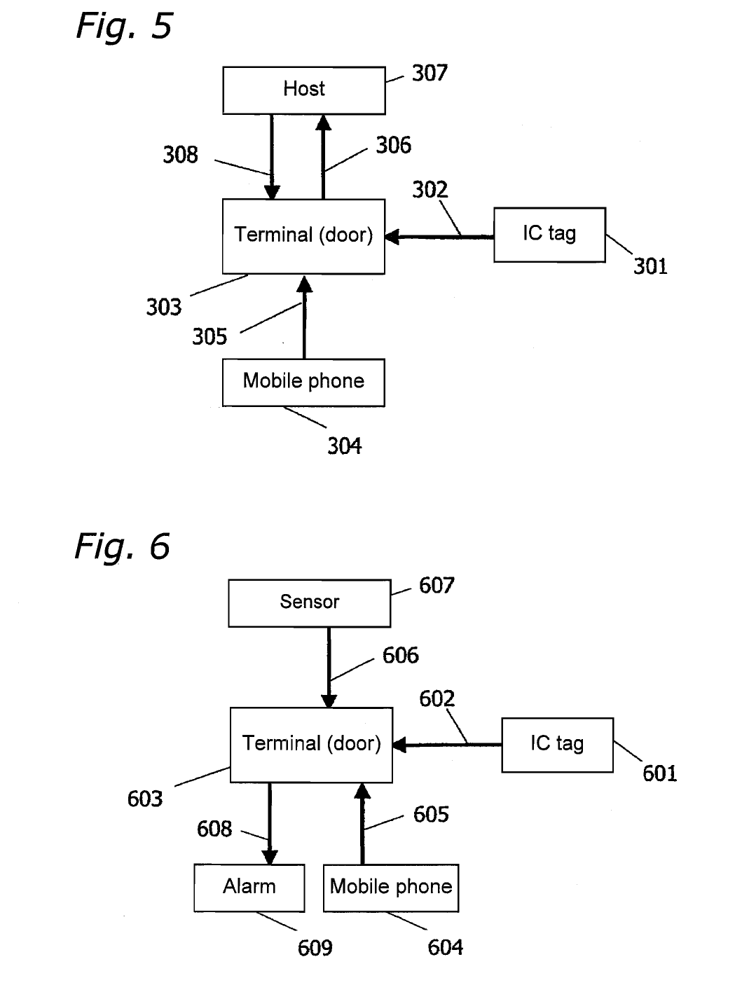

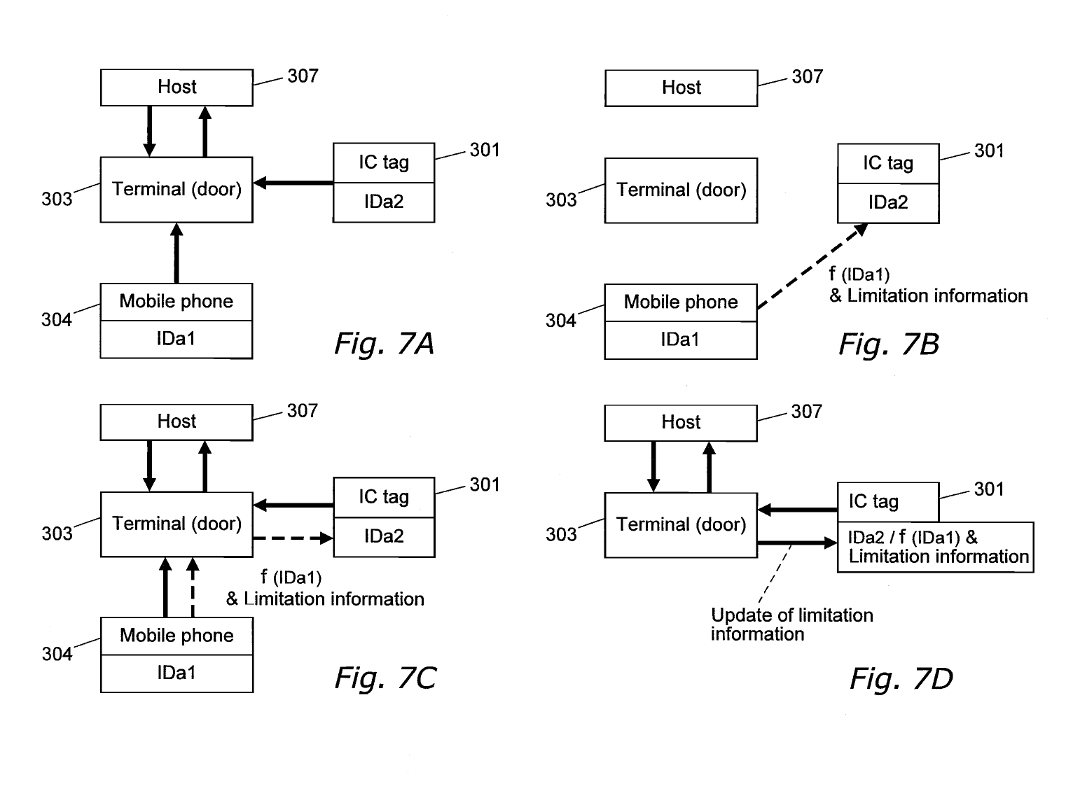

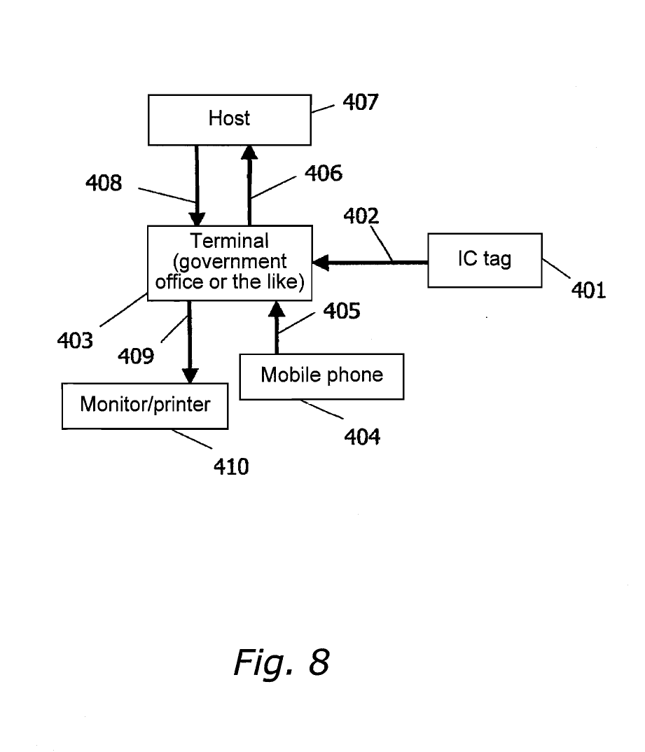

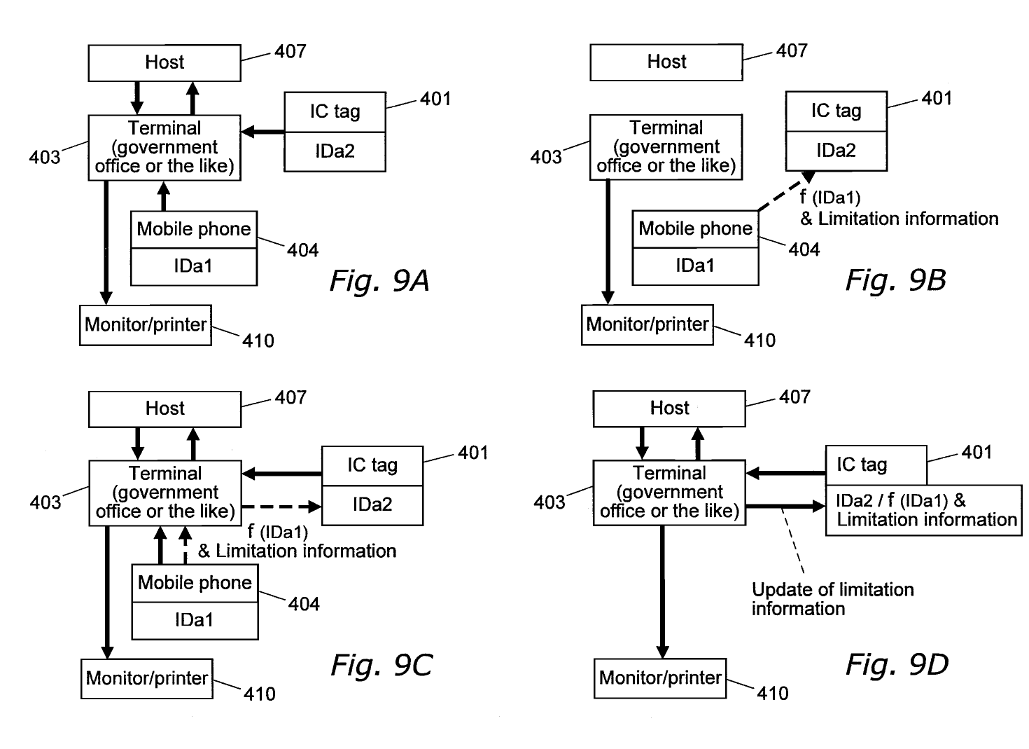

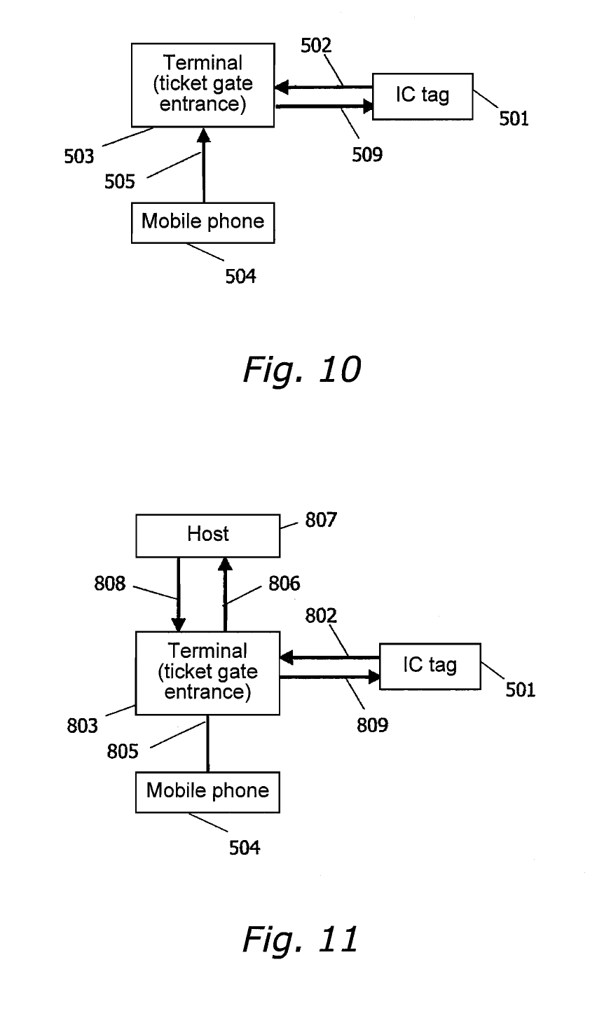

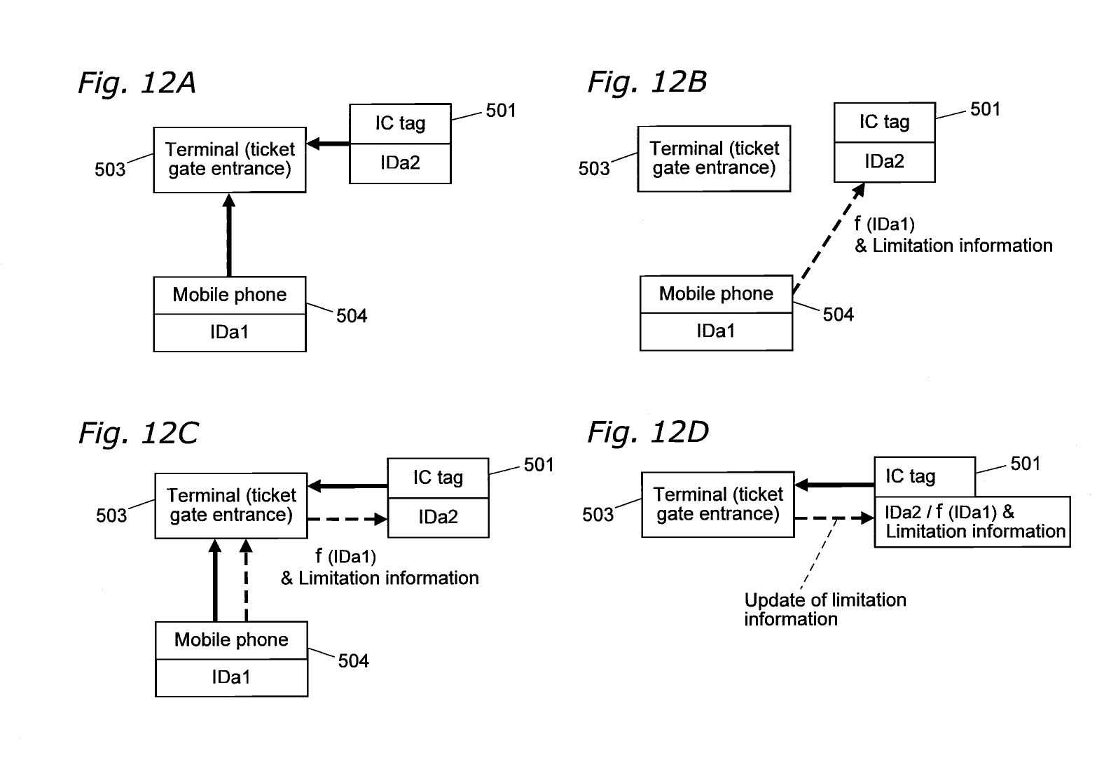

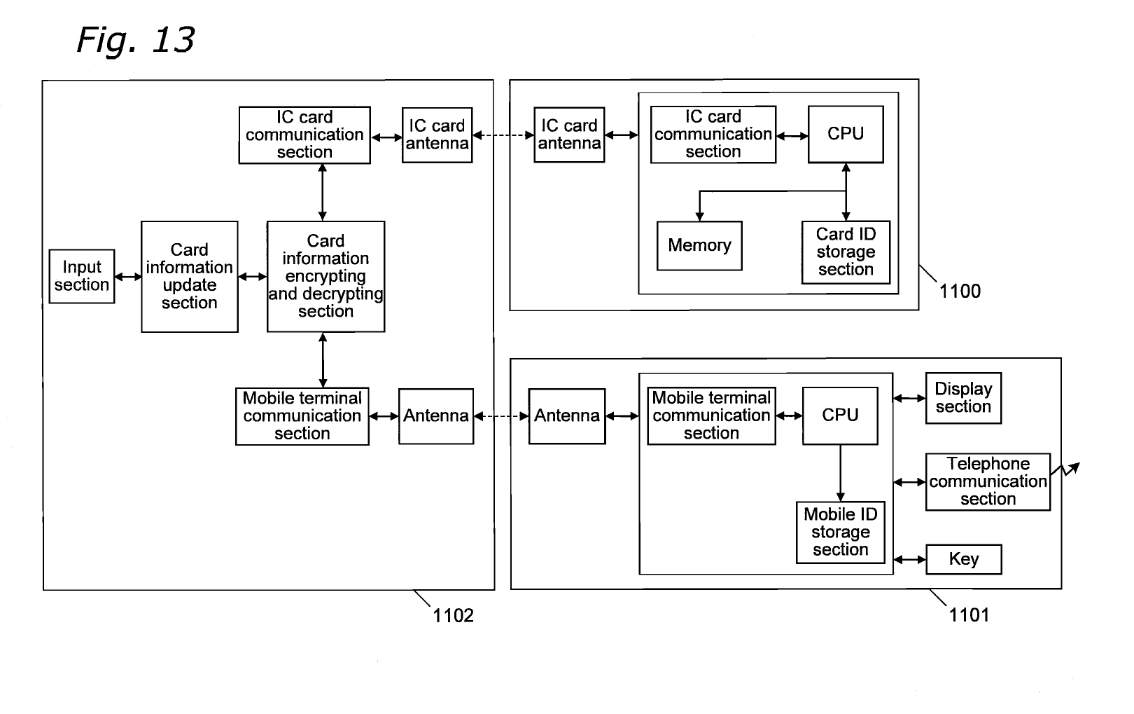

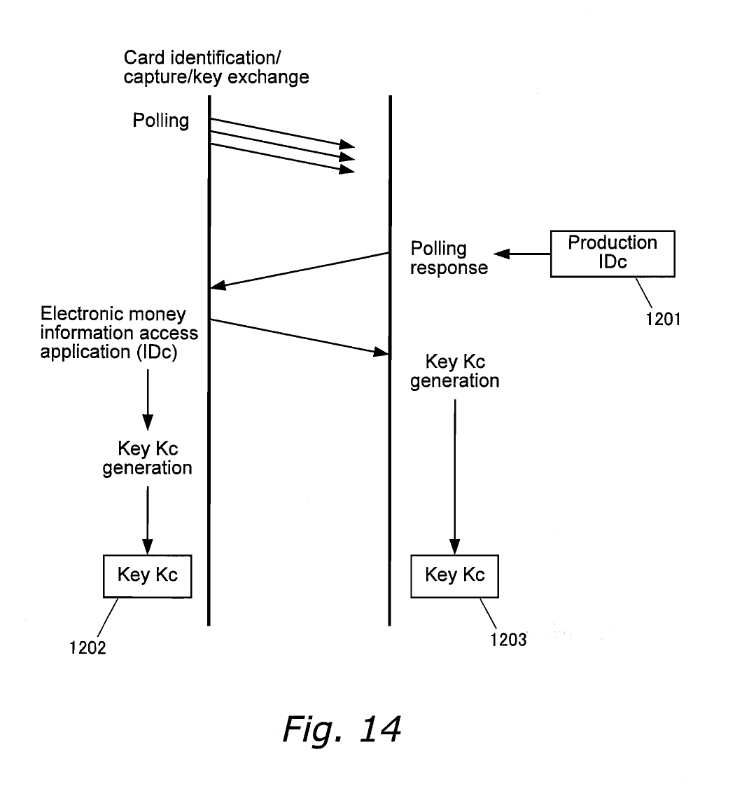

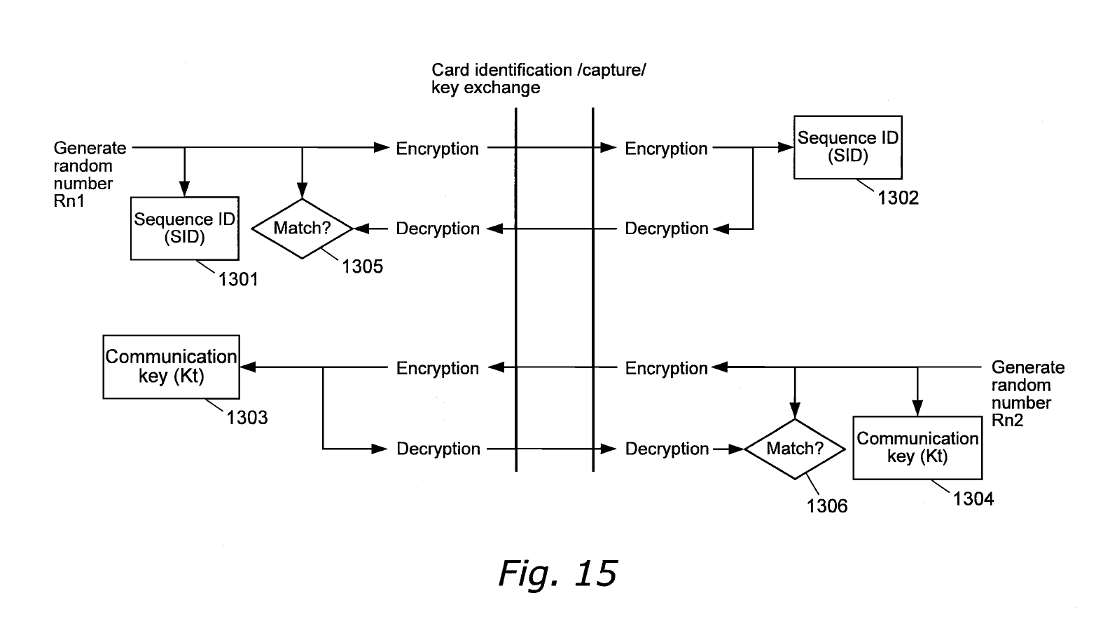

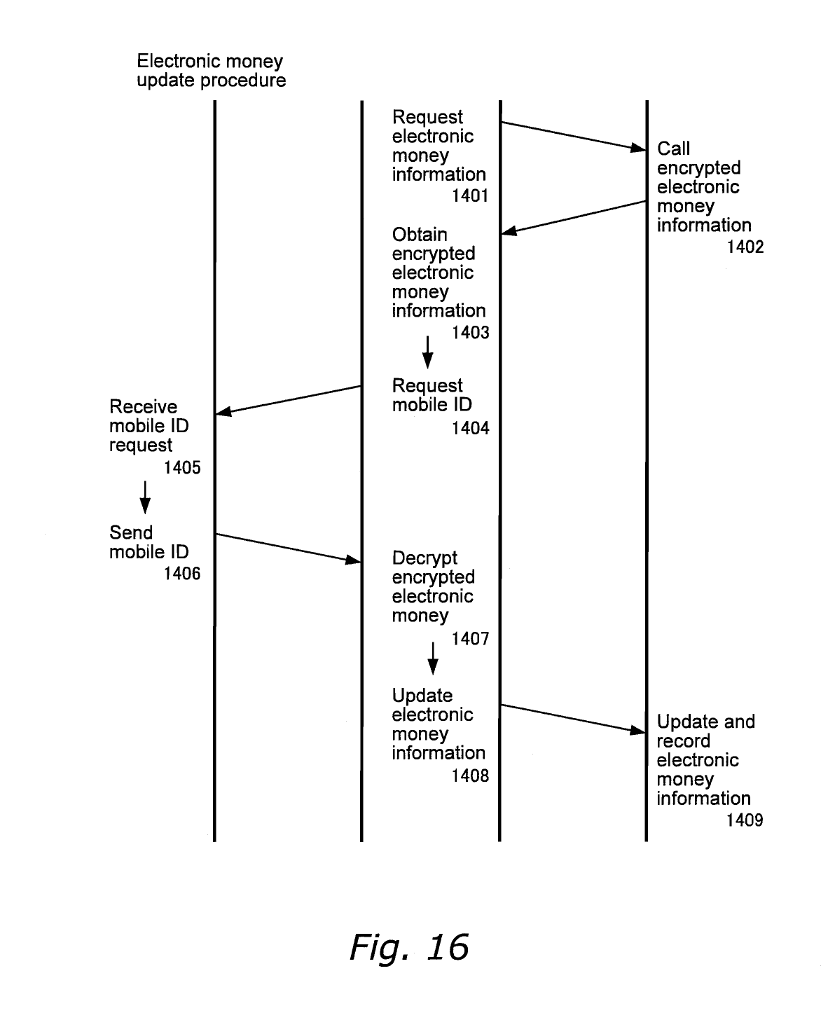

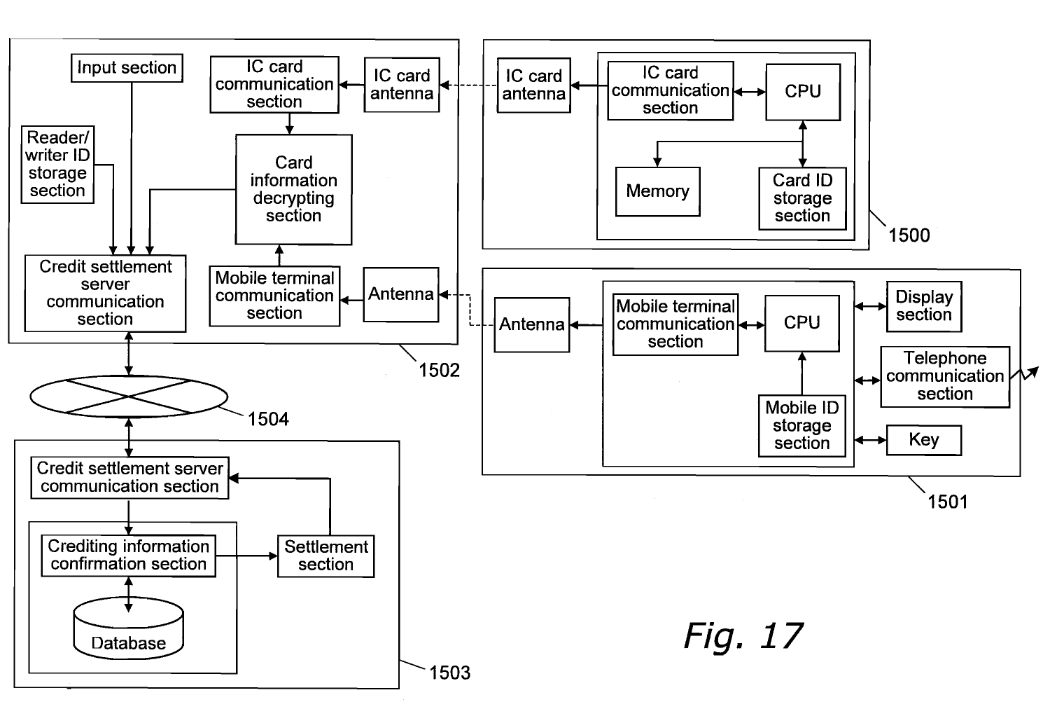

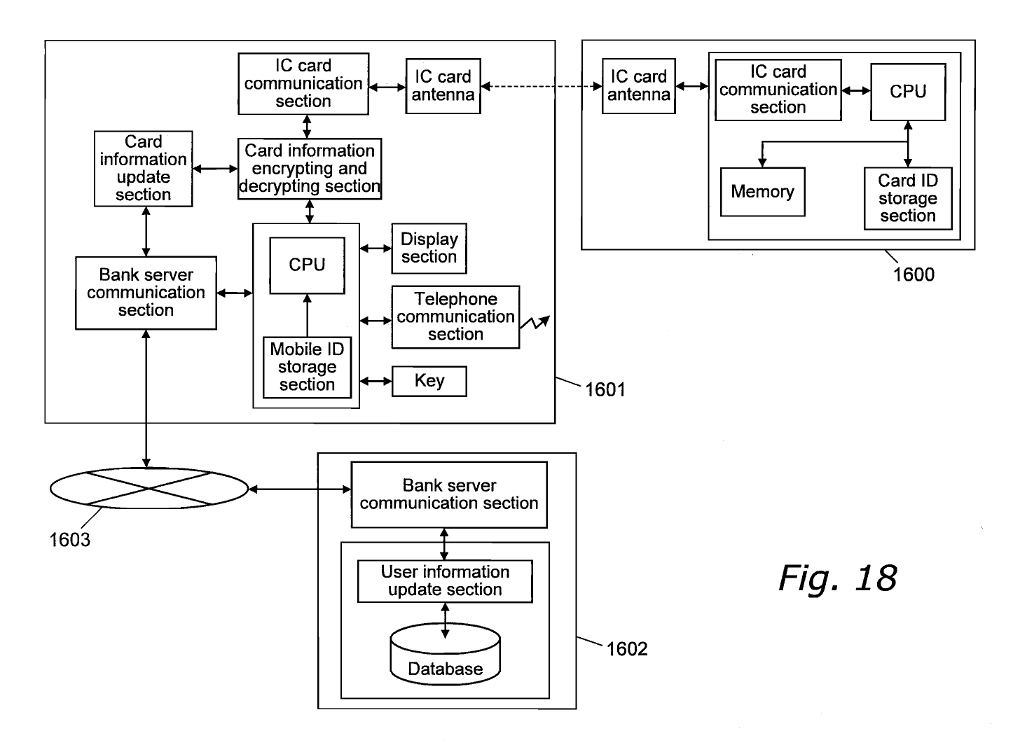

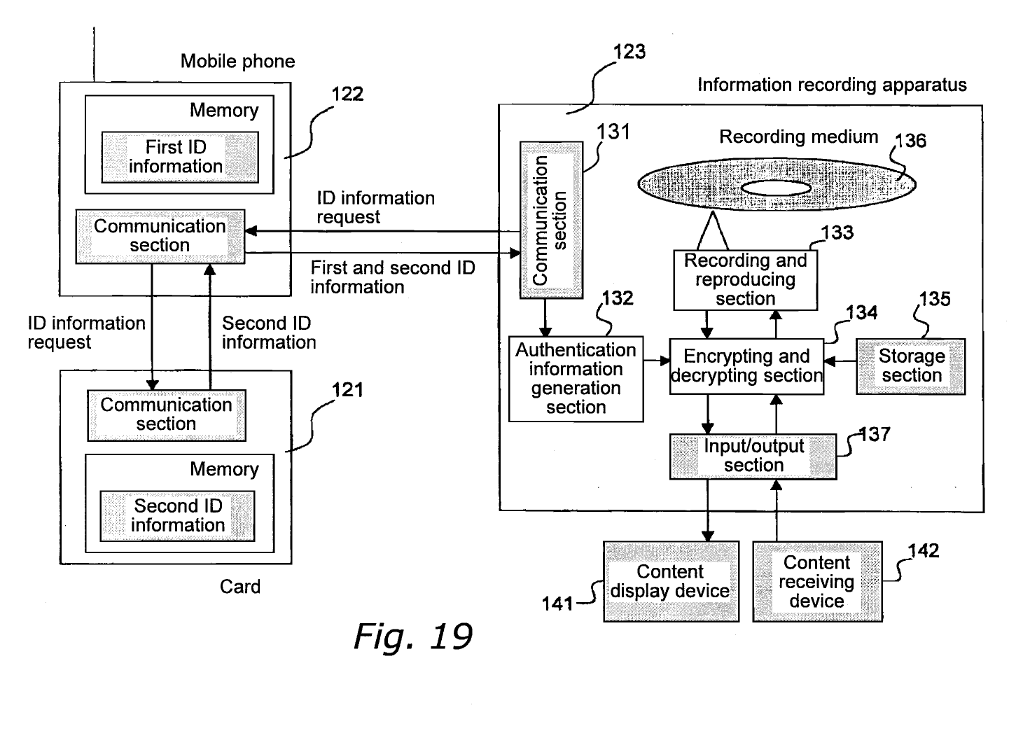

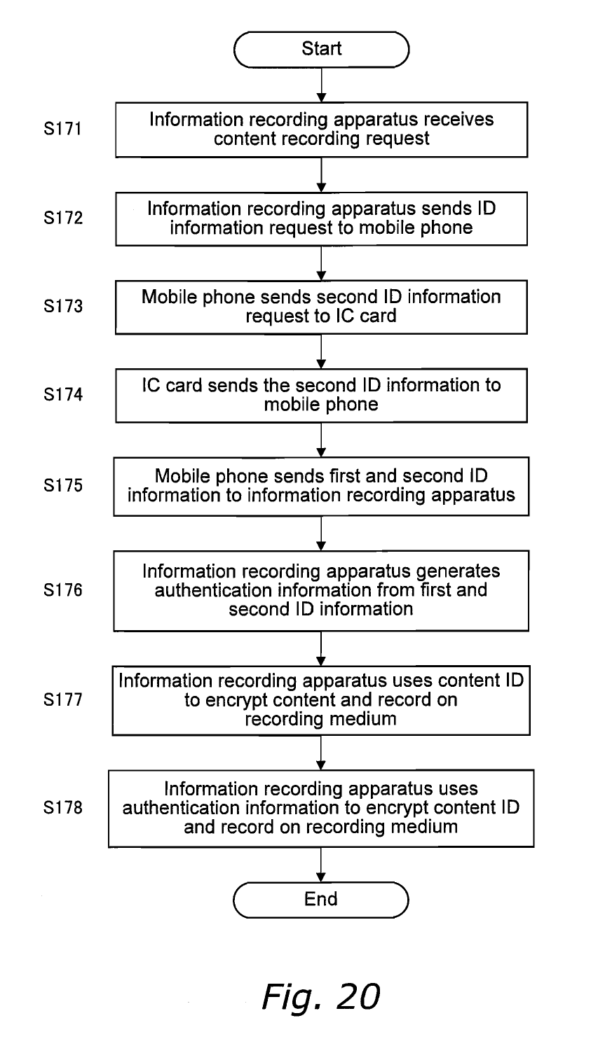

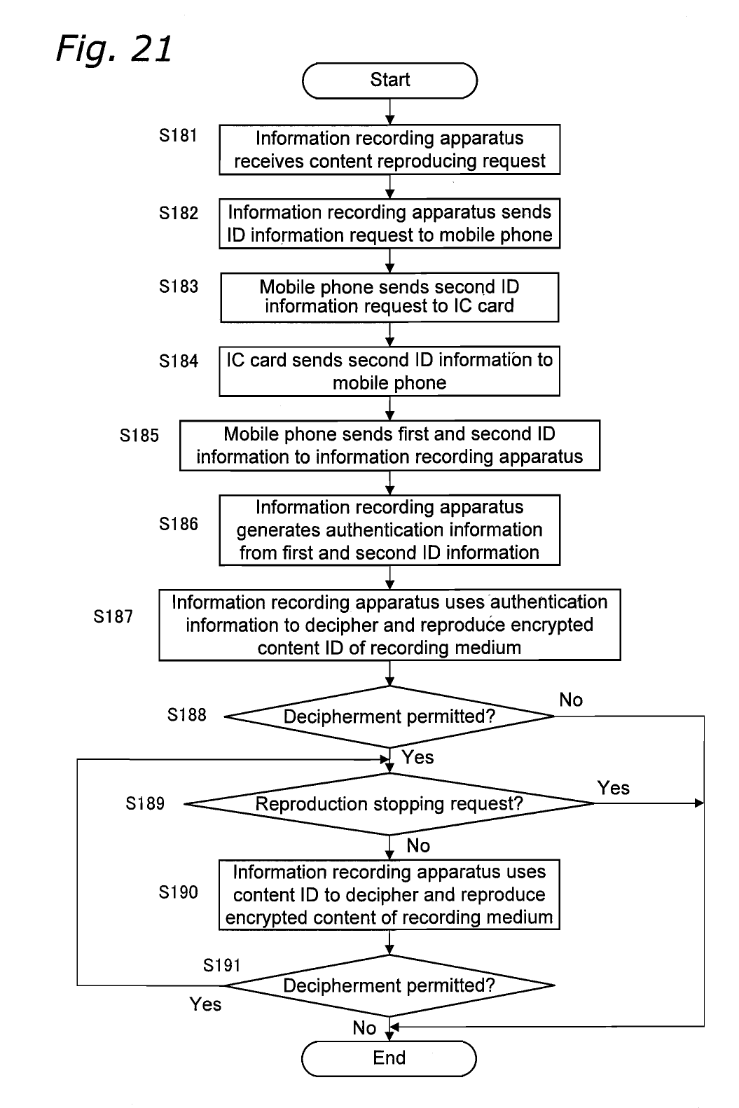

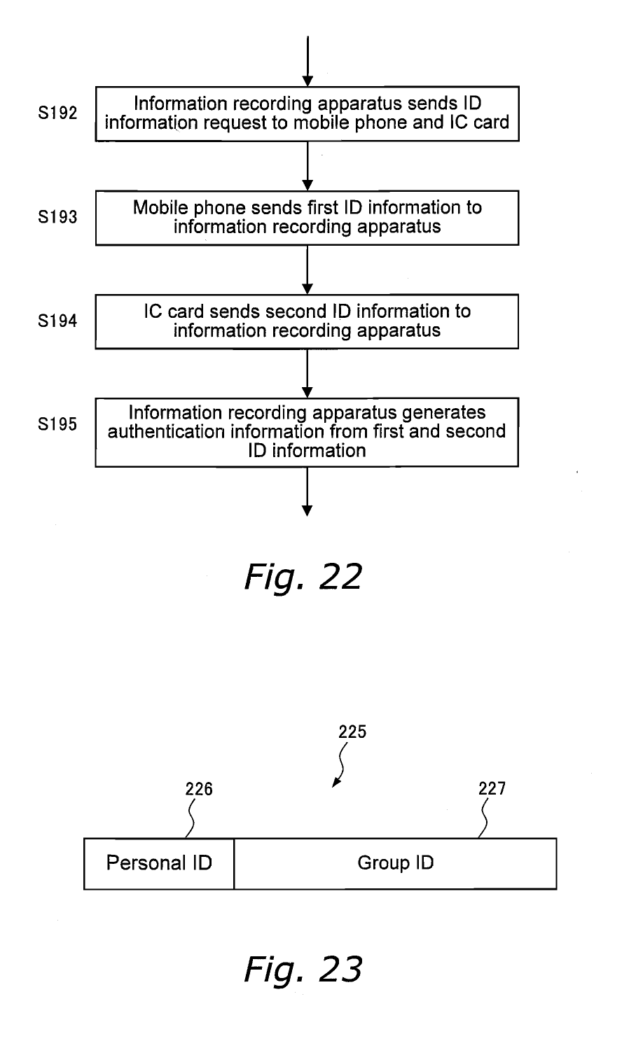

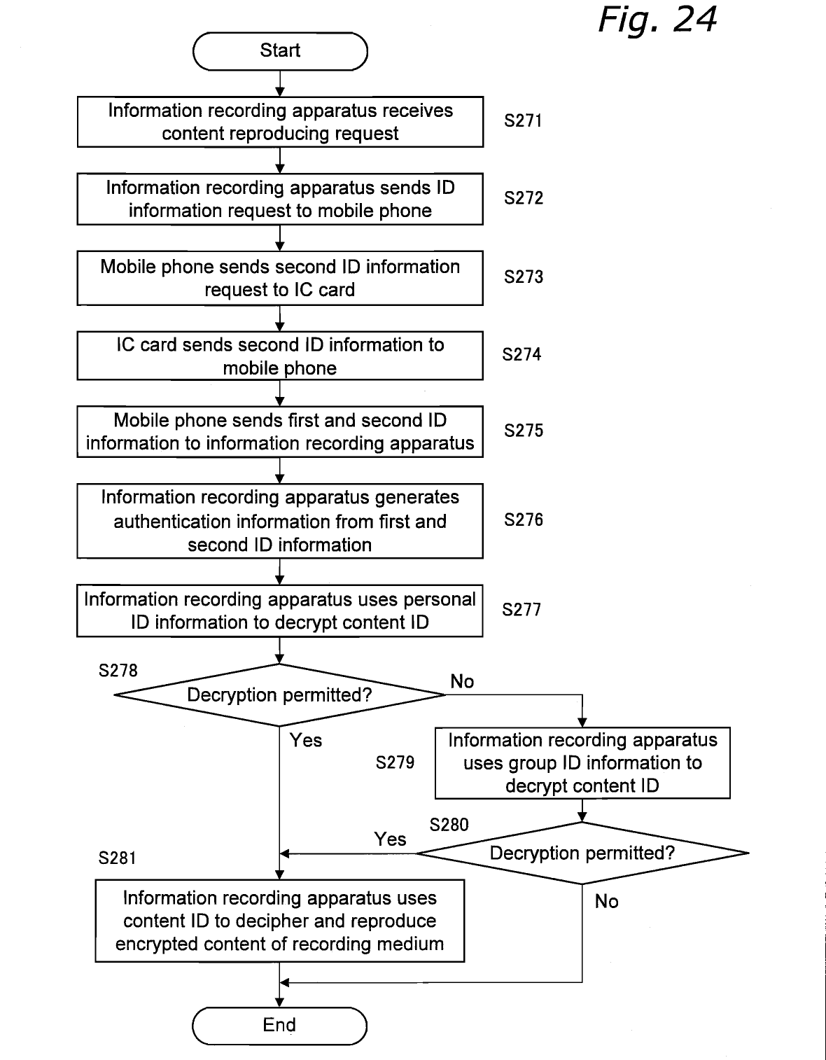

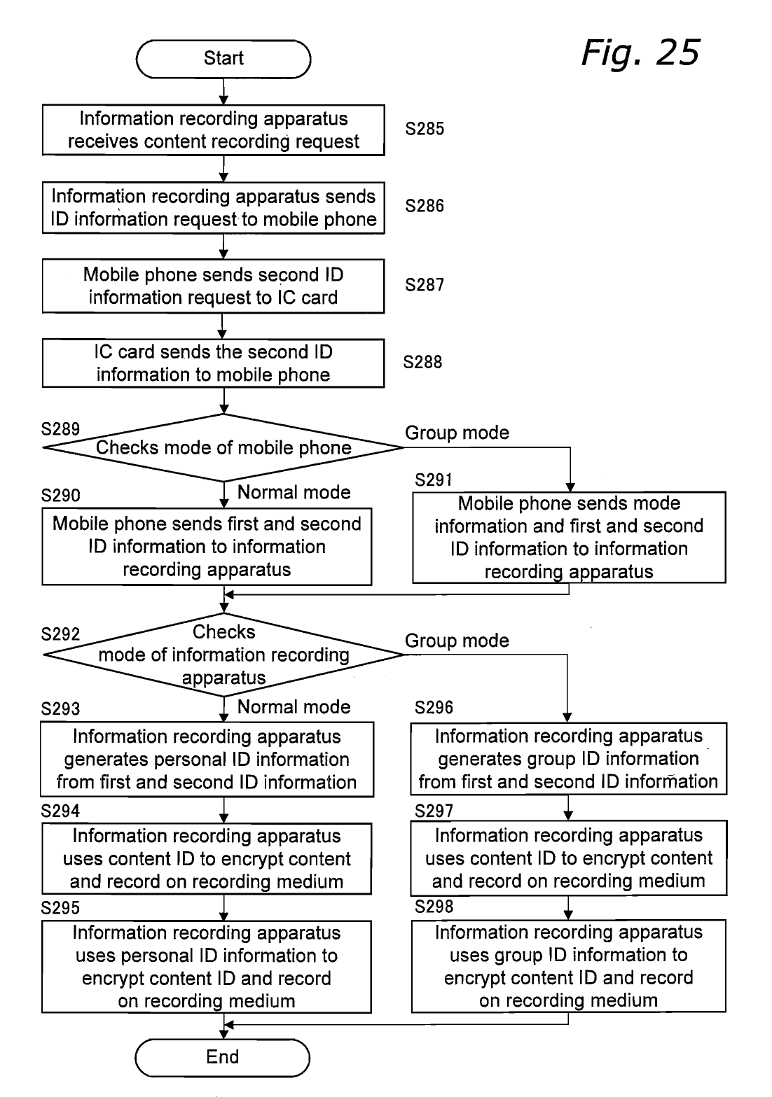

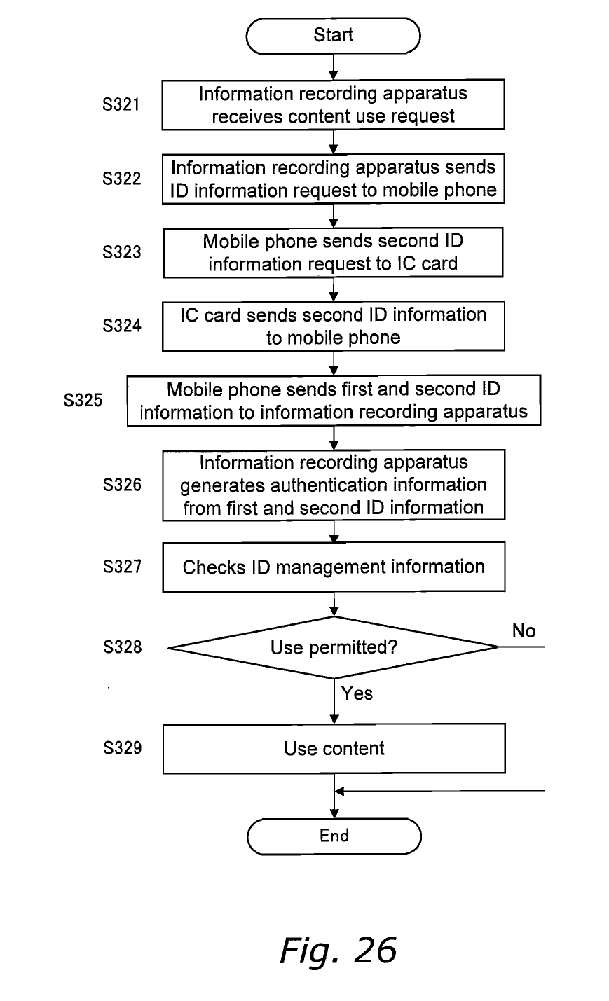

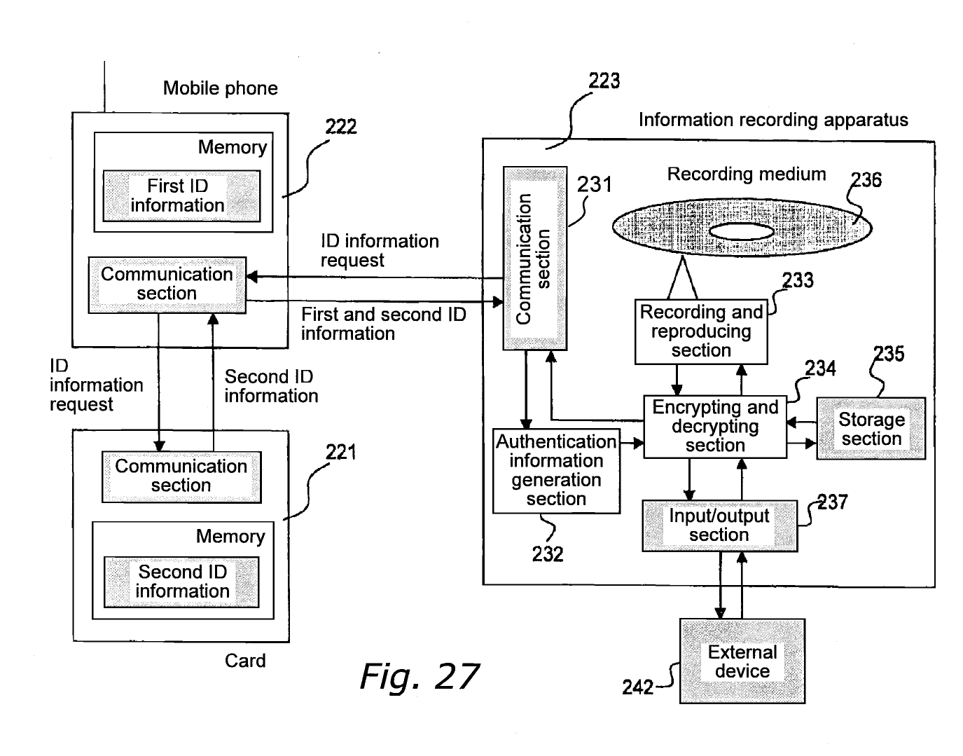

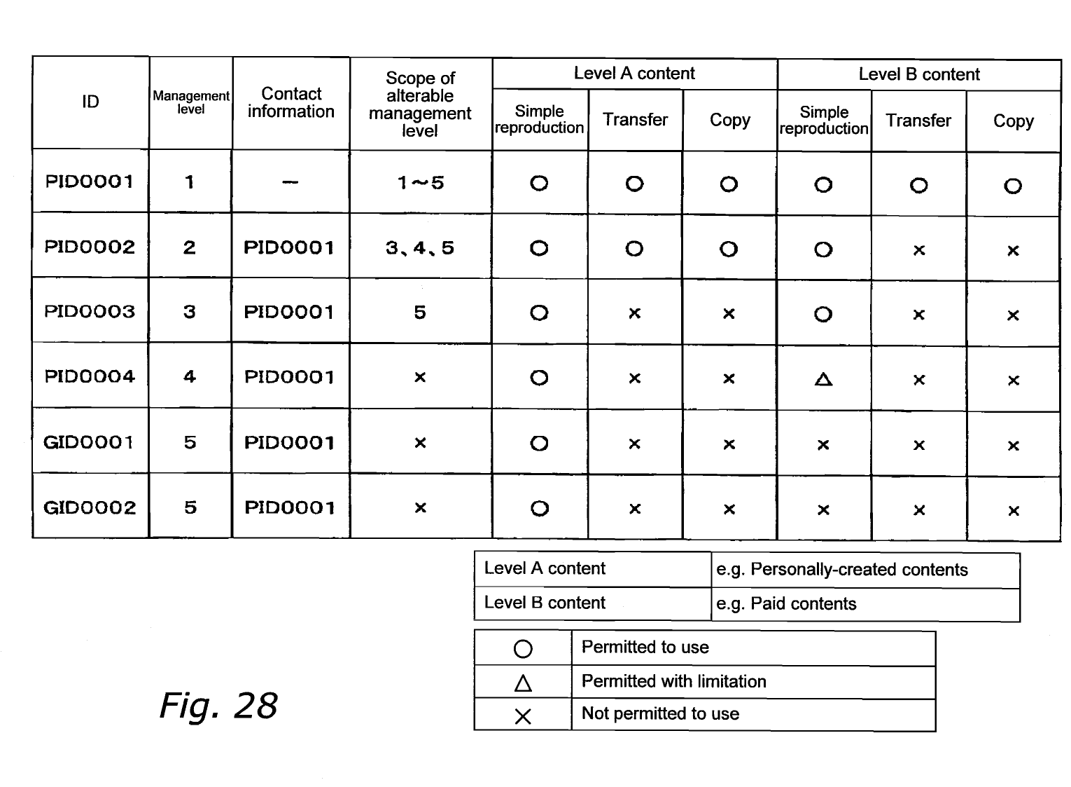

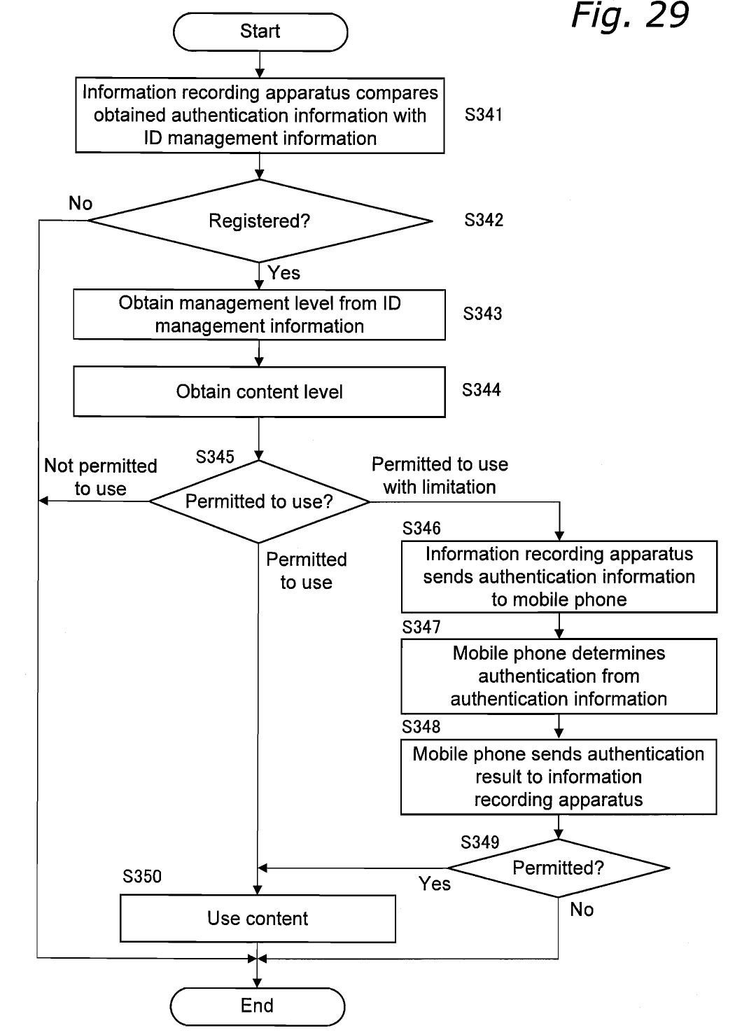

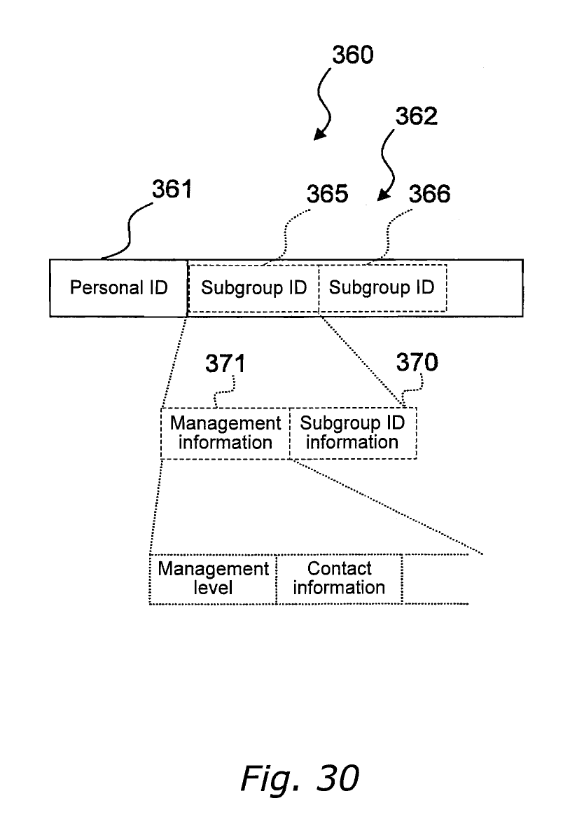

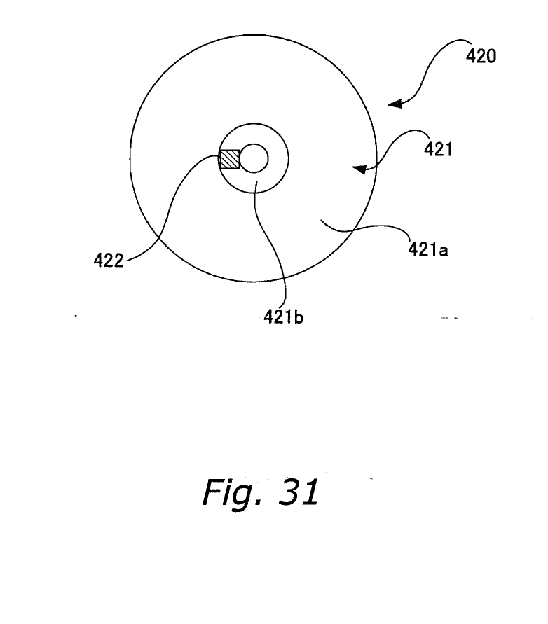

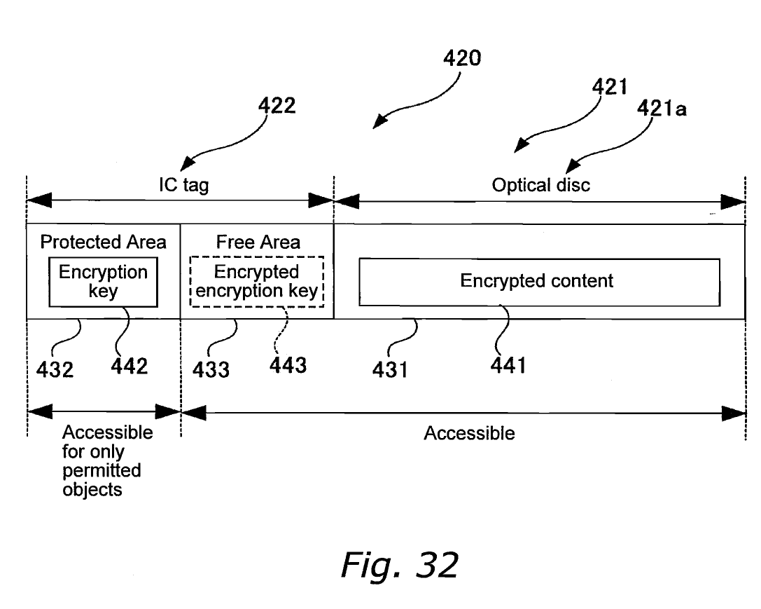

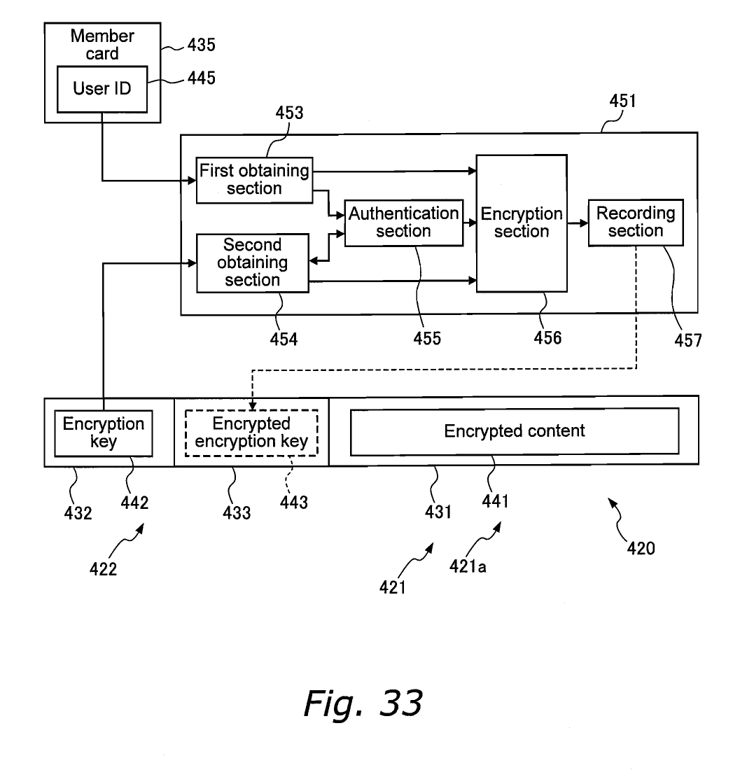

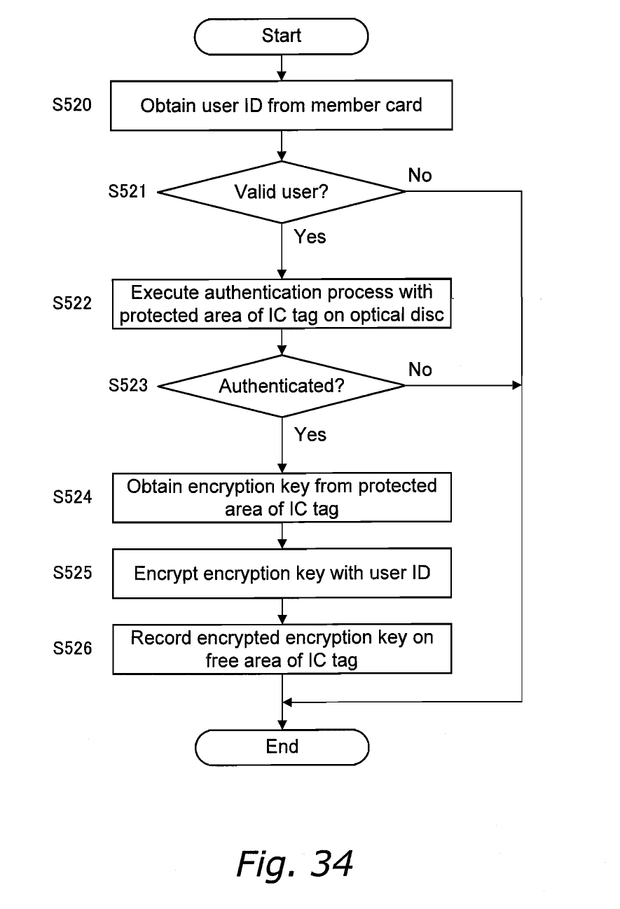

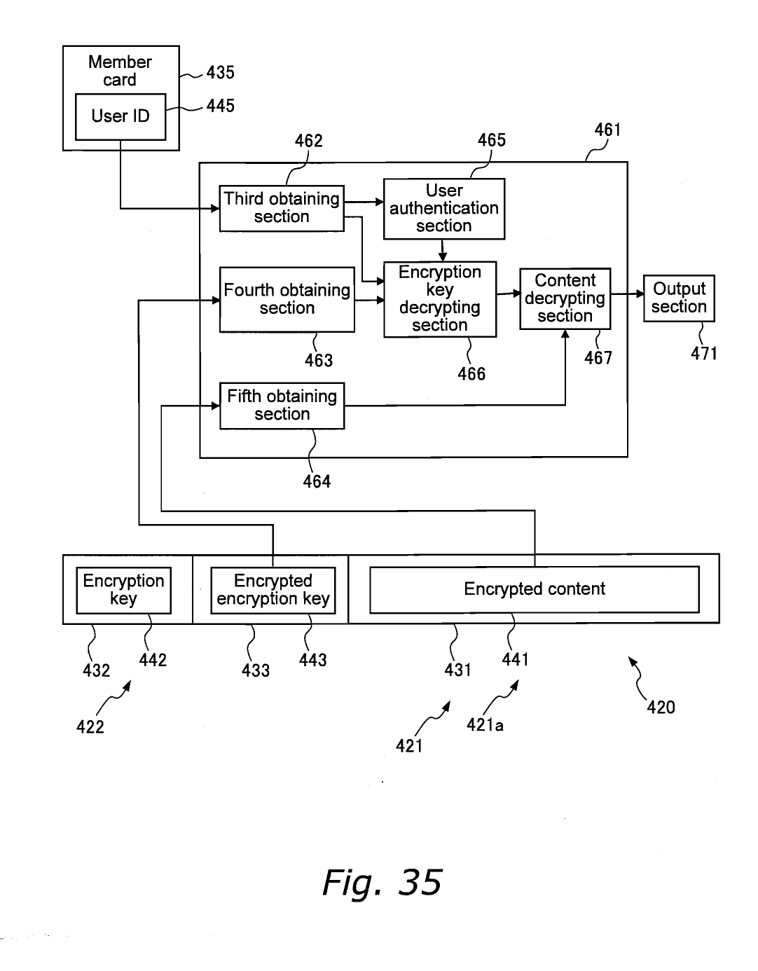

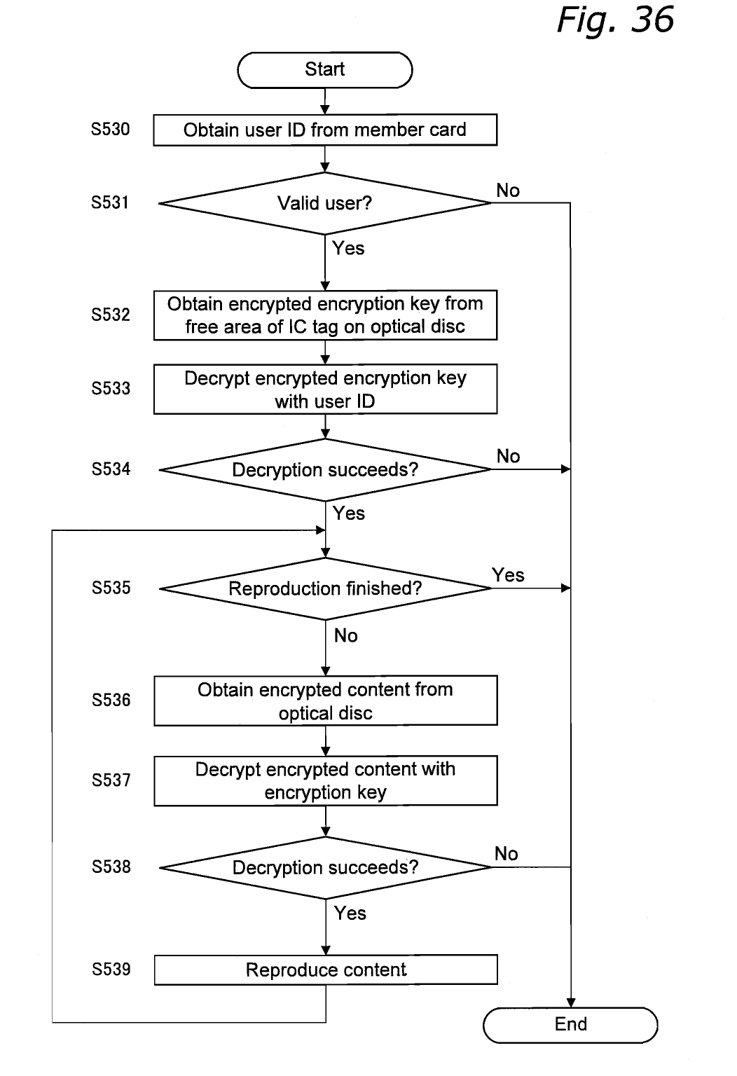

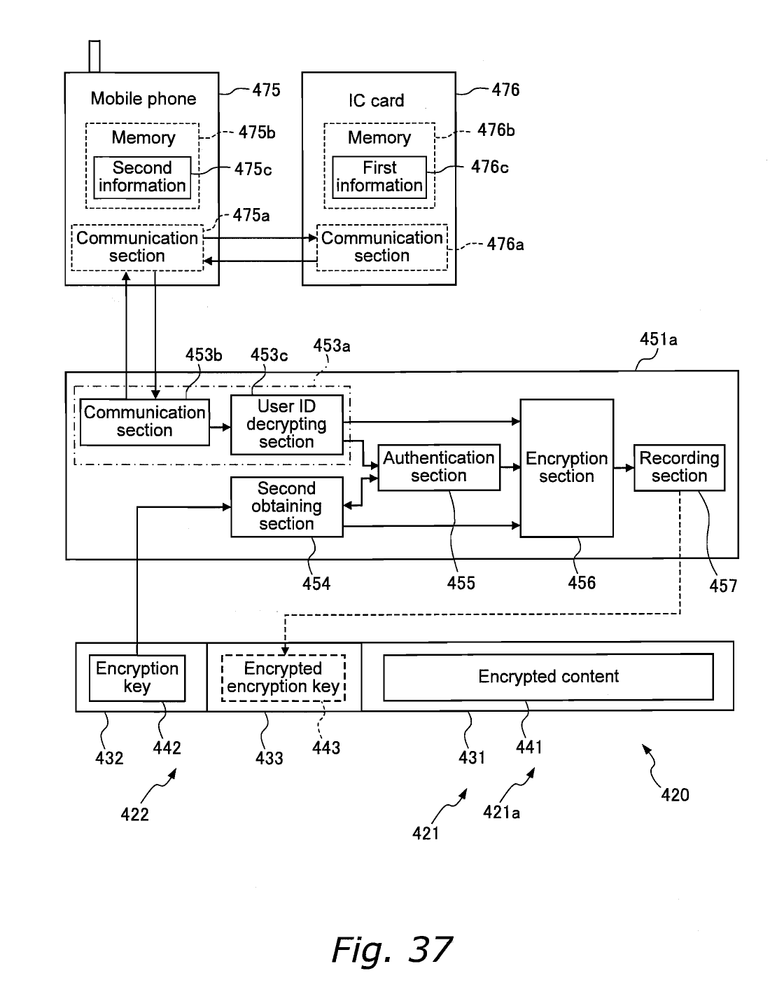

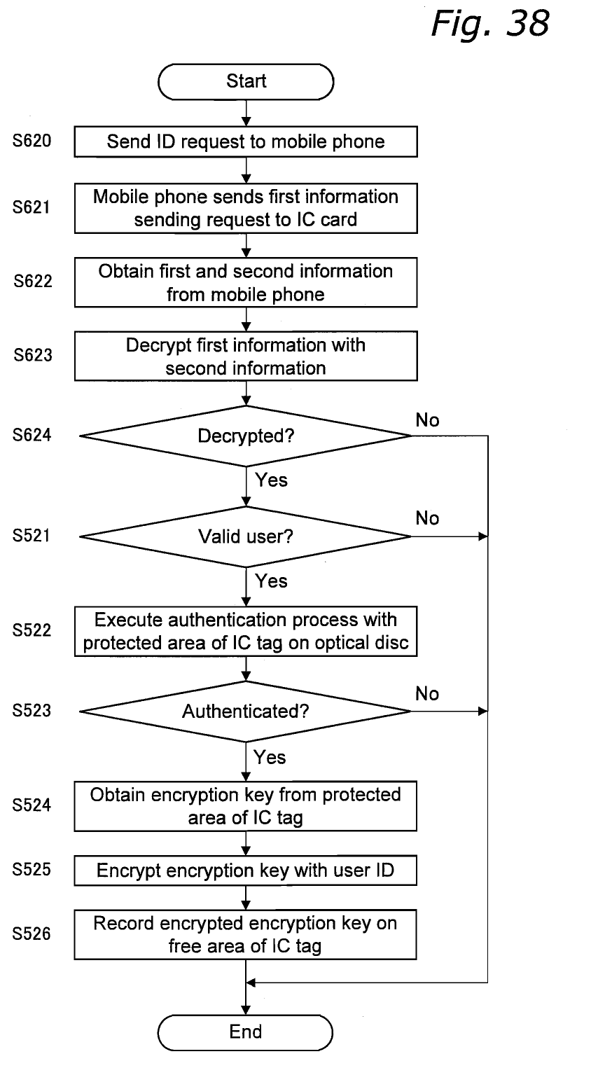

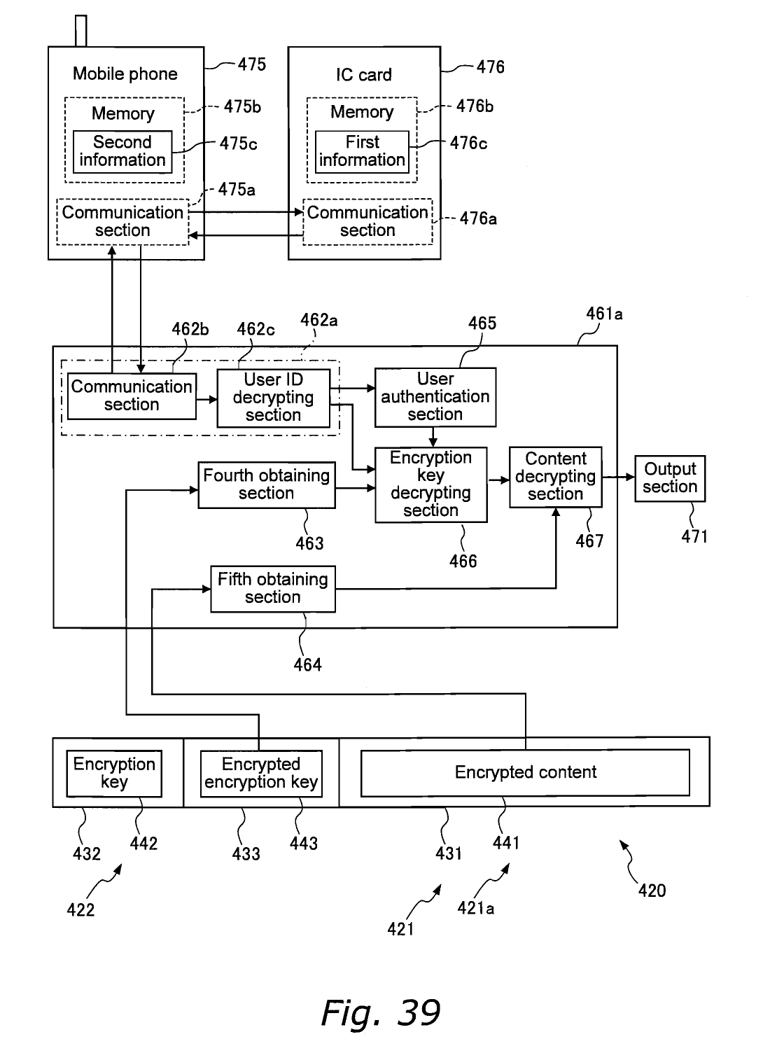

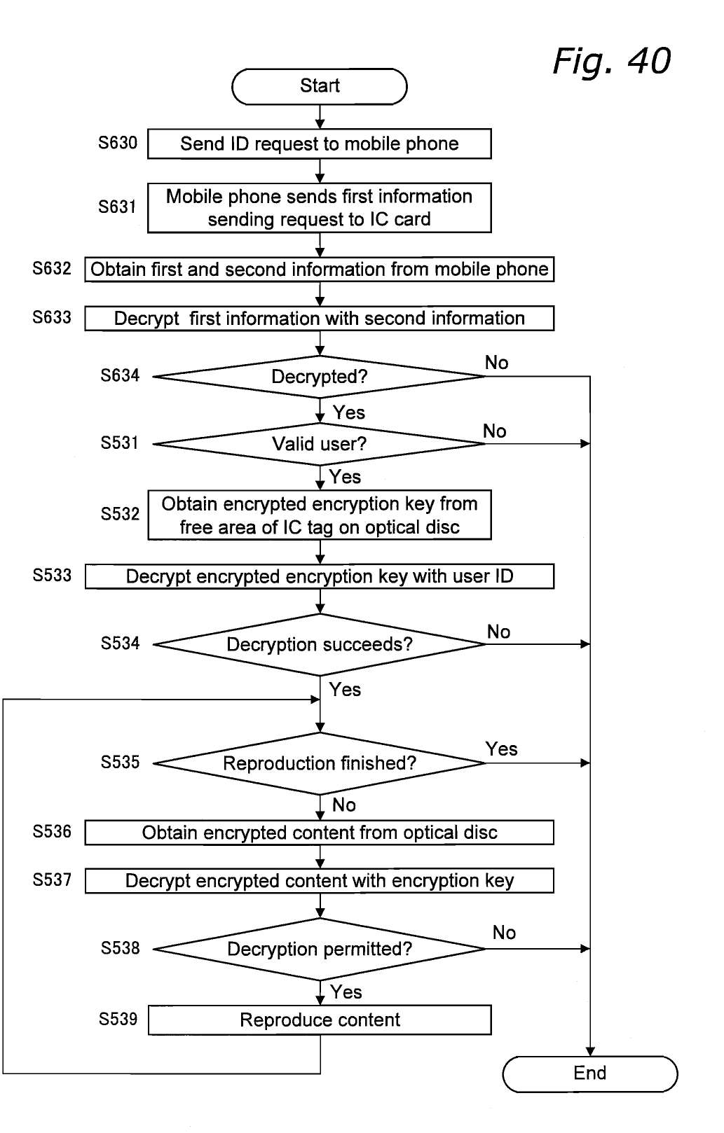

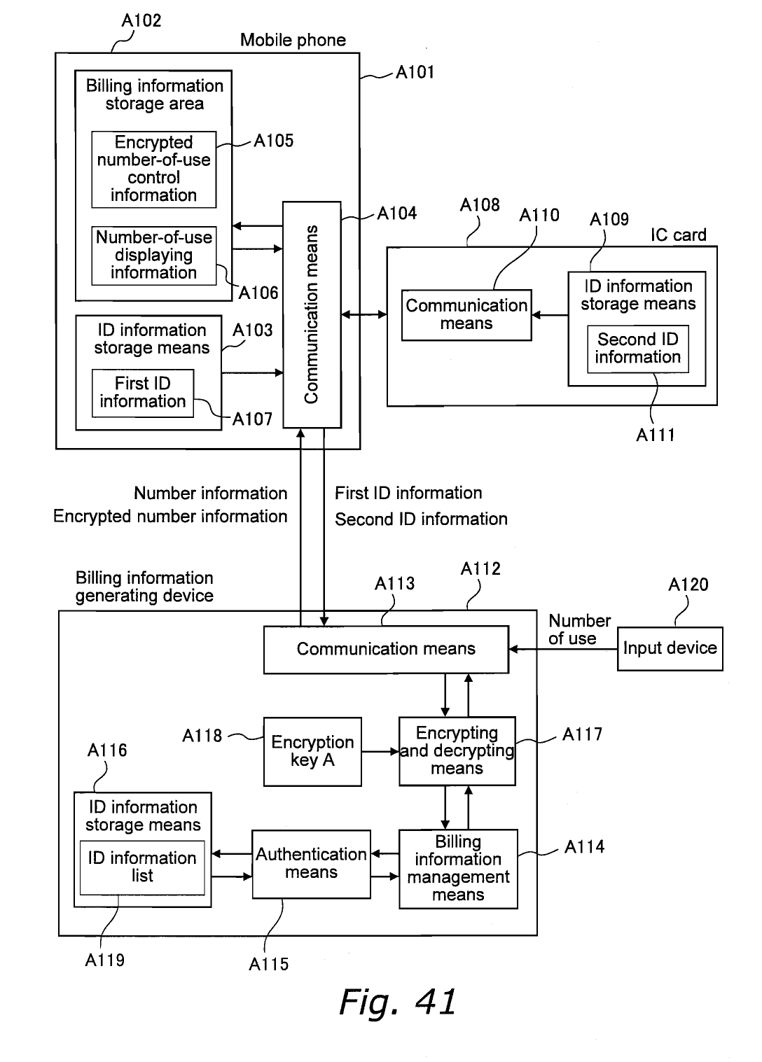

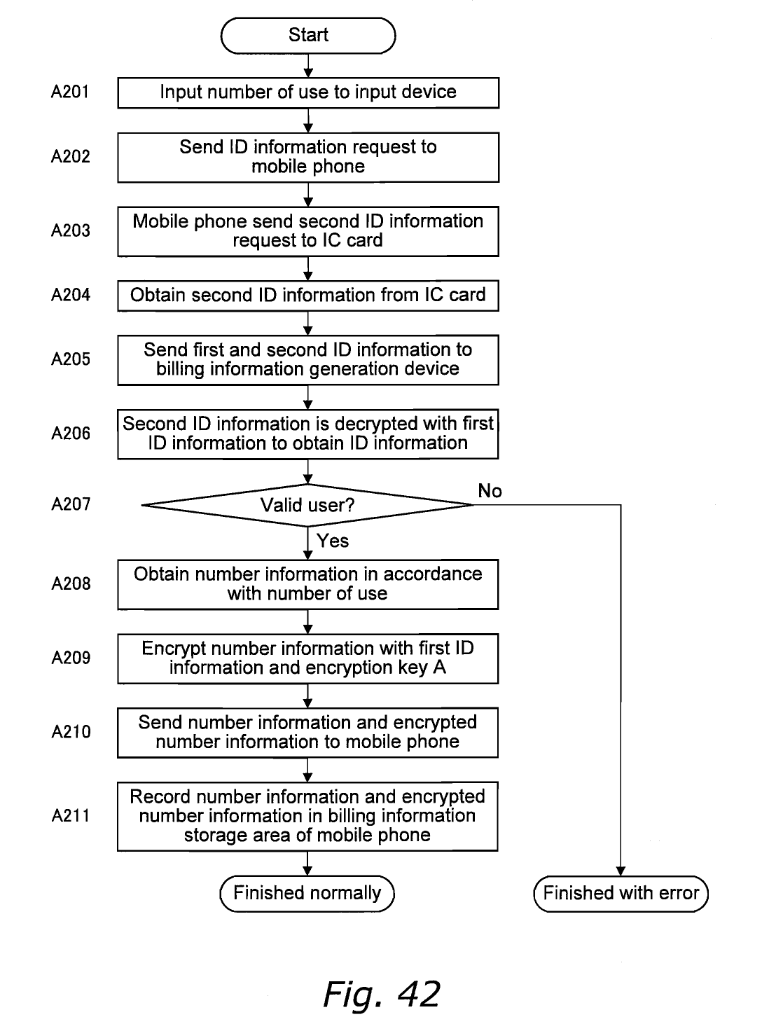

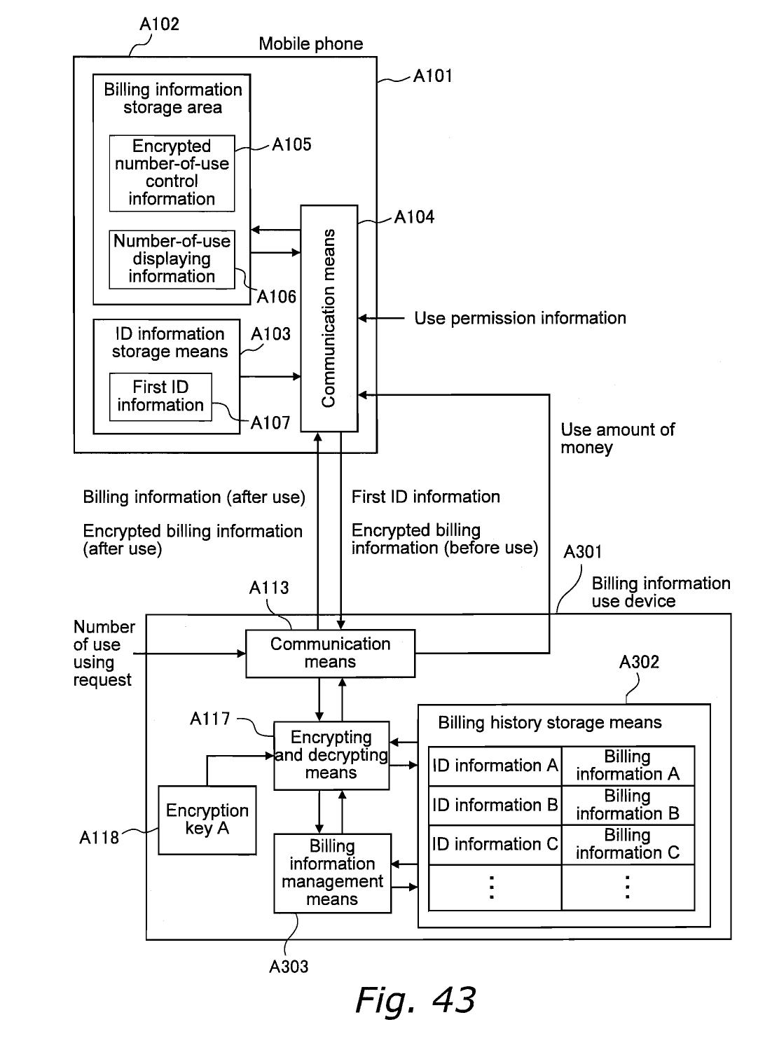

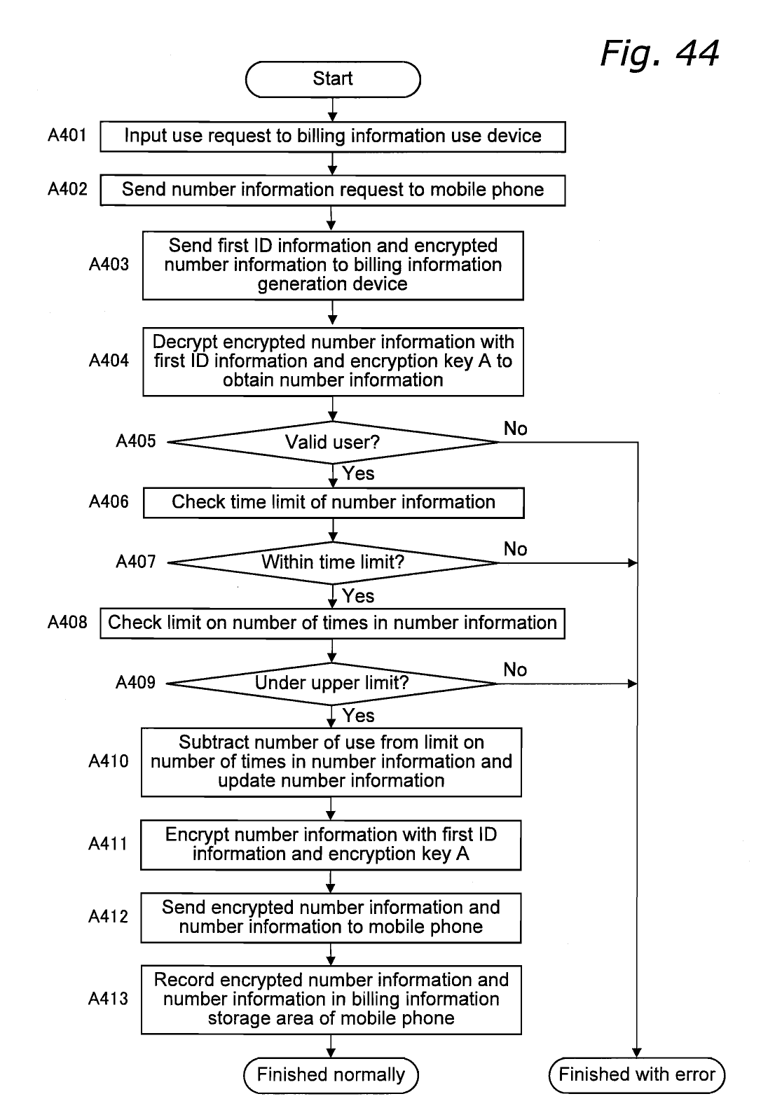

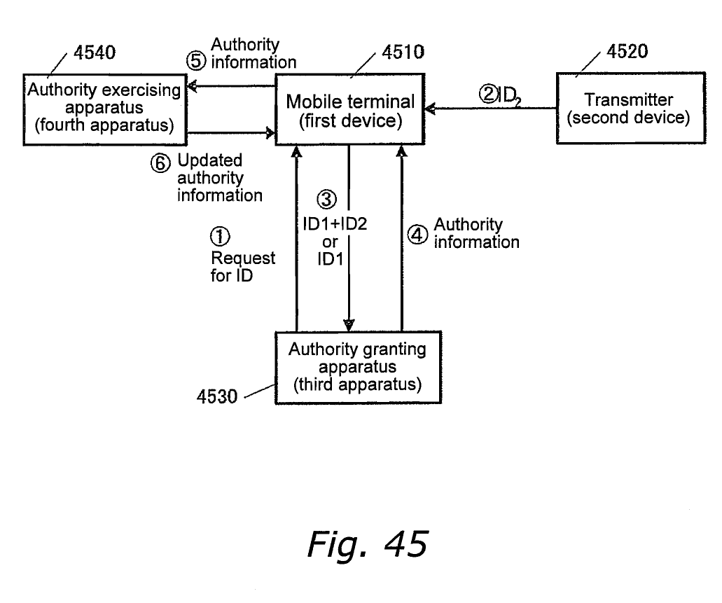

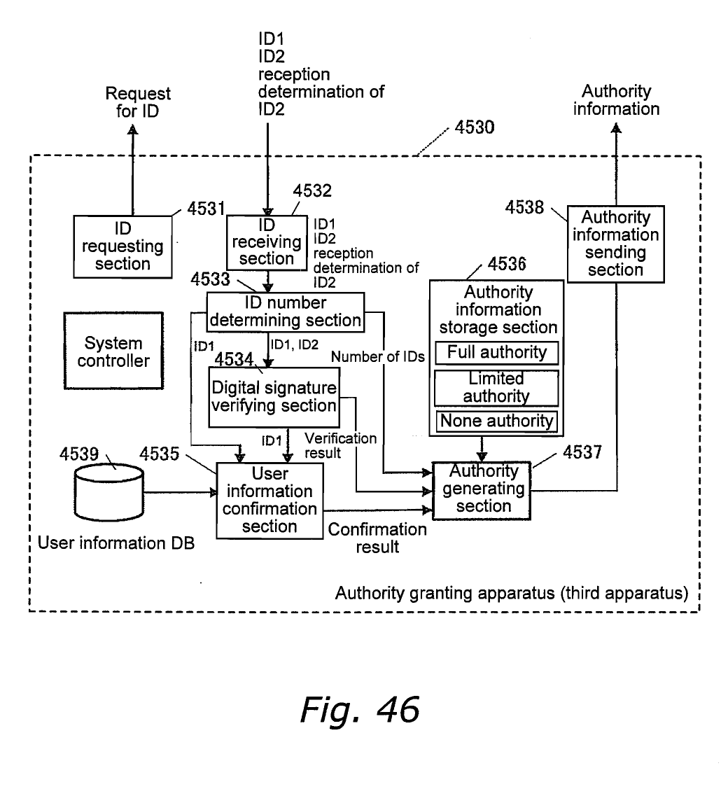

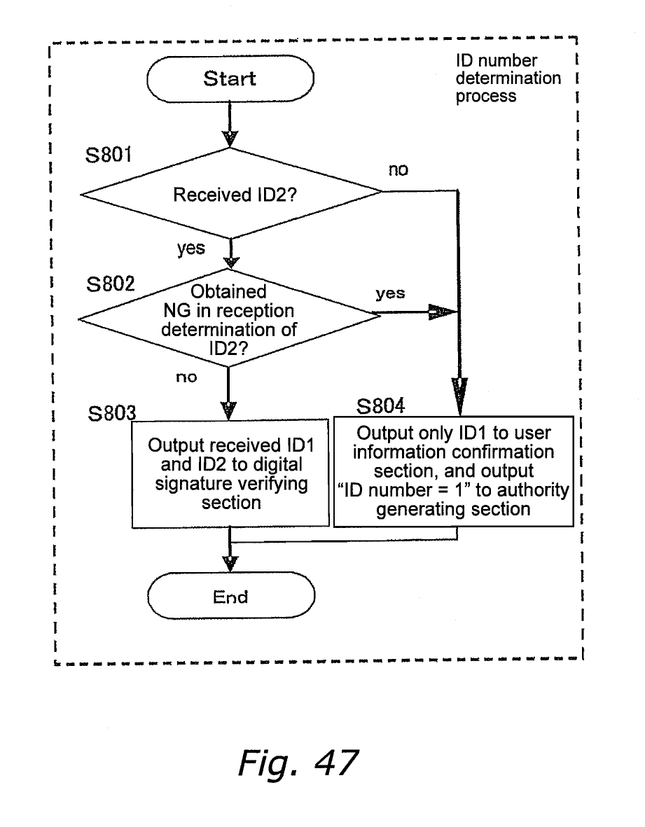

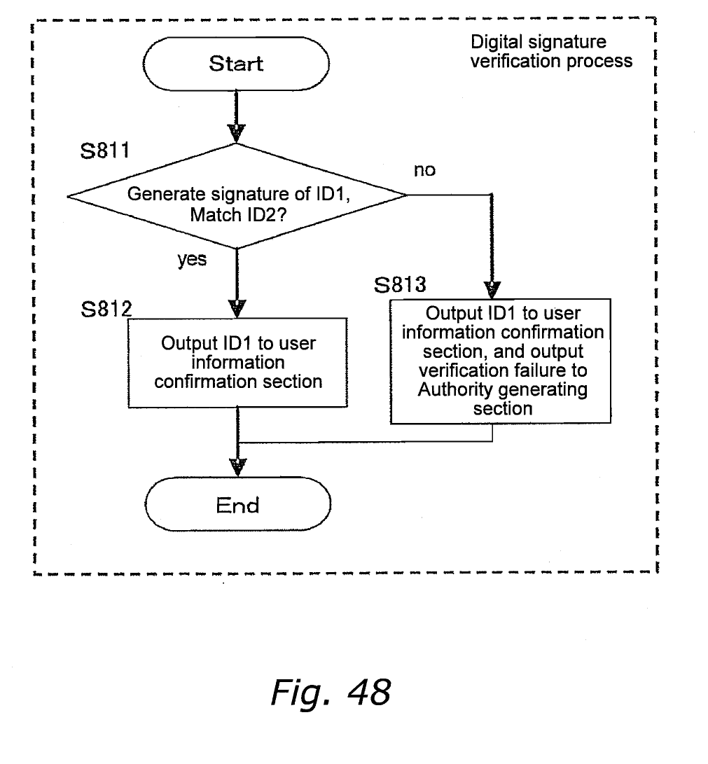

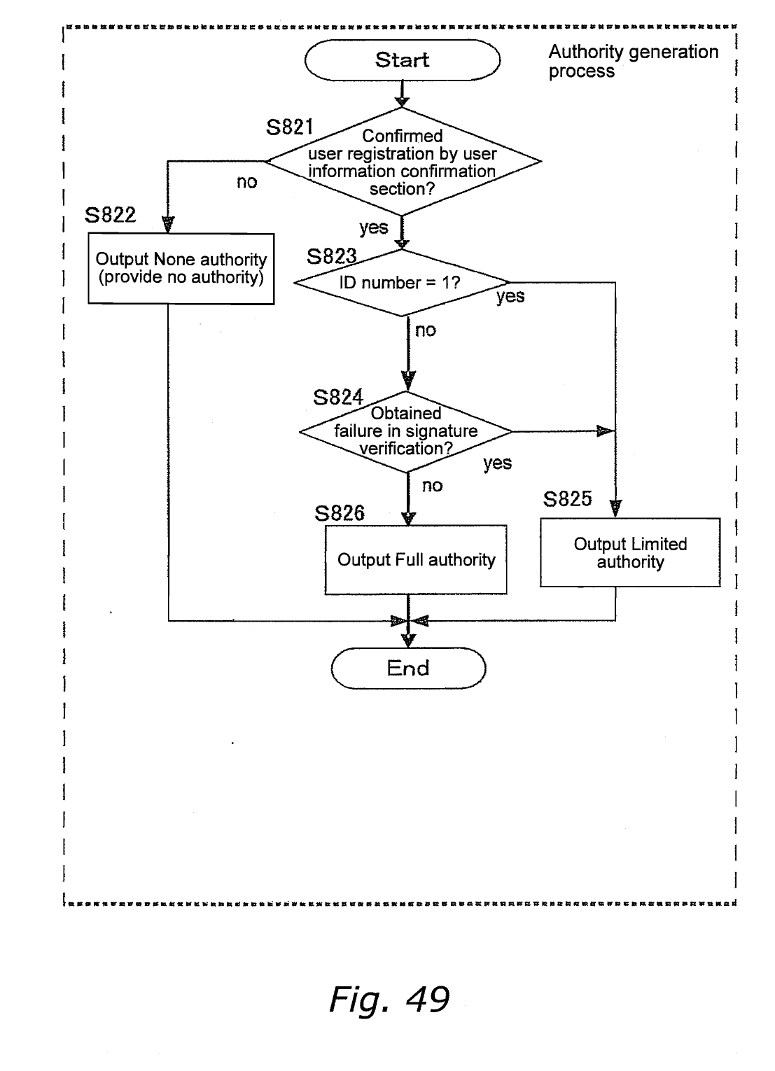

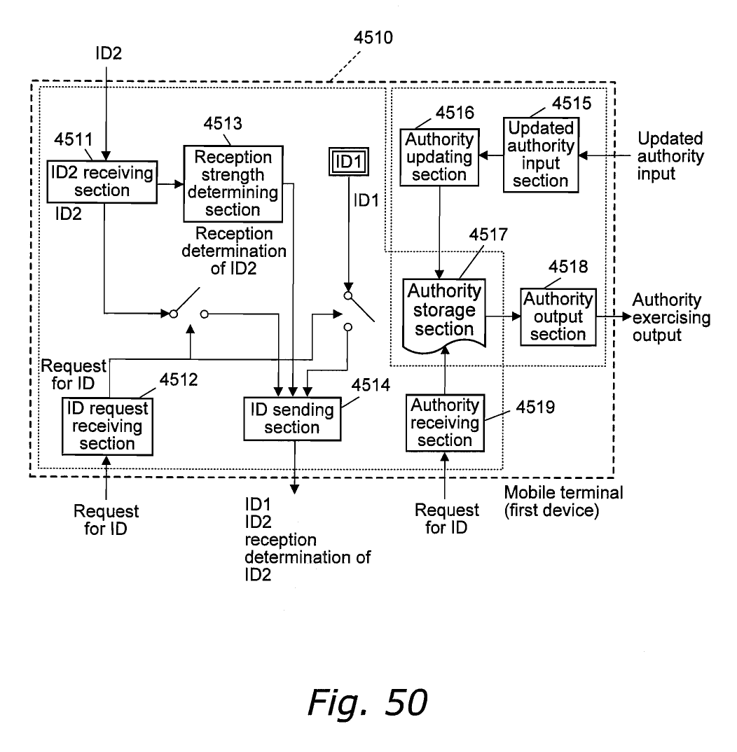

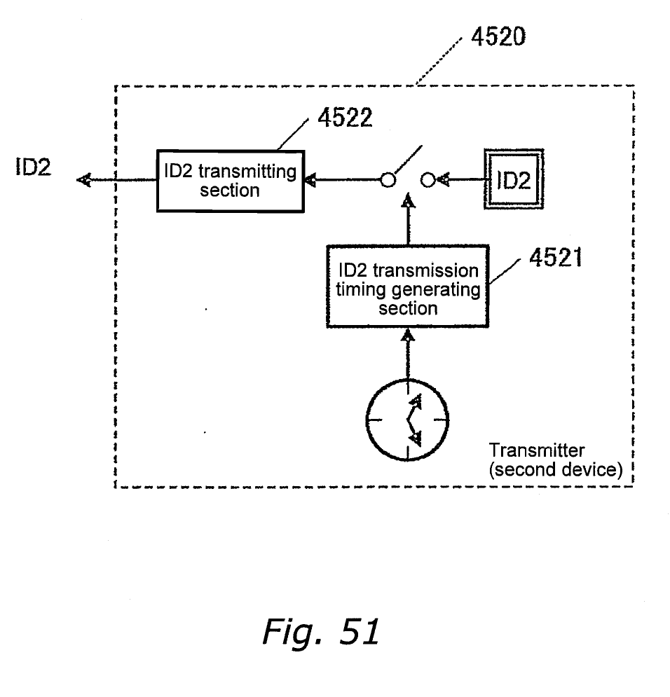

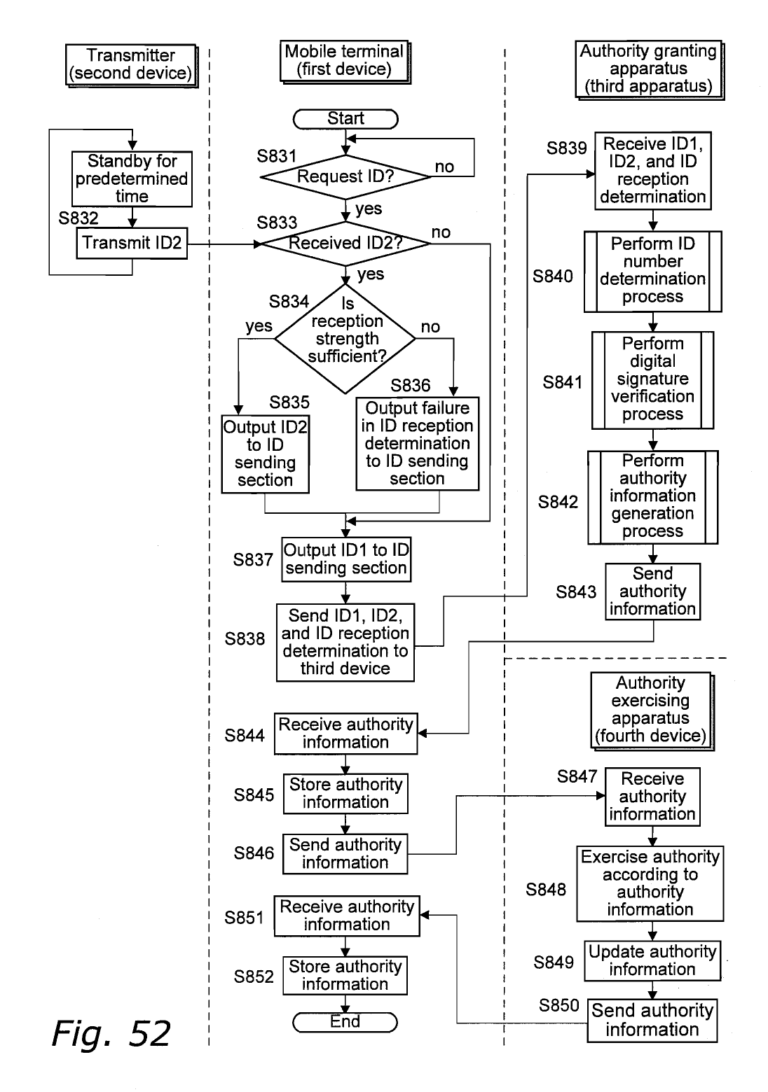

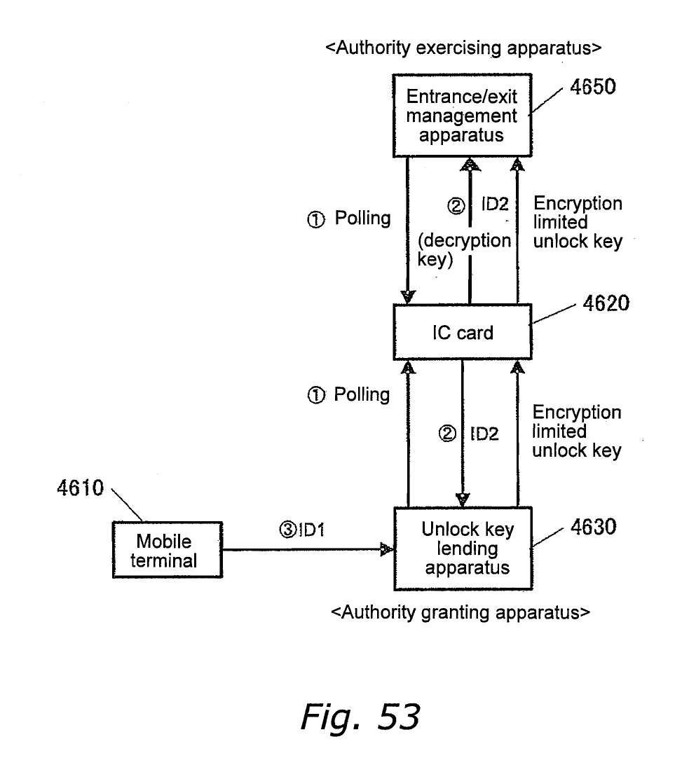

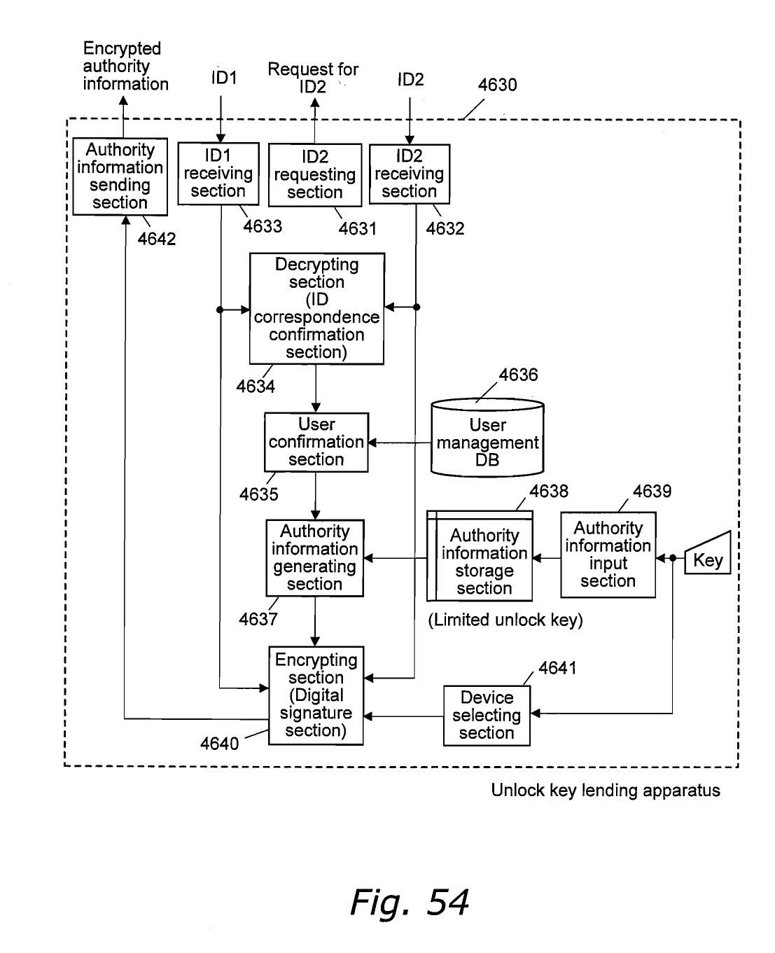

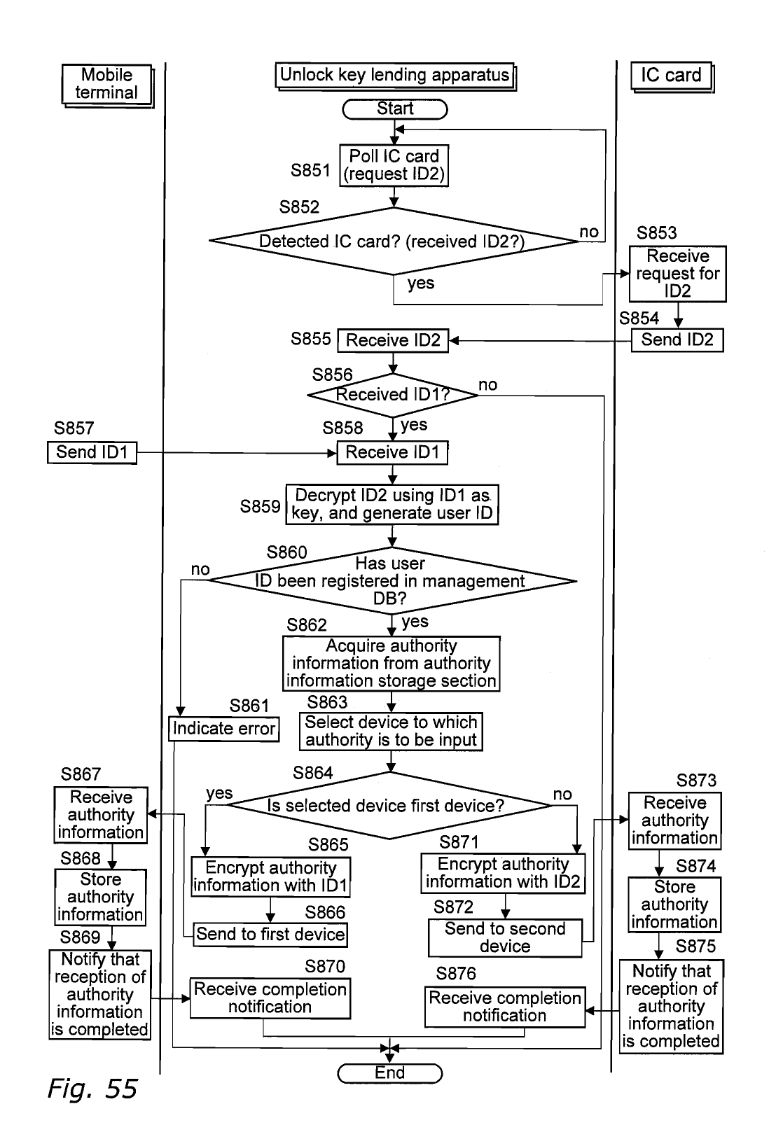

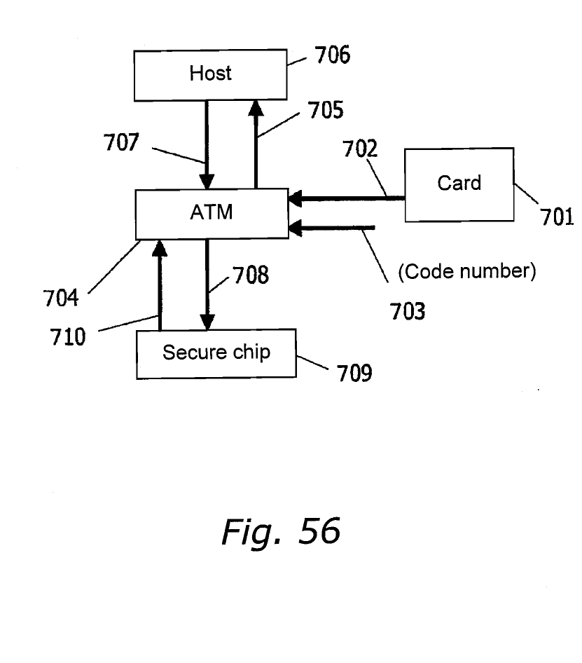

### REFERENCE NUMERALS

101 IC tag
102 Card
106 ATM
108 Host computer
110 Mobile phone
201 IC tag
203 Terminal (store)
204 Mobile phone
207 Host computer
1100 IC card
1101 Mobile phone
1102 Reader/writer
1201 IC card manufacturer's serial number
1202, 1203 Common key made through key exchange processing
1301, 1302 Sequence ID
1303, 1304 Communication key
1305, 1306 correspondence and comparison processing
1500 IC card
1501 Mobile phone
1502 Reader/writer
1503 Credit server
1504 Network
1600 IC card
1601 Mobile phone
1602 Bank server
1603 Network
4510 mobile terminal
4520 transmitter
4530 authority granting apparatus
4540 authority exercising apparatus
4610 mobile terminal
4620 IC card
4630 unlock key lending apparatus
4650 entrance/exit management apparatus

1-16. (canceled)

17. An authentication system, comprising:
a receiving unit operable to receive first ID information from a first device, and receive second ID information from a second device;
a received ID number counting unit operable to count the number of pieces of the ID information successfully received by the receiving unit, among the first ID information from the first device and the second ID information from the second device;
an authority information generating unit operable to generate authority information according to the number of pieces of the ID information counted by the received ID number counting unit;
a device selecting unit operable to select either one of the first device and the second device; and
a sending unit operable to send the authority information that has been generated by the authority information generating unit, to the device that has been selected by the device selecting unit.

18. The authentication system according to claim 17, comprising:
a user management unit operable to hold information relating to a user; and
a user confirmation unit operable to make an inquiry as to the first ID information or the second ID information to the user management unit, and acquire information regarding whether or not a user corresponding to the first ID information or the second ID information has been registered,
wherein if information indicating that the user has been registered is not acquired by the user confirmation unit, the authority information generating unit does not generate the authority information.

19. The authentication system according to claim 17,
wherein if the first device is selected by the device selecting unit, the authority information generating unit generates the authority information, by encrypting the authority information with the first ID information, and
if the second device is selected by the device selecting unit, the authority information generating unit generates the authority information, by encrypting the authority information with the second ID information.

20. The authentication system according to claim 17,
wherein if the first device is selected by the device selecting unit, the authority information generating unit generates the authority information, by providing a digital signature to the authority information and the first ID information, and
if the second device is selected by the device selecting unit, the authority information generating unit generates the authority information, by providing a digital signature to the authority information and the second ID information.

21. The authentication system according to claim 17, further comprising an authority information storage unit operable to store in advance authority information each having an authority range varying according to the number of pieces of the ID information successfully received by the receiving unit,
wherein the authority information generating unit generates the authority information, by selecting the authority information stored in the authority information storage unit, according to the number of pieces of the ID information counted by the received ID number counting unit.

22. An ATM (automatic teller machine) system, comprising the authentication system according to claim 21,
wherein the authority information is the maximum amount of money that can be transacted.

23. A gate management system, comprising the authentication system according to claim 21,
wherein the authentication system further comprises an area determining unit operable to determine an area for each gate, and
the authority information is the area of the gate that is allowed to be unlocked.

24. A gate management system, comprising the authentication system according to claim 21,
wherein the authentication system further comprises a time determining unit, and
the authority information is time at which unlock is allowed.

25. A gate management system, comprising the authentication system according to claim 21,
wherein the authentication system further comprises a time measuring unit, and
the authority information is a period during which unlock is allowed.

26. An electronic payment system, comprising the authentication system according to claim 21,
wherein the authority information is the maximum amount of money that can be paid.

27. An electronic payment system, comprising the authentication system according to claim 21,
wherein the authentication system further comprises an area determining unit operable to determine an area in which payment is performed, and
the authority information is the area in which payment is allowed.

28. An electronic payment system, comprising the authentication system according to claim 21,
wherein the authentication system further comprises a time determining unit operable to determine time at which payment is performed, and
the authority information is the time at which payment is allowed.

29. An electronic payment system, comprising the authentication system according to claim 21,
wherein the authentication system further comprises a time measuring unit operable to measure a period during which payment is performed, and
the authority information is the period during which payment is allowed.
